(19) United States
(12) Patent Application Publication
(10) Pub. No.: US 2026/0212639 A1
(43) Pub. Date: Jul. 23, 2026

(54) ARTIFICIAL INTELLIGENCE MODEL FOR PROCESSING MEDIA

(71) Applicant: V-NOVA INTERNATIONAL LIMITED, London (GB)

(72) Inventor: Guido MEARDI, London (GB)

(21) Appl. No.: 19/429,828

(22) Filed: Dec. 22, 2025

(30) Foreign Application Priority Data
Dec. 23, 2024 (GB) 2418985.4
Feb. 6, 2025 (GB) 2501802.9
Feb. 6, 2025 (GB) 2501803.7
Jul. 21, 2025 (GB) 2511834.0
Sep. 9, 2025 (GB) 2514927.9
Oct. 10, 2025 (GB) 2516942.6
Nov. 17, 2025 (GB) 2519289.9

(51) Int. Cl. G06V 10/72; G06V 10/25; G06V 10/764; G06V 10/774; H04N 19/134; H04N 19/30

(52) U.S. Cl. CPC G06V 10/72; G06V 10/25; G06V 10/764; G06V 10/774; H04N 19/134; H04N 19/30

(57) ABSTRACT

There is described an artificial intelligence, AI, model arranged to receive a set of image data associated with an encoded image, the image being encoded using a codec that provides a base image and one or more enhancement layers so as to enable the generation of a plurality of versions of the image, wherein each version of the image has a different level of quality, the set of image data comprising: a thumbnail tile that provides a version of the image with a first level of quality; and one or more image tiles that provide a version of one or more regions of the image with a second level of quality.

### CROSS-REFERENCE TO RELATED APPLICATIONS

This application claims priority to the following GB Applications; 2418985.4, filed December 23, 2024, 2501803.7, filed February 6, 2025, 2501802.9, filed February 6, 2025, 2511834.0, filed July 21, 2025, 2514927.9, filed September 9, 2025, 2516942.6, filed October 10, 2025, and 2519289.9, filed November 17, 2025, the disclosures of which are incorporated by reference in their entirety.

### FIELD OF THE DISCLOSURE

The present disclosure relates to methods, systems, apparatuses, and AI models for processing (e.g. classifying) media such as images or videos. The present disclosure further relates to methods of training and using models for media processing and for generating sets of media data for use with such models.

### BACKGROUND TO THE DISCLOSURE

Systems for image classification have a wide range of uses. In order to train and use these systems it is generally necessary to provide suitable image data in a suitable format. This need for formatting data can cause inefficiencies in both the training and usage of image classification systems where, for example, the need to reformat images received at a server may lead to an increase in the time needed to classify these images.

As such, methods of efficiently providing images to image classification systems – both for training purposes and to improve the use of the systems – are desirable.

### SUMMARY OF THE DISCLOSURE

According to an aspect of the present disclosure, there is described a method of decoding an image, the image being encoded using a codec that provides a base image and one or more enhancement layers so as to enable the generation of a plurality of versions of the image, wherein each version of the image has a different level of quality, the method comprising: identifying an image classifier (e.g. an image classifier of an artificial image, AI, model where the AI model may include or comprise the image classifier); determining a required format of an image based on the identified image classifier; determining a level of quality capable of providing the required format of image; and decoding the image so as to generate a version of the image using the identified level of quality.

Preferably determining a required format of an image comprises identifying a required size of an image.

Preferably determining a required format of an image comprises identifying a required resolution of an image.

Preferably, determining a required format of an image comprises identifying a required size and/or arrangement of tiles for inputting into the image classifier.

Preferably, determining the level of quality comprises identifying an enhancement layer capable of providing the identified format of image.

Preferably, determining the level of quality comprises identifying a minimum-quality level of quality capable of providing the required format of image.

Preferably, the method comprises transmitting the decoded image to a further computer device.

Preferably, the method comprises: identifying a plurality of image classifiers with different required formats; and for each of the image classifiers: identifying a level of quality capable of providing the required format of image; and generating, from the encoded image, a version of the image using the identified level of quality.

Preferably, the method comprises: determining a thumbnail tile using a version of the image with a first level of quality; determining one or more image tiles using a version of the image with a second level of quality that is the identified level of quality; and combining the thumbnail tile and the image tiles to form the set of image data.

According to an aspect of the present disclosure, there is described a method of forming a set of image data for use with an image classifier, the method comprising: identifying an encoded image, the image being encoded using a codec that provides a base image and one or more enhancement layers so as to enable the generation of a plurality of versions of the image, wherein each version of the image has a different level of quality; generating a thumbnail tile using a version of the image with a first level of quality; generating one or more image tiles using a version of the image with a second level of quality; and combining the thumbnail tile and the image tiles to form the set of image data.

Preferably, the method comprises: determining a region of interest in the image; and extracting the region of interest in at third level of quality. Preferably, the method comprises including the extracted region of interest in the set of image data.

Preferably, the method comprises performing an inference process based on the region of interest.

Preferably, the first level of quality is lower than the second level of quality and/or is lower than the identified level of quality.

Preferably, generating an image with a specific level of quality comprises combining the base layer with one or more enhancement layers associated with said specific level of quality.

Preferably, generating an image with a specific level of quality comprises upsampling the base image one or more times.

Preferably, generating the image comprises determining an intermediate image by upsampling the base image and combining the upsampled base image with a first enhancement layer and then upsampling the combined image and combining the upsampled combined image with a second enhancement layer.

Preferably, generating an image with a specific level of quality comprises combining the upsampled image with a set of residuals that corresponds to the amount of upsampling performed on the base image, preferably a number of upsampling operations applied to the base image.

Preferably, the method comprises resizing the decoded image based on the required format, preferably comprising resizing the decoded image based on a required image size.

Preferably, the method comprises: identifying a first region of the image and a second region of the image; and generating a first tile based on the first region and generating a second tile based on the second region.

Preferably, the method comprises generating the first tile with a first level of quality and generating the second tile with a second level of quality.

According to another aspect of the present disclosure, there is described a method of forming a set of image data for use with an AI model using an image encoded using a codec that provides a base image and one or more enhancement layers so as to enable the generation of a plurality of versions of the image, wherein each version of the image has a different level of quality, wherein the method comprises: identifying a first region of the image and a second region of the image; and generating a first tile with a first level of quality based on the first region and generating a second tile with a second level of quality based on the second region; and forming a set of image data based on the first tile and the second tile.

According to another aspect of the present disclosure, there is described an artificial intelligence, AI, model arranged to receive a set of image data associated with an encoded image, the image being encoded using a codec that provides a base image and one or more enhancement layers so as to enable the generation of a plurality of versions of the image, wherein each version of the image has a different level of quality, the AI model being arranged to receive a set of image data that comprises: a first tile with a first level of quality, the first tile representing a first region of an image; a second tile with a second level of quality, the second tile representing a second, different, region of the image.

Preferably, the AI model comprises an image classifier. Preferably, the method comprises: determining a required format of the image tiles based on the image classifier; determining a level of quality capable of providing the required format of image tiles; and decoding the image so as to generate the one or more image tiles at the determined level of quality.

Preferably, the method comprises identifying the first region based on a feature of the first region, preferably comprising identifying the first region based on an object detection process.

Preferably, the method comprises receiving an object of interest from a second device and identifying the first region based on the object of interest. Preferably, the object of interest is associated with a capability of the image classifier.

Preferably, the method comprises determining a region of interest in the image and generating the set of image data based on this region of interest.

Preferably, the method comprises determining one or more tiles from the image based on one or more regions of interest.

Preferably, determining the one or more tiles comprises generating a partial version of the image including only these regions.

Preferably, determining the one or more tiles comprises generating a first set of tiles with a first level of quality, the first set of tiles relating to regions of interest and generating a second set of tiles with a second level of quality, the second set of tiles relating to regions other than the regions of interest. Preferably, the first level of quality is greater than the second level of quality.

Preferably, the codec enables the separate and independent decoding of separate regions of the image.

Preferably, the method comprises determining the regions of interest based on a first version of the image, preferably the base layer, prior to determining a second, higher level of quality, version of a portion of the image including the regions of interest.

Preferably, the method comprises dividing the image into a plurality of tiles and allocating each tile to a different processing component for decoding the section of the image relating to said tile.

Preferably, the method comprises compiling the set of image data without generating the image and/or without combing the tiles so as to form an interpretable image.

Preferably, the method comprises determining an encoding parameter based on an input format associated with the image classifier and/or AI model. Preferably, the encoding parameter comprises one or more of: a quality (e.g. a resolution) of an enhancement layer; a number of enhancement layers; an upsampling technique used to upsample a first layer to a different layer; a structure for encoding different regions of the image; locations of boundaries between regions in the image; and/or end markers that indicate the location of features in the image.

Preferably, the method comprises allocating different regions of the image to different processing components for decoding based on the locations indicated by one or more end markers.

Preferably, the required format for the image classifier is associated with one or more of: a required size of input tiles for a set of image data; a required arrangement of input tiles for a set of image data; a required sampling ratio for an enhancement layer; a required number of and/or ratio between enhancement layers.

Preferably, the image classifier comprises a machine learning model, preferably a large language model (LLM).

According to another aspect of the present invention, there is described a method of classifying an image using an image classifier, the method comprising: generating a set of image data using the aforesaid method; providing the set of image data to an image classifier; and classifying the image using the image classifier.

According to another aspect of the present invention, there is described a method of forming a set of image data for training an image classifier, the method comprising: generating a set of image data using the aforesaid method; and including the set of image data in a training set for training an image classifier.

According to another aspect of the present invention, there is described a method of encoding an image, the method comprising: identifying an image classifier; identifying a required format of an image based on the identified image classifier; and determining an encoding parameter based on an input format associated with the image classifier.

According to another aspect of the present invention, there is described encoder for encoding an image, the encoder comprising a processor for: identifying an artificial intelligence, AI, model; identifying a required format of an image based on the identified AI model; determining an encoding parameter based on the required format; and encoding the image based on the encoding parameter, the image being encoded using a codec that provides a base image and one or more enhancement layers so as to enable the generation of a plurality of versions of the image, wherein each version of the image has a different level of quality.

According to another aspect of the present invention, there is described a method of encoding an image, the method comprising: determining an encoding parameter based on an input format associated with the image classifier; preferably wherein the parameter comprises one or more of: a quality (e.g. a resolution) of an enhancement layer; a number of enhancement layers; an upsampling technique used to upsample a first layer to a different layer; a structure for encoding different regions of the image; locations of boundaries between regions in the image; and/or end markers that indicate the location of features in the image.

According to another aspect of the present invention, there is described a method of decoding an image, the image being encoded using a codec that provides a base image and one or more enhancement layers so as to enable the generation of a plurality of versions of the image, wherein each version of the image has a different level of quality, the method comprising: identifying an image classifier, preferably an image classifier of an AI model; decoding an image so as to generate a first version of the image at a first level of quality; determining one or more regions of interest in the image based on first version of the image; decoding the image so as to generate versions of the one or more regions at a second, higher, level of quality; preferably, generating versions of only the one or more regions at the second level of quality (e.g. without generating versions of other regions in the image at the second level of quality).

Preferably, the method comprises encoding the image based on the encoding parameter.

Preferably, the image is encoded using a codec that provides a base image and one or more enhancement layers so as to enable the generation of a plurality of versions of the image, wherein each version of the image has a different level of quality.

Preferably, the parameter comprises one or more of: a quality (e.g. a resolution) of an enhancement layer; a number of enhancement layers; an upsampling technique used to upsample a first layer to a different layer; a structure for encoding different regions of the image; locations of boundaries between regions in the image; and/or end markers that indicate the location of features in the image.

Preferably, the method comprises identifying a plurality of image classifiers and determining the parameter based on said plurality of image classifiers. Preferably, the method comprises determining the parameter so that the encoded image contains levels of quality that are suitable for each of the image classifiers.

Preferably, the method comprises defining a structure for encoding data in different regions of an image. Preferably, the method comprises defining a number of nodes in one or more layers of a hierarchical structure for encoding data in different regions of an image.

Preferably, the method comprises defining the number of nodes based on the required image size.

Preferably, the method comprises determining one or more end markers, the end markers indicating the position of a region of the image in the bitstream and/or indicating the position of a portion of an enhancement layer associated with a region in the image.

Preferably, the method comprises including the end markers in a header of a bitstream comprising the image.

Preferably, the method comprises training an image classifier, preferably training the image classifier based on the image and/or the set of image data.

Preferably, the method comprises transmitting the encoded image to a further device, preferably to a further device that is executing the image classifier.

Preferably, determining a level of quality capable of providing the required format of image comprises determining one or more enhancement layers required to provide the required format, preferably determining a number of enhancement layers required to provide the required format.

Preferably, the method comprises padding the image. Preferably, the method comprises padding the image so as to form a square image. Preferably, the method comprises padding the lower of the width or the height of the image.

Preferably, the method comprises padding the image with pixel values that are an average pixel value of the image.

Preferably, the method comprises: identifying an image; determining that the image is in a non hierarchical format; and transcoding the image to a hierarchical format; preferably, wherein the method comprises: transcoding the image prior to undertaking a first training epoch for a machine learning mode; and using the hierarchical format during one or more further training epochs.

Preferably, the method comprises converting the images to tensors. Preferably, the method comprises normalizing the tensors following the conversion of the images.

Preferably, the codec comprises a VC-6 codec.

Preferably, the codec comprises a LCEVC codec.

Preferably, the level of quality is associated with an enhancement layer. Preferably, determining a level of quality capable of providing the required format of image comprises determining an enhancement layer capable of providing the required format of image.

Preferably, the method comprises: identifying a set of training images to be used for training an image classifier; in a first step, decoding the training images so as to generate a first set of training data comprising first image data at a first level of quality; and in a second step, decoding the training images generating a second set of training data comprising second image data at a first level of quality; preferably, wherein the first and second image data are associated with the same images decoded at different levels of quality and/or using different enhancement layers (e.g. where the second level of quality is higher than the first level of quality and/or wherein the first set of training data is associated with the use of a base image and the second set of training data is associated with the use of an enhancement layer).

Preferably, the method comprises: identifying a set of training images to be used for training an image classifier; in a first step, decoding the training images so as to generate a first set of training data comprising first image data relating to a first set of regions of interest within the training images; and in a second step, decoding the training images generating a second set of training data comprising second image data relating to a second set of regions of interest within the training images; preferably, wherein the first and second regions of interest are associated with different parts of the same images.

Preferably, the method comprises: in a first training step, training the image classifier using the first set of training data; in a second training step, re-training and/or fine tuning the image classifier using the second set of training data.

Preferably, the method comprises decoding base images of the training images, and using the decoded base images during the generation of each of the first set of training data and the second set of training data.

Preferably, the method comprises: identifying one or more of the training images that are encoded in a non-hierarchical format; transcoding the identified images to a hierarchical format (e.g. from a JPEG format to a VC6 format).

Preferably, the method comprises decoding the transcoded images for one or more training epochs of a training process for a machine learning model.

Preferably, the method comprises performing a first training epoch based on decoded images that are generated from the identified images (e.g. from non-hierarchically encoded versions of a set of images) and performing a second training epoch based on decoded images that are generated from the transcoded images (e.g. from hierarchically encoded versions of the same set of images).

The aforesaid method, wherein the image classifier comprises a video classifier.

According to another aspect of the present disclosure, there is described a method of forming a set of image data for training an image classifier, the method comprising: generating a set of image data comprising one or more images generated using the aforesaid method; and including the set of image data in a training set for training an image classifier.

According to another aspect of the present disclosure, there is described an apparatus for forming a set of image data for training an image classifier, the apparatus comprising: means for (e.g. a processor for) generating a set of image data comprising one or more images generated using the aforesaid method; and means for (e.g. a processor for) including the set of image data in a training set for training an image classifier.

According to another aspect of the present invention, there is described an apparatus for decoding an image, the image being encoded using a codec that provides a base image and one or more enhancement layers so as to enable the generation of a plurality of versions of the image, wherein each version of the image has a different level of quality, the apparatus comprising: means for (e.g. a processor for) identifying an image classifier; means for (e.g. a processor for) determining a required format of an image based on the identified image classifier; means for (e.g. a processor for) determining a level of quality capable of providing the required format of image; and means for (e.g. a processor for) decoding the image so as to generate a version of the image using the identified level of quality.

According to another aspect of the present invention, there is described an apparatus for forming a set of image data for use with an image classifier, the apparatus comprising: means for (e.g. a processor for) identifying an encoded image, the image being encoded using a codec that provides a base image and one or more enhancement layers so as to enable the generation of a plurality of versions of the image, wherein each version of the image has a different level of quality; means for (e.g. a processor for) generating a thumbnail tile using a version of the image with a first level of quality; means for (e.g. a processor for) generating one or more image tiles using a version of the image with a second level of quality; and means for (e.g. a processor for) combining the thumbnail tile and the image tiles to form the set of image data.

According to another aspect of the present invention, there is described an apparatus for classifying an image using an image classifier, the apparatus comprising: the aforesaid apparatus for generating a set of image data; means for (e.g. a processor for) providing the set of image data to an image classifier; and means for (e.g. a processor for) classifying the image using the image classifier.

According to another aspect of the present invention, there is described an apparatus for forming a set of image data for training an image classifier, the apparatus comprising: means for (e.g. a processor for) generating a set of image data using the aforesaid method; and means for (e.g. a processor for) including the set of image data in a training set for training an image classifier.

According to another aspect of the present invention, there is described an apparatus for encoding an image, the apparatus comprising: means for (e.g. a processor for) identifying an image classifier; means for (e.g. a processor for) identifying a required format of an image based on the identified image classifier; and means for (e.g. a processor for) determining an encoding parameter based on an input format associated with the image classifier.

Preferably, the aforesaid apparatus comprises an encoder.

Preferably, the aforesaid apparatus comprises a decoder.

According to another aspect of the present invention, there is described a system for decoding an image, the image being encoded using a codec that provides a base image and one or more enhancement layers so as to enable the generation of a plurality of versions of the image, wherein each version of the image has a different level of quality, the system comprising: means for (e.g. a processor for) identifying an image classifier; means for (e.g. a processor for) determining a required format of an image based on the identified image classifier; means for (e.g. a processor for) determining a level of quality capable of providing the required format of image; and means for (e.g. a processor for) decoding the image so as to generate a version of the image using the identified level of quality.

According to another aspect of the present invention, there is described a system for forming a set of image data for use with an image classifier, the system comprising: means for (e.g. a processor for) identifying an encoded image, the image being encoded using a codec that provides a base image and one or more enhancement layers so as to enable the generation of a plurality of versions of the image, wherein each version of the image has a different level of quality; means for (e.g. a processor for) generating a thumbnail tile using a version of the image with a first level of quality; means for (e.g. a processor for) generating one or more image tiles using a version of the image with a second level of quality; and means for (e.g. a processor for) combining the thumbnail tile and the image tiles to form the set of image data.

According to another aspect of the present invention, there is described a system for classifying an image using an image classifier, the system comprising: the aforesaid system for generating a set of image data; means for (e.g. a processor for) providing the set of image data to an image classifier; and means for (e.g. a processor for) classifying the image using the image classifier.

According to another aspect of the present invention, there is described a system for forming a set of image data for training an image classifier, the system comprising: means for (e.g. a processor for) generating a set of image data using the aforesaid method; and means for (e.g. a processor for) including the set of image data in a training set for training an image classifier.

According to another aspect of the present invention, there is described a system for encoding an image, the system comprising: means for (e.g. a processor for) identifying an image classifier; means for (e.g. a processor for) identifying a required format of an image based on the identified image classifier; and means for (e.g. a processor for) determining an encoding parameter based on an input format associated with the image classifier.

According to another aspect of the present invention, there is described a system comprising the aforesaid encoder and the aforesaid decoder.

According to another aspect of the present invention, there is described a system comprising: an encoder for encoding an image, the encoder comprising: means for (e.g. a processor for) identifying an image classifier; means for (e.g. a processor for) identifying a required format of an image based on the identified image classifier; means for (e.g. a processor for) determining an encoding parameter based on an input format associated with the image classifier; and means for (e.g. a processor for) encoding the image based on the encoding parameter, the image being encoded using a codec that provides a base image and one or more enhancement layers so as to enable the generation of a plurality of versions of the image, wherein each version of the image has a different level of quality; and a decoder for decoding the encoded image, the decoder comprising: means for (e.g. a processor for) identifying the image classifier; means for (e.g. a processor for) determining the required format of the image based on the identified image classifier; means for (e.g. a processor for) determining a level of quality capable of providing the required format of image; and means for (e.g. a processor for) decoding the image so as to generate a version of the image using the identified level of quality.

As used herein, ‘encoding’ or ‘decoding’ an image may refer to encoding or decoding a bitstream that defines the image.

According to another aspect of the present disclosure, there is described an artificial intelligence model, preferably a machine learning model, trained using a method of: generating a first set of training data, the first set of training data comprising a first set of images at a first level of quality; performing a first training step by providing the first set of training data to the artificial intelligence model; receiving an output from the artificial intelligence model following the first training step; generating a second set of training data in dependence on the output, the second set of training data comprises a second set of images at a second level of quality; and performing a second training step by providing the second set of training data to the artificial intelligence model.

Preferably, the method comprises generating the second set of images using the first set of images. Preferably, the method comprises: combining the first set of images with enhancement data to generate the second set of images, preferably combining the first set of images with enhancement layers associated with these images and with the second level of quality.

Preferably, the method comprises upscaling or upsampling the first set of images, preferably combining the upscaled first images with enhancement data to generate the second set of images.

Preferably, the method comprises determining the enhancement data based on the output, preferably comprising determining a required level of quality for the second training step based on the output and determining enhancement data that provides this required level of quality.

Preferably, the method comprises determining the second level of quality based on the output, preferably determining a second level of quality suitable for the second training step based on the output.

Preferably, generating the first set of images comprises transcoding one or more initial images from a non-hierarchical format to a hierarchical format, wherein generating the second set of images comprises generating the second set of images based on the transcoded images.

Preferably, the method comprises transcoding the one or more initial images during the generating of the first set of images.

Preferably, the method comprises transcoding the one or more initial images before the generating of the first set of images, wherein generating the first set of images comprises generating the first set of images based on the transcoded images.

Preferably, the first set of images and the second set of images comprise different versions of the same images, preferably versions of the same images at different levels of quality.

Preferably, the first set of images and/or the second set of images comprise images encoded using a hierarchical format.

Preferably, the second set of images comprises a subset of the first set of images.

Preferably, the second set of images comprises images that depict one or more regions of interest within the first set of images.

Preferably, the first level of quality and the second level of quality are associated with a first resolution and a second resolution.

Preferably, the method comprises generating the second set of training data based on a level of confidence associated with the output.

Preferably, the method comprises generating the second set of training data based on a rate of convergence associated with the output and/or based on an amount of change of model weights attributable to the images of the first set of images.

Preferably, the output indicates a level of confidence (e.g. of classification) for one or more images from the first set of images, and wherein generating the second set of images comprises determining a subset of the first set of images associated with a level of confidence beneath a threshold level.

Preferably, generating the second set of images comprises requesting and/or receiving enhancement data associated with the second level of quality (e.g. from a server), preferably wherein the enhancement data can be combined with images of the first level of quality in order to generate images of the second level of quality.

Preferably, the method comprises requesting the enhancement data following the first training step and/or following the receiving of the output, preferably requesting the enhancement data based on the output.

Preferably, the method comprises determining, based on the output, whether to request the enhancement data.

Preferably, the method comprises receiving a second output following the second training step and determining whether to generate a third set of training data associated with a third level of quality, preferably comprising determining not to request the third set of training data.

Preferably, the method comprises training the AI model based on the first training step and fine-tuning the AI model based on the second training step.

Preferably, the second set of images is associated with one or more regions of interest in the first set of images, preferably wherein the output indicates the one or more regions of interest.

Preferably, the first set of images and the second set of images are each versions of an original set of images, wherein the first set of images are associated with a first one or more regions of interest in the original set of images and the second set of images are associated with a second one or more regions of interest in the original set of images.

Preferably, the first set of images and/or the second set of images comprise hierarchically-encoded and/or hierarchically-structured images.

According to another aspect of the present disclosure, there is described a method of training an artificial intelligence model, preferably a machine learning model, the method comprising: generating a first set of training data, the first set of training data comprising a first set of images at a first level of quality; performing a first training step by providing the first set of training data to the artificial intelligence model; receiving an output from the artificial intelligence model following the first training step; and generating a second set of training data in dependence on the output, the second set of training data comprises a second set of images at a second level of quality; and performing a second training step by providing the second set of training data to the artificial intelligence model.

According to another aspect of the present disclosure, there is described an apparatus for of training an artificial intelligence model, preferably a machine learning model, the apparatus comprising: means for (e.g. a processor for) generating a first set of training data, the first set of training data comprising a first set of images at a first level of quality; means for (e.g. a processor for) performing a first training step by providing the first set of training data to the artificial intelligence model; means for (e.g. a processor for) receiving an output from the artificial intelligence model following the first training step; and means for (e.g. a processor for) generating a second set of training data in dependence on the output, the second set of training data comprises a second set of images at a second level of quality; and means for (e.g. a processor for) performing a second training step by providing the second set of training data to the artificial intelligence model.

According to another aspect of the present disclosure, there is described a method of providing an input to an artificial intelligence model, preferably a machine learning model, the method comprising: generating a first set of input data (e.g. training data and/or inference data), the first set of input data comprising a first set of images at a first level of quality; performing a first input step by providing the first set of input data to the artificial intelligence model; receiving an output from the artificial intelligence model following the first input step; and generating a second set of input data in dependence on the output, the second set of input data comprises a second set of images at a second level of quality; and performing a second input step by providing the second set of input data to the artificial intelligence model.

According to another aspect of the present disclosure, there is described a method of providing an input to an artificial intelligence model, preferably a machine learning model, the method comprising: identifying one or more obscurable regions in a first set of images at a first level of quality; generating a second set of images in which the obscurable regions have a second level of quality; and providing the second set of images to the artificial intelligence model.

Preferably, the second set of images comprises the obscurable regions at the second level of quality.

Preferably, the second set of images comprise regions other than the obscurable regions at the first level of quality and/or at a further level of quality.

Preferably, generating the second set of images comprises obscuring one or more objects in the obscurable regions.

Preferably, the method comprises generating the second set of images at an edge device and transmitting the second set of images to a server, wherein the server provides the second set of images to the artificial intelligence model.

Preferably, the method comprises determining the second level of quality based on a recognition level for an object in the obscurable regions at the second level of quality, preferably determining the second level of quality so as to prevent recognition of the object.

Preferably, the method comprises: providing the first set of images to the artificial intelligence model; receiving an initial output from the artificial intelligence model; and generating the second set of images based on the initial output.

Preferably, the method comprises processing the first set of images and/or the second set of images to indicate the presence of the obscurable regions, preferably to indicate that only permissioned devices are able to access residual information associated with the obscurable regions at the first level of quality.

According to another aspect of the present disclosure, there is described a method of providing an input to an artificial intelligence model, preferably a machine learning model, the method comprising: identifying motion in a first set of images at a first level of quality; generating a second set of images at a second level of quality in dependence on the motion; and providing the second set of images to the artificial intelligence model.

Preferably, the method comprises determining the motion based on a difference between a first and a second image in the first set of images.

Preferably, the method comprises determining a region of interest associated with the motion, preferably wherein the second set of images depicts the region of interest at the second level of quality.

Preferably, the second set of images comprises: a first one or more images at the second level of quality; and a further one or more images at a third level of quality, preferably wherein the first one or more images comprise regions in which motion is detected and/or the further one or more images comprise regions in which no motion has been detected; preferably wherein the third level of quality is lower than the second level of quality.

Preferably, identifying the motion comprises determining that a feature of the motion, preferably a magnitude, duration, and/or direction of the motion, exceeds a threshold.

According to various aspects of the present disclosure, there are described artificial intelligence, AI, models and machine learning, ML, models. These models may be trained using any of the aforesaid methods, apparatuses, or systems. These models may be used with any of the aforementioned methods, apparatuses, or systems. Furthermore, aforementioned methods relating to the use of AI or ML models may be arranged to use AI or ML models trained according to the methods described above. The disclosure extends to apparatuses, systems, and (e.g. non-transitory) machine readable mediums for implementing or storing such AI and ML models, e.g. for storing weights or parameters of such AI and ML models.

The methods above may provide methods of image classification and/or image segmentation and/or object detection and/or object recognition. The AI and ML models disclosed herein may comprise AI or ML models for image classification and/or object detection and/or object recognition.

According to an aspect of the present disclosure, there is described a method of training the aforesaid AI model.

According to an aspect of the present disclosure, there is described an artificial intelligence, AI, model trained using the aforesaid method.

According to an aspect of the present disclosure, there is described a method of using an artificial intelligence, AI, model trained using the aforesaid method, preferably using the AI model to perform inference, more preferably to perform object detection and/or recognition on the images and/or the image tiles.

According to an aspect of the present disclosure, there is described a method of forming a set of image data for use with the aforesaid AI model.

According to an aspect of the present disclosure, there is described a method of using the aforesaid AI model to perform inference on the set of image data, preferably to perform object detection and/or recognition on the set of image data.

According to an aspect of the present disclosure, there is described an apparatus arranged to perform the aforesaid method.

According to an aspect of the present disclosure, there is described a non-transitory computer-readable medium storing instructions that, when executed by a computer device (e.g. a processor of the computer device), cause the computer device (e.g. the processor) to implement or perform the aforesaid method.

According to an aspect of the present disclosure, there is described an apparatus for storing the aforesaid AI model (e.g. for storing parameters (or weightings) of the AI model).

The aforesaid AI and ML models may be trained using a set of image data formed using any of the aforesaid methods. The aforesaid AI and ML models may be trained using a method that comprises providing said set of image data to the model so as to train the model.

This may involve providing the set of image data to the model, identifying an output of the model, comparing the output to an expected output, and updating one or more weights or parameters of the model based on a difference between the actual output and the expected output.

It will be appreciated that various techniques for training AI and ML models are known and could be used with the AI and ML models disclosed herein (and with the sets of image data formed using the methods disclosed herein).

According to an aspect of the present disclosure, there is described an artificial intelligence, AI, model arranged to receive a set of image data associated with an encoded image, the image being encoded using a codec that provides a base image and one or more enhancement layers so as to enable the generation of a plurality of versions of the image, wherein each version of the image has a different level of quality; the set of image data comprising: a thumbnail tile that provides a version of the image with a first level of quality; and one or more image tiles that provide a version of one or more regions of the image with a second level of quality.

According to an aspect of the present disclosure, there is described an artificial intelligence, AI, model arranged to receive a set of image data formed using a method that comprises: generating a first set of image data, the first set of image data comprising the image tiles; performing a first inference or training step by providing the first set of image data to the artificial intelligence model; receiving an output from the artificial intelligence model following the first inference or training step; and generating a second set of image data in dependence on the output, the second set of image data comprising a second set of images at a further level of quality.

According to an aspect of the present disclosure, there is described an artificial intelligence, AI, model, model comprising an image classifier, wherein the AI model is arranged to receive a set of image data formed using a method that comprises: determining a required format of the image tiles based on the image classifier; determining a level of quality capable of providing the required format of image tiles; and decoding the image so as to generate the one or more image tiles at the determined level of quality.

According to an aspect of the present disclosure, there is described an artificial intelligence, AI, model arranged to receive a set of image data formed using a method that comprises: generating a first set of image data, the first set of image data comprising the image tiles; performing a first inference or training step by providing the first set of image data to the artificial intelligence model; receiving an output from the artificial intelligence model following the first inference or training step; and generating a second set of image data in dependence on the output, the second set of image data comprising a second set of images at a further level of quality.

According to an aspect of the present disclosure, there is described an artificial intelligence, AI, model arranged to receive a set of image data that comprises: a first set of images at an initial level of quality; a second set of images in which one or more obscurable regions of the set of images have a further, preferably lower, level of quality.

According to an aspect of the present disclosure, there is described an artificial intelligence, AI, model arranged to receive a set of image data formed using a method that comprises: a first set of images at an initial level of quality; a second set of images at a further level of quality, the second set of images being generating in dependence on a motion in the first set of images.

According to an aspect of the present disclosure, there is described an artificial intelligence, AI, model arranged to receive a set of image data associated with an encoded image, the image being encoded using a codec that provides a base image and one or more enhancement layers so as to enable the generation of a plurality of versions of the image, wherein each version of the image has a different level of quality, the AI model being arranged to receive a set of image data formed using a method that comprises: identifying a first region of the image and a second region of the image; and generating a first tile with a first level of quality based on the first region and generating a second tile with a second level of quality based on the second region; and forming a set of image data based on the first tile and the second tile.

According to an aspect of the present disclosure, there is described an artificial intelligence, AI, model arranged to receive a set of image data associated with an encoded image, the image being encoded using a codec that provides a base image and one or more enhancement layers so as to enable the generation of a plurality of versions of the image, wherein each version of the image has a different level of quality, the AI model being arranged to receive a set of image data formed using a method that comprises: identifying an image classifier, preferably an image classifier of an AI model; decoding an image so as to generate a first version of the image at a first level of quality; determining one or more regions of interest in the image based on first version of the image; decoding the image so as to generate versions of the one or more regions at a second, higher, level of quality; preferably, generating versions of only the one or more regions at the second level of quality (e.g. without generating versions of other regions in the image at the second level of quality).

### Training Scheme

Described herein is an example AI training scheme. In particular Efficient Hierarchical Coding for Large Multimodal Model (LMM) Training. This scheme relates to optimizing preprocessing pipelines for training Large Multimodal Models (LMMs). Specifically, it introduces an improved hierarchical coding format designed to enhance computational efficiency, reduce memory bandwidth usage, and accelerate training times.

Large Multimodal Models (LMMs) extend traditional text-based Large Language Models (LLMs) by integrating multiple data modalities, including images, video, and audio. This integration significantly increases computational complexity due to the heterogeneous nature of multimodal data, which requires specialized preprocessing, feature extraction, and alignment techniques to ensure consistency across modalities. For example, video data alone involves handling temporal dependencies and high-dimensional representations, leading to substantial memory and processing requirements. Integrating additional modalities into machine translation significantly increases computational demands, as LMMs must process and align heterogeneous data sources, requiring up to 3.8× more computational resources compared to text-only LLMs. As a result, conventional preprocessing pipelines often introduce significant computational overheads, leading to prolonged training times and high infrastructure costs.

Existing preprocessing methods for LMM training introduce substantial computational overhead, leading to prolonged training durations and high infrastructure costs. While hardware accelerations, such as GPUs and TPUs, can partially mitigate these costs, inefficient data handling remains a key bottleneck.

MPEG’s Video Coding for Machines (VCM) has been explored to optimize video representations for machine learning. However, its reliance on object detection for encoding and focus on feature compression introduce biases and computational overheads, making it unsuitable for large-scale AI training workflows. Additionally, it lacks a hierarchical structure to support selective decoding of lower-resolution layers, limiting its efficiency in multimodal training.

We describe utilising an optimized hierarchical coding format tailored for LMM training. The described methods overcome inefficiencies of conventional JPEG pipelines by introducing a method that integrates real-time encoding and decoding, hierarchical resolution selection, and parallel processing for optimized computational workloads.

The described methods leverage a hierarchical multi-resolution coding format (e.g. SMPTE VC-6), to significantly reduce preprocessing time.

We describe a method of processing data.

The method may comprise a method of preprocessing multimodal training data. Optionally wherein input image data is converted from a non-hierarchical format to a hierarchical coding format. Thus enabling improved storage and retrieval efficiency.

Optionally wherein non-hierarchical format images are decoded using a hardware-accelerated codec to minimize preprocessing latency.

Optionally wherein images are transcoded to a hierarchical coding format. The hierarchical coding format may enable selective resolution access in future training iterations

Optionally wherein hierarchical image encoding allows the selection of an optimal resolution level based on available computational resources.

Optionally wherein a hierarchical coding format enables partial decoding of an image at a target resolution, reducing processing time.

Optionally wherein images are expanded to a square resolution using adaptive padding (e.g. to maintain consistency in training datasets).

Optionally wherein a square expansion process is applied at full resolution (e.g. leading to increased computational complexity).

Optionally wherein input images are one or more of: rescaled; tensor-converted; and normalized, before being used in a multimodal training model.

In particular, we describe a method of increasing the efficiency of image processing for AI training by leveraging both hierarchical and non-hierarchical image formats. The method may comprise one or more of the following steps:

Loading the Data.

Retrieving images from either a non-hierarchical format (e.g., traditional compressed formats) or a hierarchical format (e.g., multi-resolution scalable compression).

Using a dataset with a large number of images per training epoch.

Iterating across multiple epochs for model learning.

Checking whether the image is already in the hierarchical format. If so, proceeding directly to the decoding stage.

If not, decoding the high-resolution image from its non-hierarchical format and re-encoding it into the hierarchical format for efficient multi-resolution access.

Decoding the image.

Determining an optimal (and/or improved) Level of Quality (LoQ) based on resolution requirements.

Selecting from multiple LoQ levels, e.g.:

LoQ-0: High resolution

LoQ-1: Medium resolution

LoQ-2: Low resolution

Decoding the selected LoQ version into (e.g. RGB) a format for compatibility with downstream processing.

Pre-processing the image.

Adapting the decoded images to a square aspect ratio, e.g. for standardization.

Expanding and/or resizing lower-resolution images to fit a consistent square format.

Adjusting high-resolution images as needed to maintain aspect ratio integrity.

Embedding the Image

Passing the pre-processed images through a feature extraction model (e.g., a vision-language embedding model like CLIP).

Resizing images to the required input dimensions for consistency.

Converting images to tensor representations for numerical processing.

Normalizing tensors to standardize pixel values across the dataset.

Training the AI Model.

Feeding the processed image tensors into large-scale AI training models, such as multimodal learning models (LMMs) or deep learning architectures.

Iterating over multiple training epochs while leveraging hierarchical image formats for efficient resolution handling.

By actively integrating hierarchical image formats, this workflow dynamically adjusts resolution levels, optimizing computational performance while preserving high-quality data when needed. This structured process enhances AI model training efficiency while ensuring high-quality feature extraction for robust learning.

### Further Embodiments

In alternative embodiments, there may be provided:

An artificial intelligence, AI, configured to receive decoded data associated with a dataset as part of a training or inference process, the dataset comprising a base layer comprising data at a first level of quality, and one or more of enhancement layers associated with the base layer, configured to be combined with the base layer to generate data at a various levels of quality, wherein the dataset has been processed by:

decoding a subsection of the dataset at a selected level of quality to produce the decoded data.

An artificial intelligence, AI, configured to receive decoded data associated with a dataset as part of a training or inference process, the dataset comprising a base layer comprising data at a first level of quality, and one or more of enhancement layers associated with the base layer, configured to be combined with the base layer to generate data at a various levels of quality, wherein the dataset has been processed by:

Identifying a processing device with a target resolution size for input data;

Sending to the processing device the base and enhancement layers which provide a level of quality closer to the target resolution than the full resolution dataset;

Processing the base and enhancement layers which provide a level of quality closer to the target resolution than the full resolution dataset using the processing device to produce the decoded dataset.

An artificial intelligence, AI, configured to receive decoded data associated with a dataset as part of a training or inference process, the dataset comprising a base layer comprising data at a first level of quality, and one or more of enhancement layers associated with the base layer, configured to be combined with the base layer to generate data at a various levels of quality, wherein the dataset has been processed by:

identifying at least one enhancement layer for removal;

sending the remaining portions of the dataset not including the at least one enhancement layer identified for removal to a decoder;

decoding the remaining portions of the dataset to produce decoded data.

An artificial intelligence, AI, configured to receive decoded data associated with a dataset as part of a training or inference process, the dataset comprising a base layer comprising data at a first level of quality, and one or more of enhancement layers associated with the base layer, configured to be combined with the base layer to generate data at various levels of quality, wherein the dataset has been processed by:

decoding the dataset at a selected level of quality

identifying a region of interest using the dataset at the selected level of quality

decoding a portion of the dataset containing the region of interest to a further level of quality

### CPU/Cuda/Open CL Decoder

A decoder, suitable for use as part of an AI system, configured to:

receive an (entire) encoded bitstream;

receive an indication of a LOQ to be decoded;

output a decoded rendition of the bitstream, decoded to the indicated LOQ.

An AI system, configured to:

request a bitstream to be decoded to an indicated LOQ;

receive a decoded rendition of the bitstream, decoded to the indicated LOQ.

### Decode Region of interest

A decoder, suitable for use as part of an AI system, configured to:

receive an encoded bitstream;

receive a request to decode a ROI of the encoded bitstream at an indicated LOQ;

output a decoded region of interest at the specified LOQ.

An AI system, configured to:

request a decoded region of interest at a specified LOQ of an encoded bitstream;

receive the decoded region of interest at a specified LOQ.

### Partial fetch and decode

A decoder, suitable for use as part of an AI system, configured to:

decode a received portion of an encoded bitstream, where the decoding only processes the portion required to decode to an indicated LOQ.

An AI system, configured to:

request a portion of an encoded bitstream, wherein the requested portion is a portion of the encoded bitstream that is associated with a LOQ (and any LOQs required to reconstruct the indicated LOQ);

receive only the portions of the encoded bitstream that are needed to decode the signal to the indicated LOQ.

### Thumbnail ROI

A decoder, suitable for use as part of an AI system, configured to:

decode a signal (i.e. entire signal, not a portion) to a specified LOQ (and output);

decode, by utilising the decoded signal at the specified LOQ, a region of interest at a higher quality LOQ (and output).

An AI system, configured to:

Request a (entire, non-portion) decoded rendition of an encoded bittream at a specified LOQ;

Request a decoded rendition of a ROI of the encoded bitstream at a higher LOQ

(Request a further decoded rendition of a ROI of the encoded bitstream at the higher LOQ);

Request an additional decoded rendition of a ROI of the encoded bitstream at a further higher LOQ.

### Resize

A decoder, suitable for use as part of an AI system, configured to:

receive an instruction to (a GPU) decode to a specified LOQ, wherein the specified LOQ has a closest (and/or higher) attribute (e.g. resolution) to a target attribute;

decode to the specified LOQ;

Send the decoded signal to a resizing function, wherein the resizing function resizes the decoded signal to the target attribute.

An AI system, configured to:

send instructions to (a GPU) decode to a specified LOQ;

Wherein the specified LOQ has a closest (and/or higher) attribute (e.g. resolution) to a target attribute.

### Progressive rendering

A decoder, suitable for use as part of an AI system, configured to:

receive a first portion of a bitstream corresponding to a first LOQ, wherein the specified LOQ has a first attribute (e.g. resolution, frame rate);

(optionally, request to) receive a second portion of a bitstream corresponding to a second LOQ, wherein the specified LOQ has a second attribute (e.g. resolution, frame rate) (the second attribute being higher and / or better than the first attribute); and

decode (and display and / or process) the first LOQ whilst (e.g. simultaneously, concurrently, partially overlapping) the second portion of the bitstream is being received.

An AI system, configured to:

receive a first portion of a bitstream corresponding to a first LOQ, wherein the specified LOQ has a first attribute (e.g. resolution, frame rate);

(optionally, request to) Receive a second portion of a bitstream corresponding to a second LOQ, wherein the specified LOQ has a second attribute (e.g. resolution, frame rate) (the second attribute being higher and/or better than the first attribute); and

decode (and processing and/or display) the first LOQ whilst (e.g. simultaneously, concurrently, partially overlapping) the second portion of the bitstream is being received.

### Partial bitstream access

A decoder, suitable for use as part of an AI system, configured to:

receive a first portion of a bitstream corresponding to a first LOQ, wherein the specified LOQ has a first attribute (e.g. resolution, frame rate);

receive a second portion of a bitstream corresponding to a second LOQ, wherein the specified LOQ has a second attribute (e.g. resolution, frame rate) (the second attribute being higher and / or better than the first attribute); and

determining to decode (and decoding and/or display and / or process) one of the first LOQ or second LOQ, without decoding the other LOQ (based on the needs of the decoder).

An AI system, configured to:

receive a first portion of a bitstream corresponding to a first LOQ, wherein the specified LOQ has a first attribute (e.g. resolution, frame rate);

receive a second portion of a bitstream corresponding to a second LOQ, wherein the specified LOQ has a second attribute (e.g. resolution, frame rate) (the second attribute being higher and / or better than the first attribute); and

determining to decode (and decoding and/or display and / or process) one of the first LOQ or second LOQ, without decoding the other LOQ (based on the needs of the AI).

The described methods introduce utilising a hierarchical coding format to enhance LMM training efficiency by reducing computational overhead, improving preprocessing times, and optimizing memory bandwidth usage. The methods provide a scalable and practical solution for training multimodal AI models at scale.

Any feature in one aspect of the disclosure may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure also provides a computer program and a computer program product comprising software code adapted, when executed on a data processing apparatus, to perform any of the methods described herein, including any or all of their component steps.

The disclosure also provides a computer program and a computer program product comprising software code which, when executed on a data processing apparatus, comprises any of the apparatus features described herein.

The disclosure also provides a computer program and a computer program product having an operating system which supports a computer program for carrying out any of the methods described herein and/or for embodying any of the apparatus features described herein.

The disclosure also provides a computer readable medium having stored thereon the computer program as aforesaid.

The disclosure also provides a signal carrying the computer program as aforesaid, and a method of transmitting such a signal.

The disclosure extends to methods and/or apparatus substantially as herein described with reference to the accompanying drawings.

The disclosure will now be described, by way of example, with reference to the accompanying drawings.

### DESCRIPTION OF THE DRAWINGS

FIG. 1 shows a computer device on which aspects of the systems and methods disclosed herein may be implemented.

FIGS. 2a and 2b show, respectively, methods of training and using a machine learning model.

FIG. 3 shows a set of image data suitable for providing to a machine learning model.

FIGS. 4a, 4b, and FIG. 4c show a codec that comprises one or more enhancement layers.

FIGS. 5a and 5b show a codec that allows independent decoding of separate image regions.

FIG. 6 shows a method of generating an image based on a determined enhancement layer.

FIGS. 7a and 7b show a method of generating a version of an image based on a determined region of interest in the image.

FIG. 8 shows a method of allocating different regions of an image to different processing components for decoding.

FIG. 9 shows a method of encoding an image so as to be suitable for use with an image classification model.

FIG. 10 shows an exemplary architecture with which the described methods may be implemented.

FIG. 11 shows a method of training a machine learning model.

FIG. 12 shows a method of outputting a feature representation using a machine learning model.

FIGS. 13a-13d show methods of using an input image to determine tensors that can be provided to a machine learning model.

FIG. 14 shows a method of pre-processing images prior to providing a representation of the images to a machine learning model.

FIGS. 15a and 15b show methods of obtaining tensors that can be provided to a machine learning model.

FIG. 16 shows a pipeline for performing analysis using an AI model.

### DESCRIPTION OF THE PREFERRED EMBODIMENTS

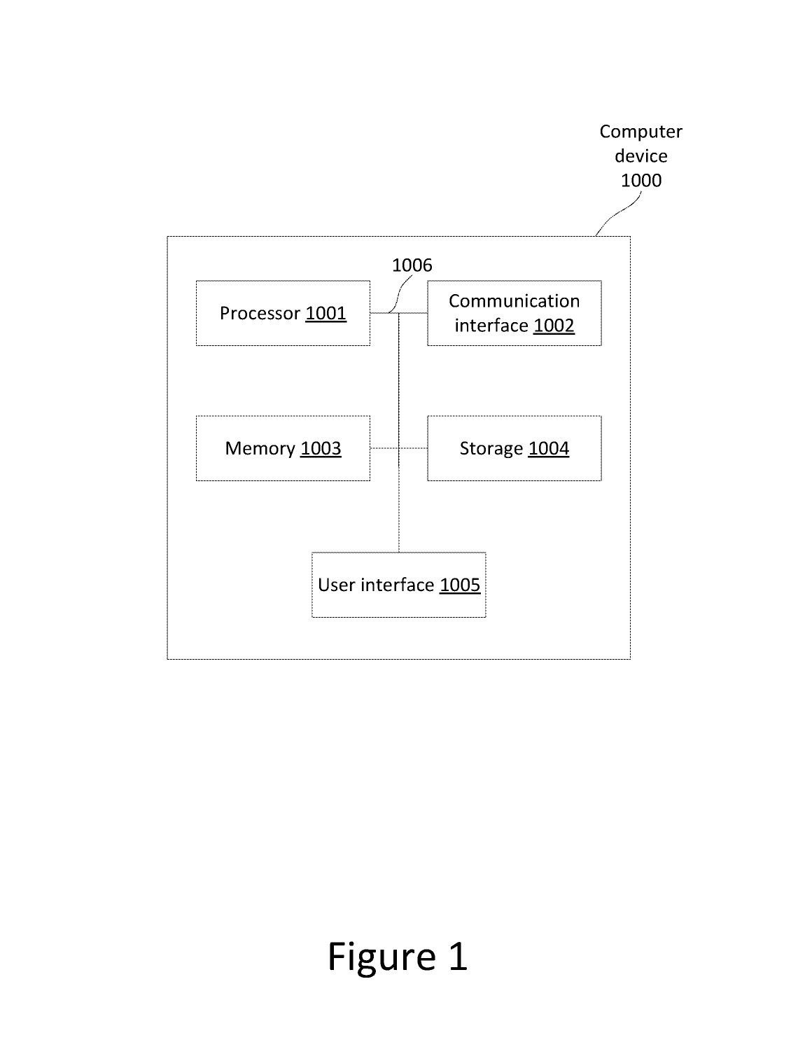

Referring to FIG. 1, there is described a computer device 1000. The systems and methods disclosed below may be implemented using such a computer device (or may be implemented using a plurality of computer devices.

Each computer device comprises one or more of: a processor 1001 for executing instructions (e.g. so as to perform one or more of the steps of the various methods described below), a communication interface 1002 for facilitating communication between computer devices (e.g. an ethernet interface, a Bluetooth® interface, or a universal serial bus (UBS) interface, a memory 1003 and/or storage 1004 for storing information and instructions (e.g. a random access memory (RAM), a read only memory (ROM), a hard drive disk (HDD) a solid state drive (SSD), and/or a flash memory, and a user interface 1005 (e.g. a display, a mouse, and/or a keyboard) for enabling a user to interact with the computer device. These components may be coupled to one another by a bus 1006 of the computer device.

The computer device 1000 may comprise further (or fewer) components. For example, computer devices for training image classification systems may comprise servers that provide only a communication interface to enable interaction with these devices. These servers may not provide a separate user interface.

Typically, the computer devices used to train and implement the disclosed image classification systems comprise one or more graphical processing units (GPUs). More specifically, the methods disclosed herein are particularly suitable for use with GPUs that comprise a large number of cores (e.g. at least 1000 and/or at least 10000) and/or are particularly suitable for use with devices that comprise a plurality of GPUs. Such arrangements enable the parallel performance of operations. Many of the methods disclosed herein are parallelisable, so that these operations can be performed quickly and efficiently by computer devices with a large number of cores and/or processing units.

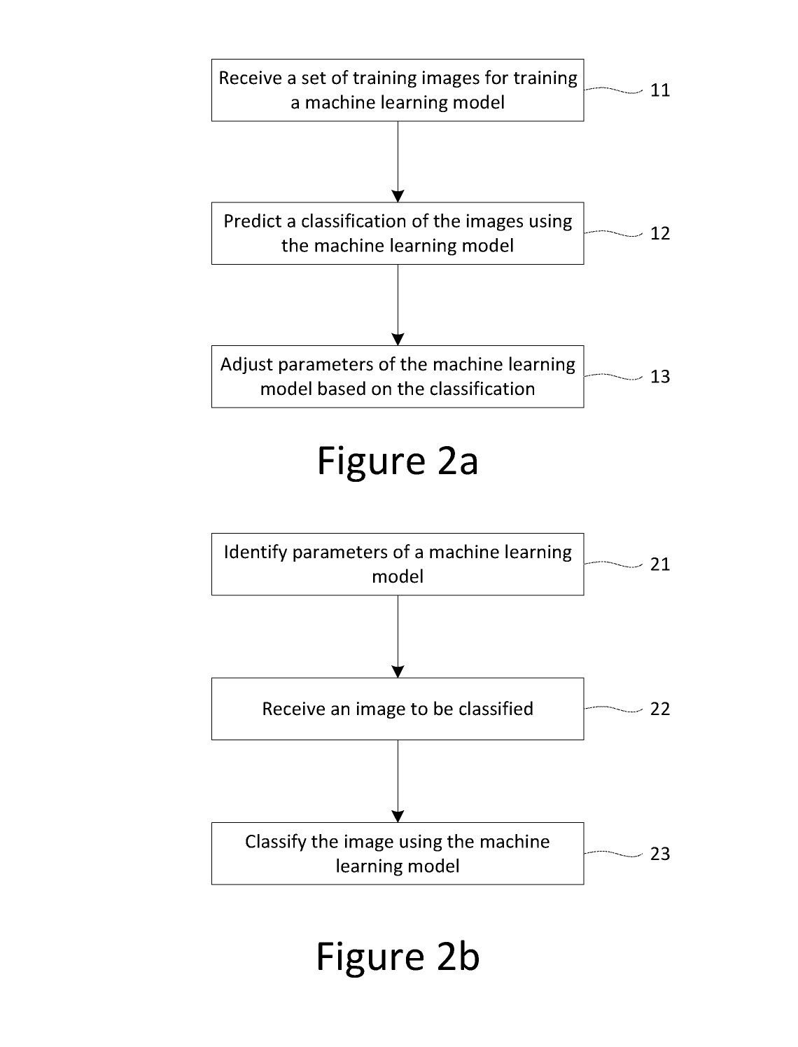

Referring to FIGS. 2a and 2b, there are shown a method of training an image classification system and a method of using this image classification system. The image classification system typically comprises an artificial intelligence (AI) or machine learning (ML) system. In particular, the image classification system may comprise a large language model (LLM). Each of these methods is performed by a computer device (and these methods could be performed by the same device or by different devices).

Referring to FIG. 2a, in order to train a classification system: in a first step 11, the computer device receives a set of training images for training the machine learning model; in a second step 12, the computer device predicts a classification of the images using the machine learning model; and in a third step 13, the computer device adjusts parameters of the machine learning model based on the classification.

Typically, the set of training images comprises images of a known type. For example, in order to train the machine learning model to accurately classify images of cats, the training set may comprise a plurality of images that contain cats (as well as other images that do not contain cats). The machine learning model is then used to predict whether or not each image contains a cat and the parameters of the machine learning model (e.g. the weights of a neural network) are updated based on an accuracy of this prediction.

Referring to FIG. 2b, once the machine learning model has been trained this model can be used to classify unknown images (and the parameters/weights of the machine learning model can be transmitted to other devices to export the machine learning model).

Thereafter, in order to classify an image using the machine learning model: in a first step 21, a computer device identifies parameters of the (trained) machine learning model; in a second step 22, the computer device receives an image to be classified; and in a third step 23, the computer device classifies the image using the machine learning mode.

The training of the machine learning model may comprise associating the images in the training set (or parts of these images) with descriptive tokens. For example, an image of a cat may be associated with the tokens: ‘cat’, ‘pet’, ‘cute’. Training the machine learning model may then comprise predicting descriptive tokens for this image based on an initial set of parameters and then updating the parameters based on a loss function (and based on a difference between the tokens associated with the image and the predicted tokens).

It will be appreciated that the above example is a very simple example and that various, more complex, methods of training machine learning models are known in the art.

Classifying an image typically comprises identifying an object in an image, identifying a feature of an image (e.g. an emotion of an image), and/or providing a description of an image or a part of an image.

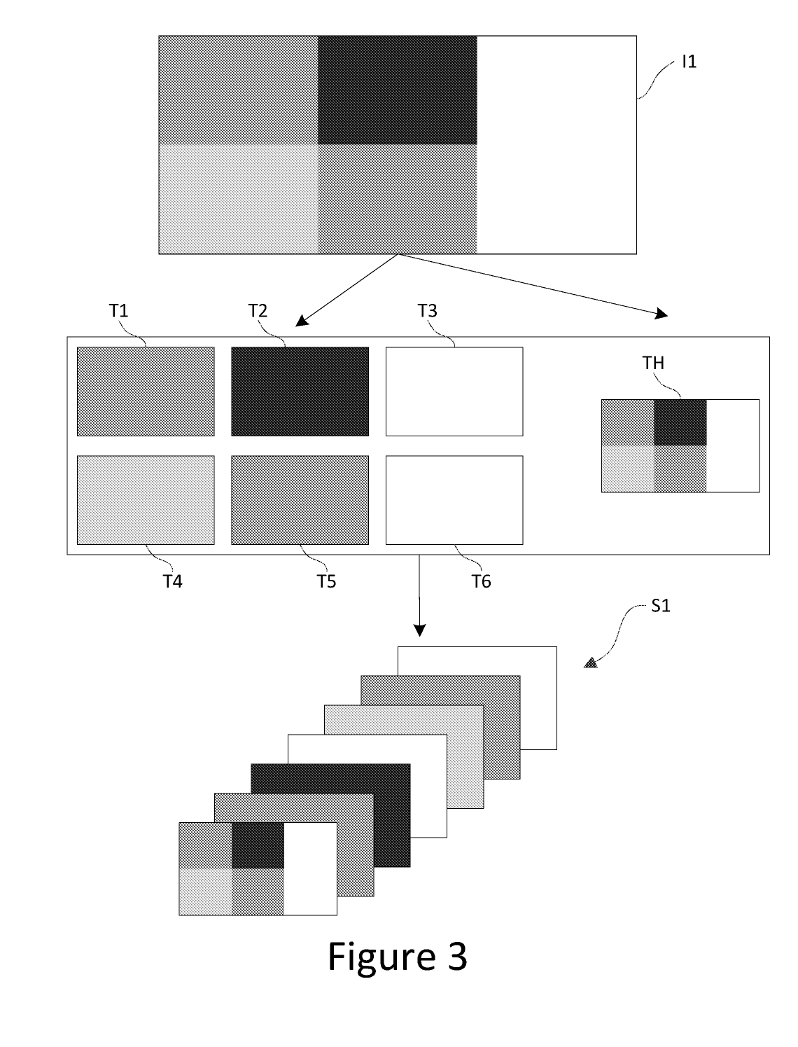

Referring to FIG. 3, there is shown a method of obtaining a set of tiles for providing to a machine learning model. This set of tiles may be part of a training set of image data and/or this set of tiles may be obtained from an image that is being classified.

Typically, in order to classify an image, the machine learning model is arranged to receive a set of image data S1 that comprises image tiles of a predetermined size and/or resolution. For example, a machine learning model may be arranged to receive a 3x2 arrangement of tiles, where each tile has a size of 448 x 448 pixels.

This set of image data S1 is typically formed from an initial image. Therefore, as shown in FIG. 3, in order to generate the set of image data, a computer device may be arranged to: receive an input image I1; divide this image into a plurality of tiles T1, T2, T3, T4, T5, T6, and to combine these tiles into the set of image data.

Breaking the initial image into a set of separate tiles enables the set of image data S1 to comprise a number of image tokens that can enable a more efficient classification than if the image is provided as a whole. This is similar to the manner in which sentences are broken into component words, or component phenomes, during the training of text classification models. Essentially, the set of image data comprises a set of image tokens, where each of these tokens (and/or a given combination of tokens) can be appropriately associated with a classification. For example, if a first image shows a cat in a city apartment and a second image shows a cat in a barn, these images may (as a whole) be very different. But if the images are tokenised to form respective sets of image data, then a token from each set can be used to identify that each image contains a cat. The process of tokenising images can be used to provide more accurate and versatile image classification models than is possible if only whole images are provided as part of the training set.

In some embodiments, the set of tiles comprises a thumbnail TH of the image I1, so the computer device may generate this thumbnail and include this thumbnail in the set of image data S1. Typically, this comprises generating a thumbnail that is the same size and/or resolution as the tiles. Therefore, the machine learning model may receive both the image as a whole and the tokenised version of the image that is provided by the tiles.

Considering a practical example in which the input image I1 has a size of 1344 x 896, the computer device may be arranged to divide this input image into a 3x2 arrangement of tiles T1 … T6 with each tile having a size of 448x448. The computer device may also be arranged to generate a thumbnail TH that has a size of 448x448 by downsampling or downscaling the input image. The computer device may then compile the set of image data S1 using the tiles T1 … T6 and the thumbnail TH.

It will be appreciated that various input formats (e.g. various shapes and sizes of tiles) may be required by different machine learning models and that the machine learning models may comprise differing levels of strictness regarding input requirements. For example, some machine learning models may impose requirements on both a size of tiles and an arrangement of tiles in an input whereas some machine learning models may impose requirements on a size of files but may accept any number of tiles in as set of image data.

In some embodiments, the computer device is arranged to generate and/or divide the tiles to obtain a desired shape of tile, such as a square tile.

In some embodiments, the computer device is arranged to pad and/or crop the image and/or the tiles in order to obtain a desired format of image/tile. For example, tiles may be padded in order to generate square tiles. Padding the tiles may comprise adding pixels to the tiles based on the content of the tiles or adding arbitrary padding pixels.

In some embodiments, the computer device is arranged to pad images so as to obtain square images (by padding the lesser of the height or the width of an image). In some embodiments, the computer device is arranged to pad images by adding pixels with values that are an average of the pixel values of the original images.

There are a number of inefficiencies that can occur during this generation of the set of image data and aspects of the present disclosure relate to methods and systems for increasing the efficiency of the generation of the set of image data S1.

For example, where an initial image provided to the image classifier is of an unsuitable size, the computer device may need to upsample or downsample this image before dividing this image into tiles. This can lead to inefficiencies where, for example, a high quality image is received and is then substantially downsampled in order to provide the tiles. The time required to decode the (unnecessarily) high quality image before the downsampling could be considered to be wasted time since the image could have been provided in a lower quality.

Aspects of the present disclosure consider a system that comprises both an encoder and a decoder, where the encoder is arranged to encode images so that they can be transmitted to the decoder, and the decoder is arranged to decode these images and to provide the decoded images to the image classifier. This arrangement enables the encoder to encode the images in dependence on the image classifier so that the images can be encoded so as to be decodable in a format that is suitable for the image classifier.

### Codecs

Aspects of the present disclosure rely on the use of codecs for images and video that enable improvements in the process of generating the set of image data S1. Examples of such codecs are the SMPTE VC-6 and MPEG LCEVC codecs. It will be appreciated that these codecs are simply exemplary codecs and that other codecs could be used to provide the benefits disclosed herein.

VC-6 is a hierarchical image codec standardized by SMPTE (Society of Motion Picture and Television Engineers) in 2020, and revised in 2023 as SMPTE ST 2117-1:2023, designed for scalable image representation. It employs intra-frame compression, ensuring that each frame is stored independently without dependencies on adjacent frames. This design supports both lossless and lossy compression, allowing control over quality and computational trade-offs. Unlike conventional codecs that rely on Discrete Cosine Transform (DCT) or wavelet-based techniques, VC-6 uses hierarchical s-tree data structures to enable multi-resolution decoding and parallelized processing. By allowing selective access to different levels of detail, VC-6 supports efficient data retrieval and minimizes computational overhead, aligning with the needs of AI-driven applications, including large-scale multimodal model training.

In particular, aspects of the present disclosure relate to codecs that provide a base layer and one or more enhancement layers and aspects of the present disclosure relate to codecs that enable the independent decoding of separate portions of an image, as described below.

### Enhancement layers

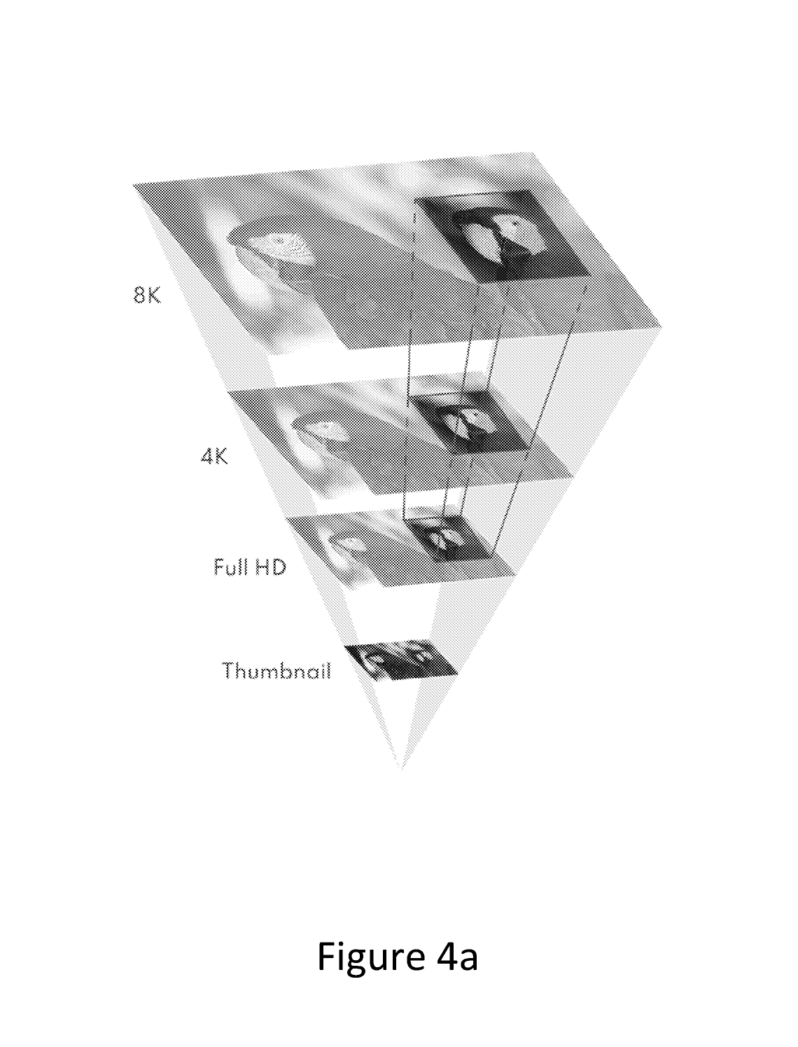

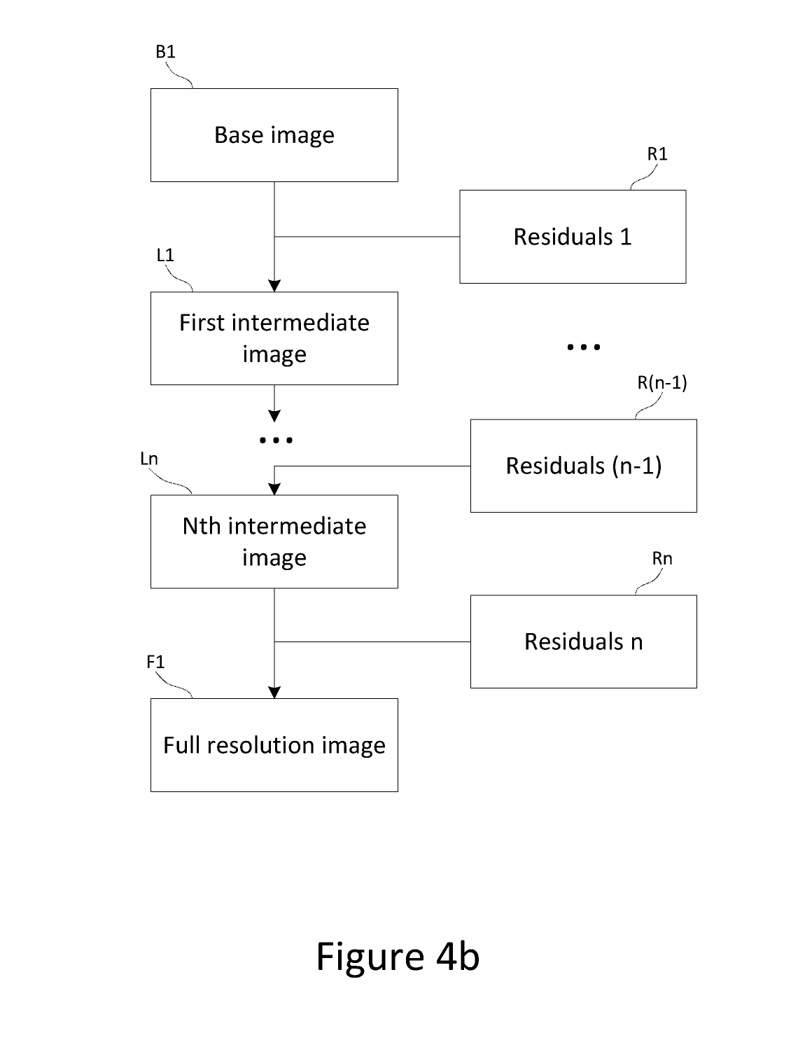

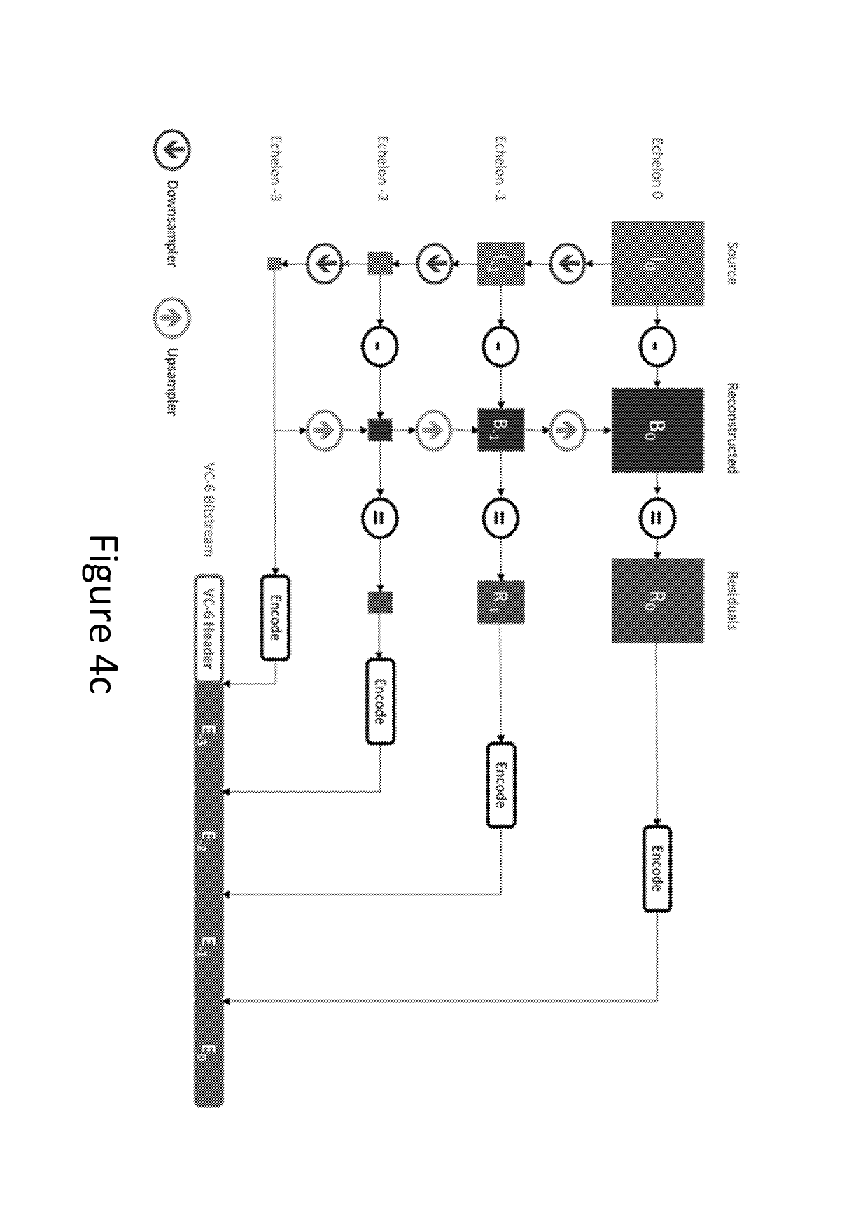

A codec that comprises a base layer and one or more enhancement layers is described with reference to FIGS. 4a, 4b, and FIG. 4c. Examples of such codecs are the VC-6 and LCEVC codecs .

Referring to FIG. 4a, there is shown an example of an image that can be provided in four resolutions (or four ‘qualities’ or four ‘levels of quality’): a thumbnail resolution, a full HD resolution, a 4K resolution, and an 8K resolution. Each of these resolutions may be considered to be a different ‘layer’ of an image or a different ‘version’ of an image. Each level of quality is associated with a respective enhancement layer, where a bitstream comprising the image may include a plurality of enhancement layers. A device that is decoding this bitstream is then able to select a subset of these enhancement layers in order to obtain an image of a required quality. For example, if the decoder only requires a full HD resolution, then only a single enhancement layer may be considered; if the decoder requires a 4K resolution, then two enhancement layers may be considered.

Referring to FIG. 4b, there is shown an exemplary arrangement for providing these different levels of quality. As shown in this figure, the enhancement layers required to obtain these different levels of quality are typically provided in a bitstream that is received by a computer device that comprises a decoder.

As shown in FIG. 4b, the bitstream is arranged so that the computer device is able to extract a base image B1 from the bitstream (e.g. the thumbnail), the base image having a first (lowest) level of quality (e.g. resolution).

This description primarily describes ‘levels of quality’ in terms of low levels of quality that provide low resolution and higher levels of quality that provide higher resolutions. It will be appreciated that in practice (e.g. in certain codecs) a base, or zeroth, level of quality may instead define to a highest quality image, with 1st and 2nd (etc.) levels of quality defining lower quality images. It will be appreciated that in such implementations the base level would provide a level of quality with a highest resolution with the further levels of quality providing lower resolution. Therefore, the base level would be a highest, or maximum, level of quality according to the methods herein with the other levels being lower levels of quality (albeit with higher ordinals). Equally, the base level may be a zeroth, highest, level of quality with the other levels of quality being lower levels that are a -1 level, a -2 level, …, a -n level. Where the levels of quality are increasing levels of quality, the lowest (e.g. -nth) level of quality may be considered to be the ‘base’ representation.

In this regard, typically, the ‘base representations’ at the first, lowest, level of quality are typically at a level of quality that is LOQ-n, the second level of quality may then be a level of quality that is LOQ-(n-1), with the highest level of quality being at a level of quality that is LOQ0.

Furthermore, while the description primarily describes ‘levels of quality’ as being related to resolutions, it will be appreciated that other metrics may define a quality of an image. For example, the level of quality of an image may be dependent on a bit depth, a colour range, or a quantisation level of the image.

The computer device is able to obtain an image of increased resolution by combining this base image B1 with a first set of residuals R1 so as to generate a first intermediate image L1 with a first resolution.

Typically, the bitstream is provided so that the computer device is able to obtain the first intermediate image by upscaling or upsampling the base image B1 and then combining this upscaled image with the first set of residuals R1. The first set of residuals is typically determined at an encoder by performing a similar upscaling process on the base image and then determining the residuals as the difference between this upscaled based image and a target image at the first resolution. The residuals are then provided in the bitstream.

The upsampling may use various upsampling techniques, for example a nearest neighbour upsampler, a bicubic upsampler, a sharp upsampler, a nonlinear 9-transformer upsampler. The choice of upsampler to used may be signalled in the bitstream so that the decoder can identify a suitable upsampler to use for upsampling the base image B1 so as to obtain the first intermediate image L1.

Once the computer device has obtained the first intermediate image L1, the computer device is able to obtain a higher quality, second intermediate image by combining this first intermediate image with a second set of residuals. This process can continue until the computer device combined an nth intermediate image Ln with an nth set of residuals Rn in order to obtain a full resolution image F1.

Each image is associated with an enhancement layer so that, for example, the first intermediate image L1 is determined by combining the base image B1 with a first set of residuals associated with a first enhancement layer.

It will be appreciated that in different implementations, different numbers of intermediate images may be provided. For example, the example of FIG. 4a contains a base, thumbnail, image, a first intermediate, full HD, image, a second intermediate, 4K, image and a full quality, 8K, image. These images may be considered to be different versions of different layers of an encoded image (where, e.g., the base image comprises a base layer of the image, the full HD image comprises a second layer of the image, etc.).

While the example of FIG. 4b describes a hierarchical arrangement in which the first intermediate image L1 is obtained using the base image and then the second intermediate image is obtained using the first intermediate image, it will be appreciated that the bitstream may define a plurality of images of different resolutions where each image is associated with a base image and with a different set of residuals.

For example, a first intermediate image may be obtained by upscaling the base image to a first resolution to obtain a first upscaled image and then combining this first upscaled image with a first set of residuals and a second intermediate image may be obtained by upscaling the base image to a second resolution (e.g. that is larger than the first resolution) to obtain a second upscaled image and then combining this second upscaled image with a second set of residuals.

Typically, each level of quality is associated with a sampling ratio of 2 in both height and width (so that the first intermediate image L1 has a resolution that is four times the resolution of the base image B1, the second intermediate image has a resolution that is four times the resolution of the first intermediate image, and so on). However, it will be appreciated that various sampling ratios are possible (e.g. a sampling ratio of 0.75, 1.5, and/or 4). Typically, the sampling ratio is related to a two-dimensional sampling (e.g. that relates to an increase in both height and width), but it will be appreciated that one-dimensional upsampling/downsampling is possible. Furthermore, three-dimensional upsampling/downsampling is possible where the disclosures herein are applied to three-dimensional images.

At least one aspect of the present disclosure relates to a method of configuring a sampling ratio for an enhancement layer of a codec based on an input format for an image classifier (e.g. to select an upsampling ratio between a base layer and a first level of quality based on a required input format for an image classifier).

Typically, the level of quality is arranged to increase at a constant rate with each enhancement layer. However, it will be appreciated that the level of quality may improve in an irregular manner between enhancement layers. For example, the first intermediate image may be four times the resolution of the base image and then the second intermediate image may be four times the resolution of the first intermediate image. Equally, the first intermediate image may be four times the resolution of the base image and then the second intermediate image may be twice the resolution of the first intermediate image.

In some embodiments, each enhancement layer is obtained by combining a corresponding set of residuals with a previous enhancement layer. However, typically, each enhancement layer is obtained by combining a corresponding set of residuals with the base layer. Typically, the bitstream is arranged to enable separate/independent determination of each set of residuals so that images of each level of quality can be determined independently. Therefore, a first computer device may obtain an image with a first level of quality by combining a first set of residuals with the base image and a second computer device may obtain an image with a second level of quality by combining a second set of residuals with the base image. By enabling this independent formation of each level of quality, different devices can efficiently obtain different images (with different levels of quality). This enables the computer device to efficiently determine image tiles of a suitable level of quality in various situations.

Referring to FIG. 4c, there is shown a specific implementation of the aforementioned codec that is found in a VC-6 codec. In this codec, the residuals for different intermediate images (for different ‘echelons’) are defined in different parts of a bitstream. The header of the bitstream contains information about, e.g. the upsamplers used between the echelons.

Advantageously, with this arrangement a decoder only needs to parse and process the residuals required to obtain an image of a required resolution. So a single bitstream can encode an image at a plurality of resolutions (e.g. thumbnail, full HD, 4K, 8K) and then if an image classifier only requires a full HD image, then the decoder can consider only a first set of residuals.

### Independent encoding

The codec typically enables each image in a stream of images to be decoded independently (e.g. the codec typically does not use any inter-coding processes).

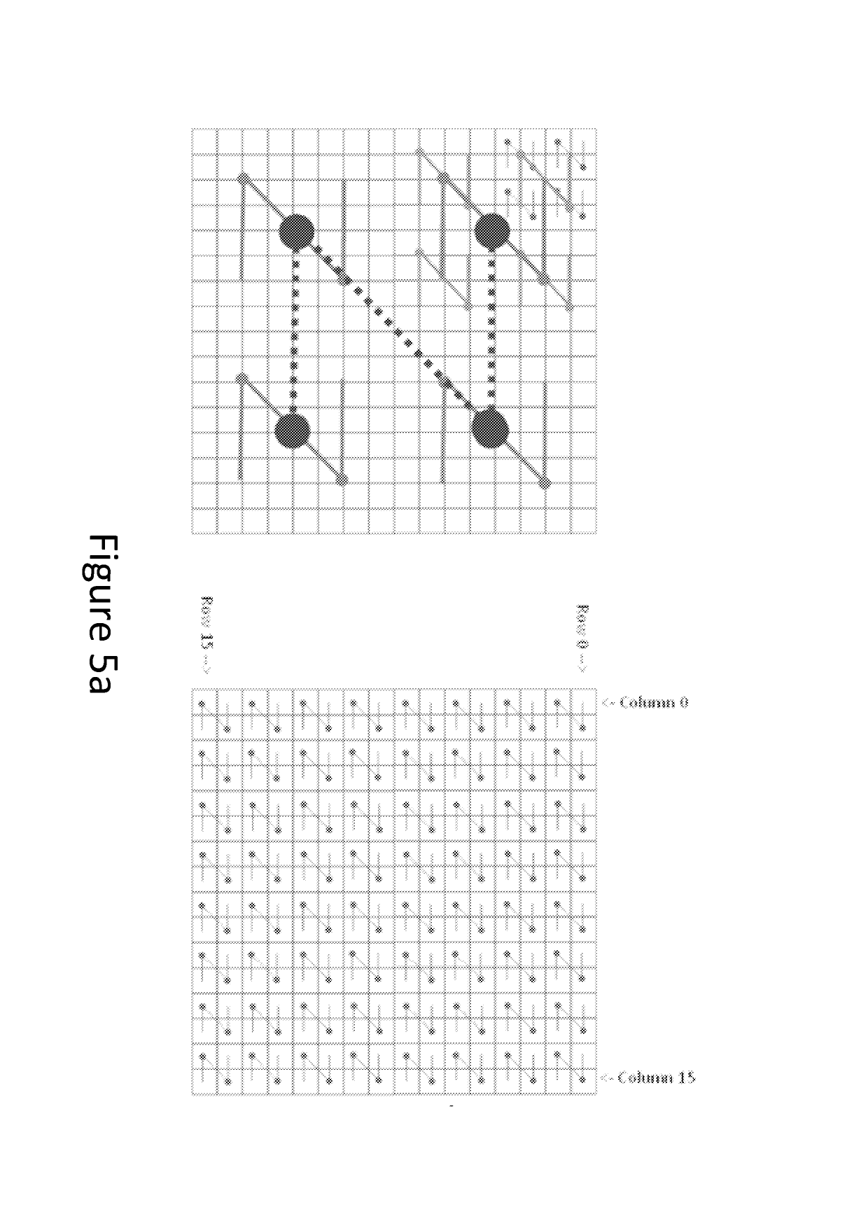

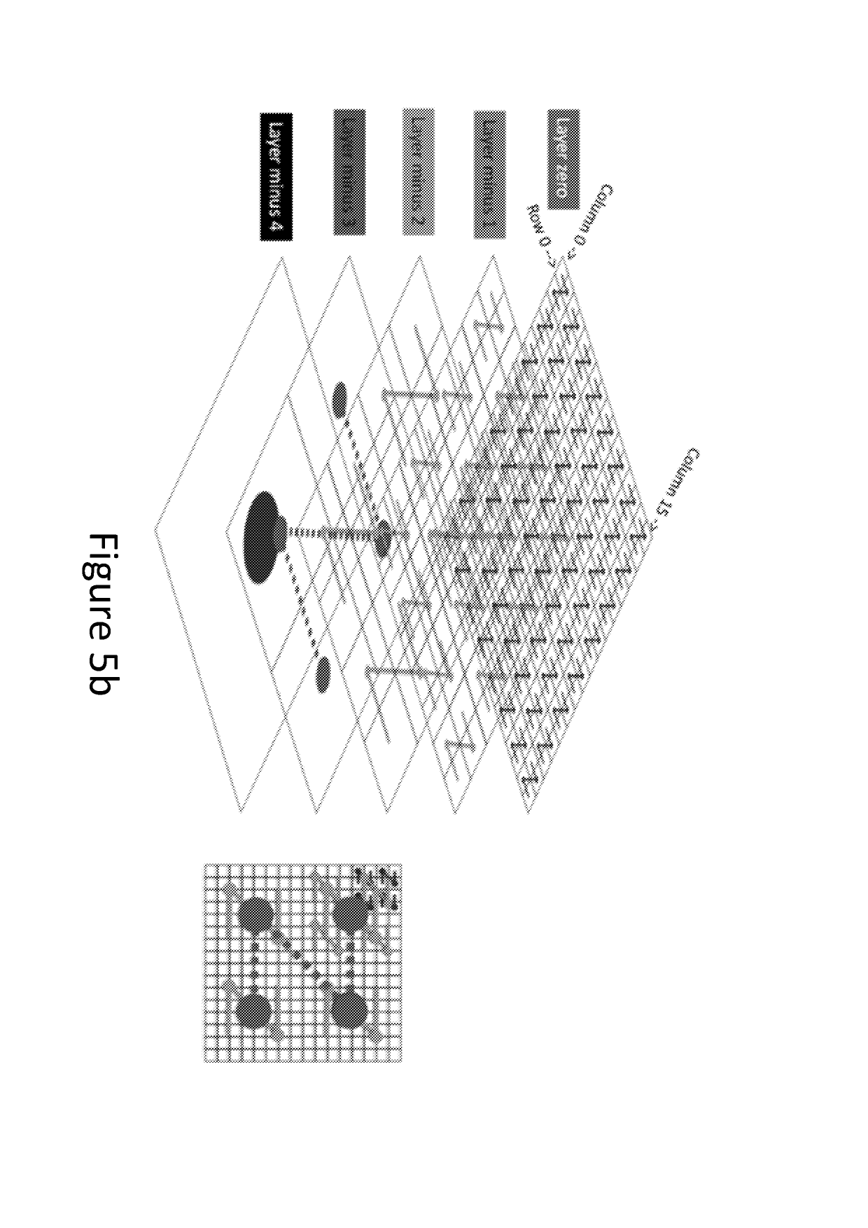

Furthermore, referring to FIGS. 5a and 5b, the codec typically enables separate areas of each image to be decoded independently. With the VC-6 codec, this is achieved using s-trees, where different areas of the image are encoded using different nodes of a layer of an s-tree. For example, a first node of a layer may define pixels in a top-left quadrant of an image, a second node of the layer may define pixel values in a top-right quadrant, and so on.

Typically, the codec uses a hierarchical encoding structure, where a first layer of the structure divides the image into a first number of sections, with each section being defined by a node of the first layer, a second layer of the structure divides the image into a second, larger, number of sections, with each node of the first layer being associated with a plurality of the nodes of the second layer, and so on. Therefore, each layer of the structure comprises an increasing number of nodes in a tree-and-branch arrangement. A decoder can decode only a part of an image by decoding only a subset of the branches of this structure.

Where the codec provides one or more enhancement layer, each enhancement layer may be associated with a different (or a connected) encoding structure so that regions can be separately and independently decoded for each level of quality.

Referring to the example of FIGS. 5a and 5b, it can be seen that the layer minus 3 divides the image into four separate portions, the layer minus 2 divides the image into sixteen separate portions, the layer minus 1 divides the image into sixty four separate portions, and the layer zero divides the image into two hundred and fifty six separate portions. In order to decode only a single portion of the image, a subset of these portions can be decoded. For example, to decode a 4x4 block in the top left corner of the image, only a single portion of the layer minus 1 needs to be decoded (which may requires decoding the layer minus 4 layer and then only decoding a portion of the resultant data from this decoding).

This ability to separately decode different portions of the image enables a computer device to only decode necessary information from an image.

It will be appreciated that this VC-6 implementation is purely exemplary and that various methods are possible for encoding an image such that different portions of this image can be independently decoded (and/or such that the image can be decoded using one or more enhancement layers). For example, the low complexity enhancement video codec (LCEVC) provides comparable features.

### Codec configuration

In some embodiments, the method may comprise configuring a codec in order to define a configuration parameter of the codec. For example, the method may comprise configuring a codec to select a coding structure (e.g. a hierarchical structure or an s-tree) for encoding an image, e.g. to select a number of nodes in a layer of the structure. Equally, the method may comprise selecting a level of upscaling for one or more enhancement layers.

Furthermore, the method may comprise determining locations of encoding boundaries for regions of an image (e.g. determining locations for boundaries that separate different branches of a hierarchical encoding structure). For example, if each tile of a set of image data for an image classifier is required to be provided as a 17x17 block of pixels, then the boundary locations may be determined so as to divide the image into 17x17 blocks of pixels. This may comprise defining each layer of an encoding structure to comprise 17 nodes (it will be appreciated that the number 17 is merely exemplary and that the layers may be arranged to comprise any number of nodes).

In some embodiments, a number of regions in a hierarchical arrangement that defines an image is selected in dependence on an input requirement for an image classifier (e.g. based on a required dimension of tiles for an image classifier). For example, a number of pixels in a block may be determined based on this requirement. Similarly, a number of nodes in a layer of an s-tree may be determined based on this requirement. In this regard, an image may be defined based on a hierarchical arrangement such as an s-tree in which the arrangement comprises a plurality of hierarchical layers, with each layer comprising one or more nodes. For example, a first layer may comprise a single node, a second layer may comprise n (e.g. 4) nodes all stemming from the single node, a third layer may comprise n2 (e.g. 16) nodes, with n (e.g.4) nodes stemming from each of the nodes of the second layer, and so on. Typically, the number of nodes in each layer increases with a constant multiplier, but it will be appreciated that different node ratios between layers are possible (e.g. the second layer may comprise n*m (e.g. 20) nodes, with m (e.g. 5) nodes stemming from each of the nodes of the first layer).

According to the present disclosure, the number of nodes in one or more layers of the arrangement may depend on an input requirement of an image classifier.

### Selective upscaling

As described above, the set of image data S1 typically comprises a set of tiles of a predetermined resolution and/or size. Generating the set of image data may comprise forming this set of image data by dividing an input image I1 into tiles of the predetermined size.

In the example provided above, the input image I1 has a size of 1344x896 and the set of image data requires tiles of a size 448x448. Therefore, the input image can be divided into six tiles of the required resolution.

However, a user may wish to train the machine learning model using differently sized images and/or the user may wish to classify differently sized images using the machine learning model.

Where these differently sized images are smaller than a required size, this may require upsampling of the differently sized images, which can lead to a loss of resolution. Where these differently sized images are larger than a required size, this may require downsampling of the differently sized images. For example, if an initial input image is provided with a size of 1000x700, then this image may need to be upsampled to a suitable size so that this image can be divided into tiles of the required size.

In order to avoid a loss of resolution and quality, it is typically desirable to provide images with a size that is greater than the required size and then to downsample these images. However, this can lead to inefficiency, since this requires the computer device to receive images that are more detailed than is strictly necessary.

Furthermore, a user might wish to train different machine learning models on different resolutions or sizes of images, e.g. to provide machine learning models that are suitable for use with different images. With many conventional codecs, this would require either providing a high-resolution image that is then downsampled for use with different codecs or providing a plurality of images in different resolutions in entirely separate bitstreams.

The above-described codecs, which provide a base layer and a plurality of enhancement layers, enable methods with which a bitstream can be used to provide images at a resolution that is suitable for a desired use (without being unnecessarily high-resolution) and also enable methods with which different resolutions of the same image can be extracted from a single bitstream in order to train a plurality of different image classification models (or, more generally machine learning models) and/or in order to train a single image classification model (or, more generally a machine learning model) using different resolutions of the same images. For example, different resolutions may be used to train different aspects of a machine learning model and/or a system, where lower resolution images may be used to train aspects such as object detection aspects and higher resolution images may be used to train aspects such as object classification aspects.

In particular, a method of initially training an image classification model may involve training the model (e.g. for a first one or more training epochs) using images with a first level of quality or a first resolution and then training (e.g. re-training and/or fine-tuning) the model (e.g. for a second one or more training epochs) with a second level of quality or a second resolution. This enables a model to be quickly trained initially using low quality images and then to be refined using higher quality images. With the systems disclosed herein, both of these training steps may be performed efficiently using the same (hierarchically encoded) images, where for example the first training steps may be performed using a base layer only and then the second training steps may be performed by combining the base layer with one or more enhancement layers.

Using images at a particular level of quality may comprise using images at a particular ‘echelon’, ‘layer’, ‘tier’, or ‘LOQ’. For example, the first level of quality may be associated with a first echelon of a VC-6 image and the second level of quality may be associated with a second echelon of a VC-6 image.

Similarly, the method may comprise training the model for a first one or more training epochs using a first one or more regions of interest in a set of images and then training the model for a second one or more training epochs using a second one or more regions of interest in a set of images. In this regard, the present disclosure considers the use of codecs that enable only a portion of an image/video to be decoded (and/or that enable different portions of images/videos to be decoded in different resolutions). This enables the same set of training images/videos to be used to provide different tiles (tokenised inputs) to the machine learning model for different training epochs.

In this regard, using specific VC-6 and/or LCEVC functionalities to perform adaptive tokenization (e.g. to provide images of different resolutions) during multimodal GenAI training enables improvements to the training of machine learning models. Currently (e.g. using non-hierarchical codecs) the choice of image-video tokenization (and the step of content preparation/pre-processing) is static and not subject to the learning epochs of GenAI training. With hierarchical and/or parallel codecs such as - by way of non-limiting example - SMPTE VC-6, it is possible to adapt the way in which AI processes the same source video during a plurality of training epochs. This may mean that during the first epochs certain objects or details or resolution levels are not considered important, while in subsequent epochs, as a consequence of learning, the tokenization process starts tokenizing the content in different ways. This is particularly true for space-time patches (e.g., series of frame thumbnails next to one another, at a given resolution and color space), allowing to recognize actions. Furthermore, during the first training epochs, video or images may be mostly processed at low resolution, to avoid wasting time by decoding video or images at an unnecessarily high resolution, while during the latter epochs, when the model has already been trained to a degree and so is more precise than for earlier epochs, the training process could start using video and images at the maximum available resolutions, e.g. at least for certain areas in the video/images. Over time, AI can learn that for certain areas/training epochs it is worthwhile to tokenize high-resolution regions of interest or space-time patches, while for other areas/training epochs it is not helpful to do this.

The present disclosure considers a method of training a machine learning model using a first set of training data during a first training step and a second set of training data during a second training set. The first set of training data and the second set of training data may each be derived from a set of training images comprise images at different levels of quality and/or images that represent different regions of interest within the training images.

For example, the training images may comprise hierarchically encoded images and the first and second sets of training data may be associated with the same images decoded at different levels of quality and/or with different regions of interest. The first set of training data may be associated with a base image or base representation of the training images. The second set of training data may be associated with an enhancement layer (e.g. may comprises images at a higher level of quality than the first set of training data).

The computer device may be arranged to process the training images to decode base images to form the first set of training data and then to reuse these base images to form the second set of training date. This may comprise combining the base images with corresponding enhancement layers and/or processing the base images to extract a region of interest from the base images (and then to, e.g. upscale this region of interest).

This provides an improvement in efficiency as compared to implementations that use non-hierarchical encoding methods. With these implementations, a high resolution image would need to be downscaled repeatedly by different amounts to form the different training sets – there is no possibility of reusing base images to form the training sets.

While the above description has mentioned the use of a first and second set of training data, it will be appreciated that any plurality of sets of training data may be generated based on the training images (e.g. with each set of training data being associated with a different enhancement layer and/or a different level of quality).

In some embodiments, the formation of the training sets is dependent on an output of the machine learning model that is being trained. For example, a convergence or a success of the model over a plurality of training epochs may be determined and the machine learning model may determine the second set of training data based on this convergence (e.g. to generate the second set of training data when the model reaches a first level of success for classifying images in the first set of training data and/or when the degree of convergence indicates the model is no longer improving due to training on the first set of training data.

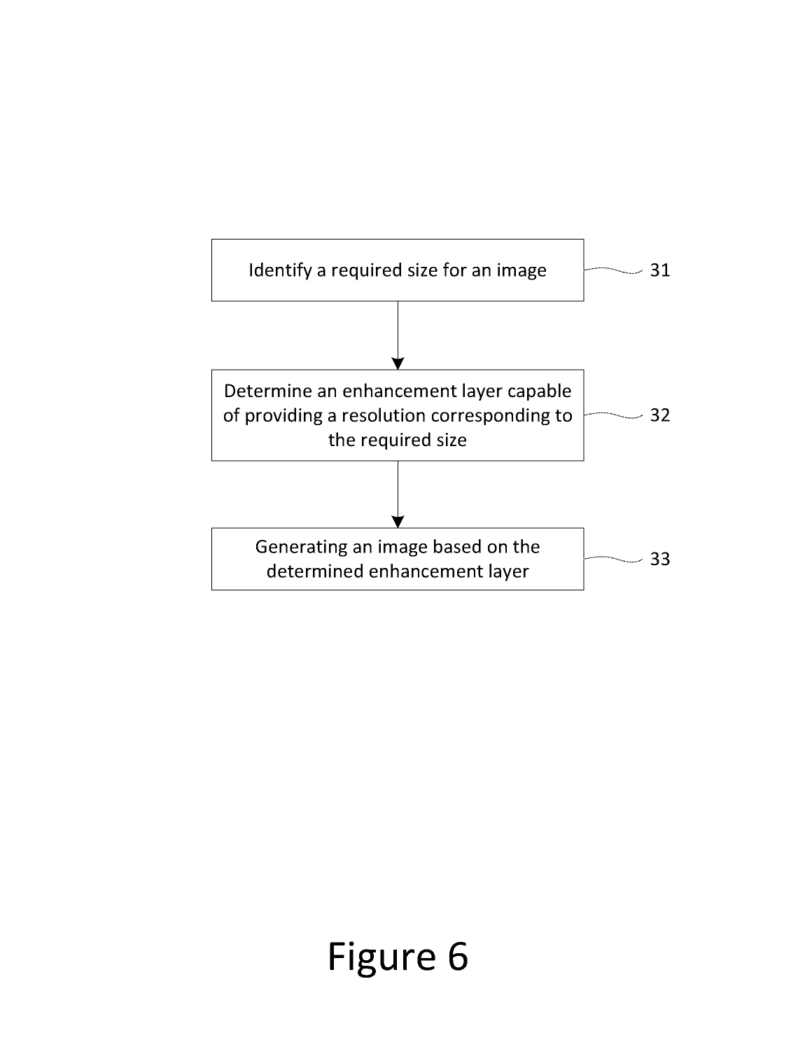

Referring to FIG. 6, there is described a method of generating an image based on an enhancement layer in a bitstream. This method is carried out by a computer device, e.g. by a computer device that is generating a training set of images for a machine learning model.

In a first step 31, the computer device identifies a required size for an image. For example, the computer device may identify that the set of image data S1 requires a 3x2 arrangement of 448x448 tiles and the computer device may then identify that this requires an input image I1 that has a size of (at least) 1344x896.

In a second step 32, the computer device determines an enhancement layer capable of providing a resolution corresponding to the required size. Typically, the computer device is arranged to determine a minimum quality enhancement layer that provides an image of a size greater than the required size.

In a third step 33, the computer device generates an image based on the determined enhancement layer (e.g. the first intermediate image L1).

In some embodiments, the computer device may downsample the generated image in order to generate an image of the required size.

The generated (and, e.g. downsampled) image may then be included in a training set of images. The set of images may then be used to train a machine learning model. Equally, the image may be provided to a machine learning model and classified using the machine learning model. This may comprise extracting tiles from the image (e.g. the whole of, or a portion of, the image).

In practice the enhancement layers provided in the bitstream might not provide an image of exactly the required size. Therefore, the computer device may determine a minimum-resolution enhancement layer that is greater than the required size, generate an image based on this enhancement layer, and then downsample the generated image to the required size.

With many conventional codecs, the computer device might receive an image with a single, high-quality, image and might need to significantly downsample this image in order to obtain an image of the required size. With such an implementation, the decoding of the original image leads to inefficiency, since the high-quality obtained by this decoding is not required. In the context of machine learning models, this can provide a bottleneck, where a computer device training the machine learning models is not able to generate training images at a desired speed.

With the present disclosure, which considers a codec that uses a plurality of enhancement layers, it is possible to reduce this inefficiency by reducing the gap between the quality of a decoded image and the quality of a required image. Therefore, the present disclosure provides methods that avoid the aforementioned bottleneck.

Aspects of the present disclosure consider the use of ‘enhancement layers’ to obtain different ‘levels of quality’. It will be appreciated that numerous different methods (and terms) may be used to provide different levels of quality and that numerous terms may be used to identify different levels of quality. For example, the level of quality may be associated with (or described as) a ‘layer’, a ‘tier’, an ‘echelon’, an ‘LOQ’ of a data structure, such as an image or a video. In a specific example, the level of quality is associated with a resolution in an image that comprises a plurality of echelons at different resolutions so that a device is able to decode the image at any of these echelons/resolutions.

Similarly, the ‘enhancement layers’ or more generally ‘enhancement data’ may be associated with (or described as) ‘residuals’, ‘additional data’, ‘external data’, ‘adjustment data’, ‘correction values’, etc. In general, different levels of quality of data relate to different versions of a data structure (e.g. an image or a video). These versions may differ, for example, in a resolution, a colour gamut, a depth, etc.. ‘Enhancement layers’ or ‘enhancement data’ generally relates to data that can be combined with a first version of a data structure at a first level of quality in order to obtain a second version of the data structure at a second level of quality. This process of combining may involve modifying the first version of the data structure prior to the combining. For example, the process may involve upscaling or upsampling the first version of the data structure and then combining the enhancement data with the modified (e.g. upsampled) first version.

In a practical example, combining the enhancement data with the first version of the data structure may involve upscaling an image or a video and then combining this image/video with residuals (‘enhancement data’) in order to obtain the second version of the data structure.

The residuals may be provided by an encoder that has access to both the first version and the second version of the data structure (so that the encoder is able to determine residuals that can be added to an upscaled first version of the data to regenerate the second version of the data). This may involve the encoder downscaling the second version of the data to obtain the first version of the data and then determining these residuals that can be added (by a decoder) to an upscaled first version of the data to regenerate the second version of the data).

Such a method enables the efficient encoding and transmission of the data structure as well as the efficient decoding of the encoded structure since the decoder is able to decode the structure at only a required level of quality (e.g. the data structure may enable decoding of an image at a plurality of resolutions including a HD resolution, a 4K resolution, and an 8K resolution. If only the HD resolution is required, then the decoder can only generate this HD resolution. Similarly, if the 4K resolution is required then the decoder can generate only the 4K resolution (or both the HD and the 4K resolution, where generating the HD resolution may be required to generate the 4K resolution). This hierarchically-encoded data structure contrasts with non-hierarchical structures that typically enable decoding at only a single resolution. With such a non-hierarchically encoded structure, a decoder that requires a 4K resolution may need to decode a structure at 8K and then downsample this structure, leading to inefficiency.

As described with reference to FIG. 3, in some embodiments the set of images includes a thumbnail TH of the input image I1. Typically, the thumbnail is provided using a lower quality enhancement layer than the determined enhancement layer. That is, the determined enhancement layer that is used to generate the image may have a first level of quality and the thumbnail enhancement layer that is used to generate the thumbnail may have a second level of quality. The second level of quality may be different to the first level of quality, for example the second level of quality may be lower than the first level of quality. For example, the thumbnail may be generated using the base image B1.

More generally, the methods disclosed herein envisage generating a set of image data for an image, wherein the image data comprises a plurality of tiles from the image. In some embodiments, the plurality of tiles comprise tiles with differing levels of quality, where the tiles may be associated with a plurality of different layers and/or enhancement layers of an encoded image.

In some embodiments, the computer device is arranged to identify an object in the image and to extract a region including this object at a third level of quality (e.g. a highest level of quality). This region may be provided as a tile in the set of image data S1. This tile may also be used to provide an inference process based on the extracted region (e.g. using the image classifier or using a further image classifier). This process may comprise the determination of a region of interest in the image.

In some embodiments, the present disclosure includes generating a first set of training data and a second set of data (e.g. training data). The second set of data may be generated based on the first set of data (e.g. based on an output generated when the first set of data is provided to an AI model. In some embodiments, the second set of data is generated while the first set of data is being processed. For example, high quality images may be generated while lower quality images are being processed by an AI model. In such a situation, the processing of the higher quality images may be based on an output associated with the lower quality images.

For example, inference may be performed on the low quality images while the higher quality images are being generated. The AI model may then perform an inference process on the higher quality images based on the inference of the lower quality images (e.g. to identify regions of interest in the higher quality images).

In general, the method may comprise generating a second set of data while the first set of data is being processed (e.g. by an AI model). The first set of data and the second set of data may be provided as inputs for a first and a second AI model or machine learning model. The use of a hierarchical codec enables this efficient generation of data sets while avoiding redundant decoding.

### Region of interest determination

As mentioned above, aspects of the present disclosures consider the use of a codec that enables the independent decoding of separate regions of an image (e.g. that enable the decoding of only a portion of an image). Such a codec provides a number of potential benefits.

In some embodiments, the computer device is arranged to identify a region of interest of an image based on a version of the image that has a first level of quality. For example, the computer device may use object recognition algorithms on the base image. Based on this identification of a region of interest, the computer device may generate at least a portion of the image in a different quality, e.g. the computer device may generate a higher-resolution image that comprises only a portion of the image (e.g. the region of interest).

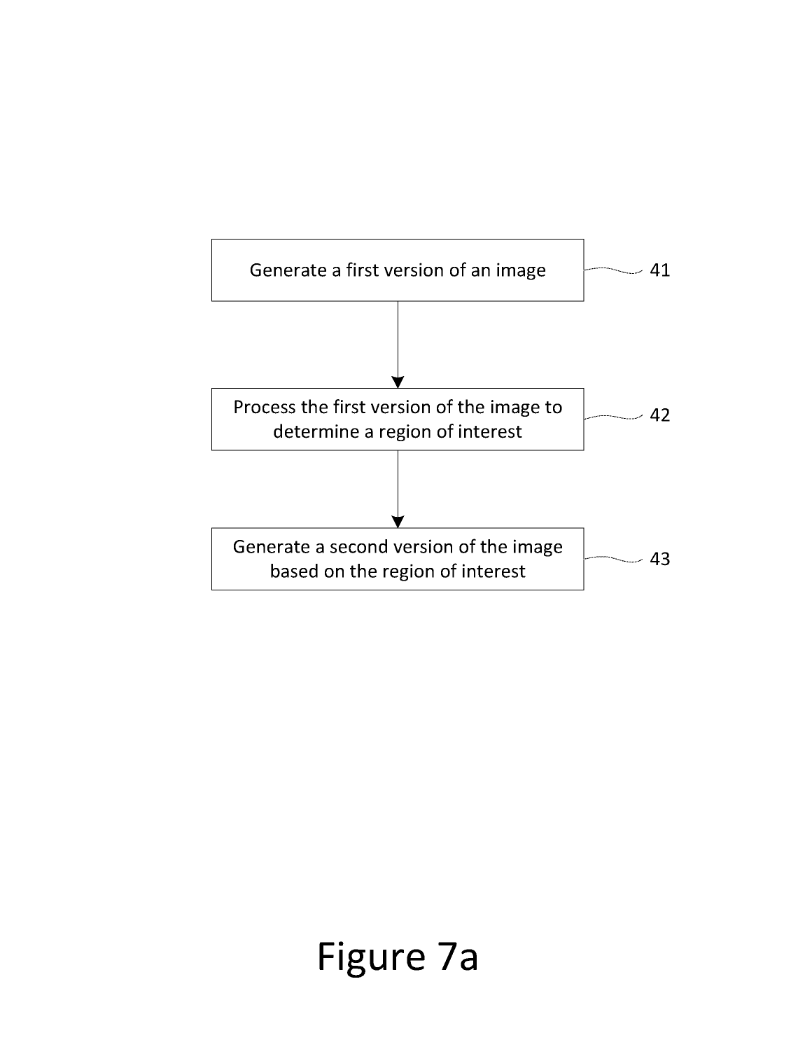

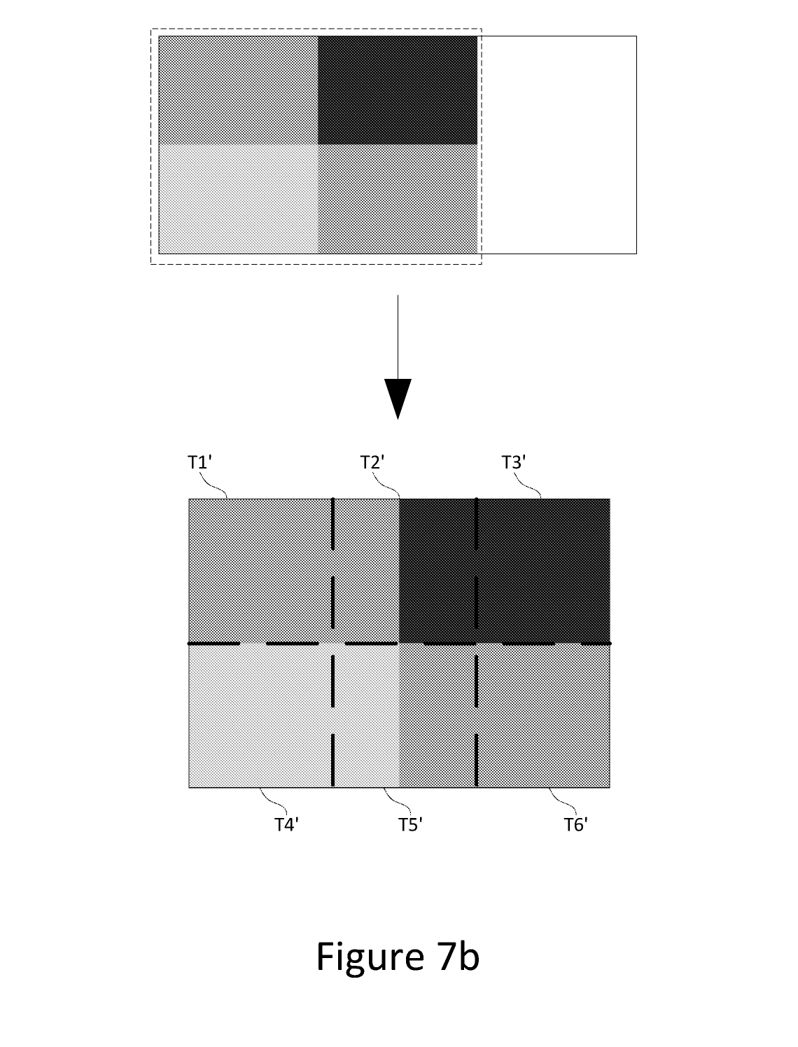

More generally, referring to FIG. 7a, the computer device may be arranged to: in a first step 41, generate a first version of an image at a first resolution; in a second step 42, process the first version of the image to determine a region of interest; and in a third step 43, generate a second version of the image at a second resolution based on the region of interest. Typically, the second version of the image comprises a subset of the image that includes the region of interest. The second resolution is typically higher than the first resolution.

In some embodiments, the determination of the region of interest comprises receiving the region of interest (e.g. from a further computer device). For example, the further computer device may be arranged to identify regions of interest in a plurality of images and to signal these regions of interest to the computer device so that the computer device can generate a plurality of versions of images based on these regions of interest (and then, e.g. form a training set of images based on the plurality of versions of images).

Such a method may be of particular benefit for generating a training set of images for a machine learning model. In this regard, a first pass determination of a region of potential interest may be identified in the second step 42 and then this region of interest can be used to generate images to populate the training set for the machine learning model. In some embodiments, this involves using an existing image classification model to determine the region of interest so as to generate a training set of images that can be used to improve (e.g. re-train and/or fine-tune) the existing model or to train a new model.

Such a method is also of benefit during an inference process, where a first inference process such as an object detection or recognition process may be performed using the first version of the image in order to determine the region of interest and then a further inference process (that may be the same as the first inference process or different to the first inference process) may be performed using the second version of the image (that includes the region of interest).

In practice, this may involve detecting an object or region of interest during the second step 32 and then generating (or otherwise obtaining) a higher quality (e.g. higher resolution) version of this object/region. The method may then involve classifying the image/object/region using the higher quality version. In a simple practical example, the first step may involve detecting a car in a low-quality version of the image, and the second step may involve classifying a type or motion of this car in a higher-quality version of a portion of the image. This method enables relatively quick or efficient inference processes to be performed on lower quality data (to avoid unnecessary processing of high quality data), with more detailed inference processes (that require higher quality inputs) then being performed on a relatively small area of higher quality data.

The method may involve a plurality of iterations, where each iteration involves determining a region of interest of an input and then generating a higher quality version of this region of interest as an output. Therefore, a first iteration may generate a first region of interest that is a subset of an input image and a second iteration may generate a second region of interest that is a subset of the first region of interest. The method may involve at least two or at least three iterations. At each iteration, the method may comprise analysing the output (e.g. to perform an inference process, and object recognition process, and/or an object classification process using the output).

Referring to the example shown in FIG. 3, the computer device may identify that the tiles T3 and T6 are blank tiles and so there is no benefit to including these tiles in the set of image data S1. Therefore, the computer device may generate the second version of the image to include only the pixels in the tiles T1, T2, T4, and T5 (e.g. the computer device may generate higher quality versions of the tiles T1, T2, T4, and T5 in a higher quality without obtaining higher quality versions of the tiles T3 and T6). This may involve receiving information, e.g. residuals, from a further computer device. In particular, the computer device may request residual data from this further computer device for only certain regions in an image (e.g. the regions of interest).

The determination of the region of interest typically occurs before upsampling, where this determination may affect the amount of upscaling that is performed and may affect the determination of the enhancement layer that occurs in the second step of FIG. 6. For example, where the computer device determines that the set of image data should only include the pixels in the tiles T1, T2, T4, and T5 (and not T3 or T6), the computer device may be arranged to upsample the base image B1 to a higher resolution so as to still provide a required number of tiles.

This is shown in FIG. 7b. As shown, a region of interest is identified that comprises the pixels in the tiles T1, T2, T4, and T5. The computer device upsamples the pixels in this region of interest and to form an upsampled portion and then divides this portion into a required number of tiles T1’, T2’, T3’, T4’, T5’, T6’ of the required size.

Therefore, instead of forming the set of image data S1 based on the tiles T1 … T6, the computer device may form the set of image data based on the tiles T1’ … T6’, where these tiles are the same size as the tiles T1 … T6, but with a higher quality.

Such methods enable high quality images to be provided efficiently to a machine learning model with given input requirements. The region of interest determination disclosed herein ensures that the computer device that is preparing the set of image data is able to prepare this image data quickly and efficiently (e.g. without unnecessarily upsampling irrelevant content in the images).

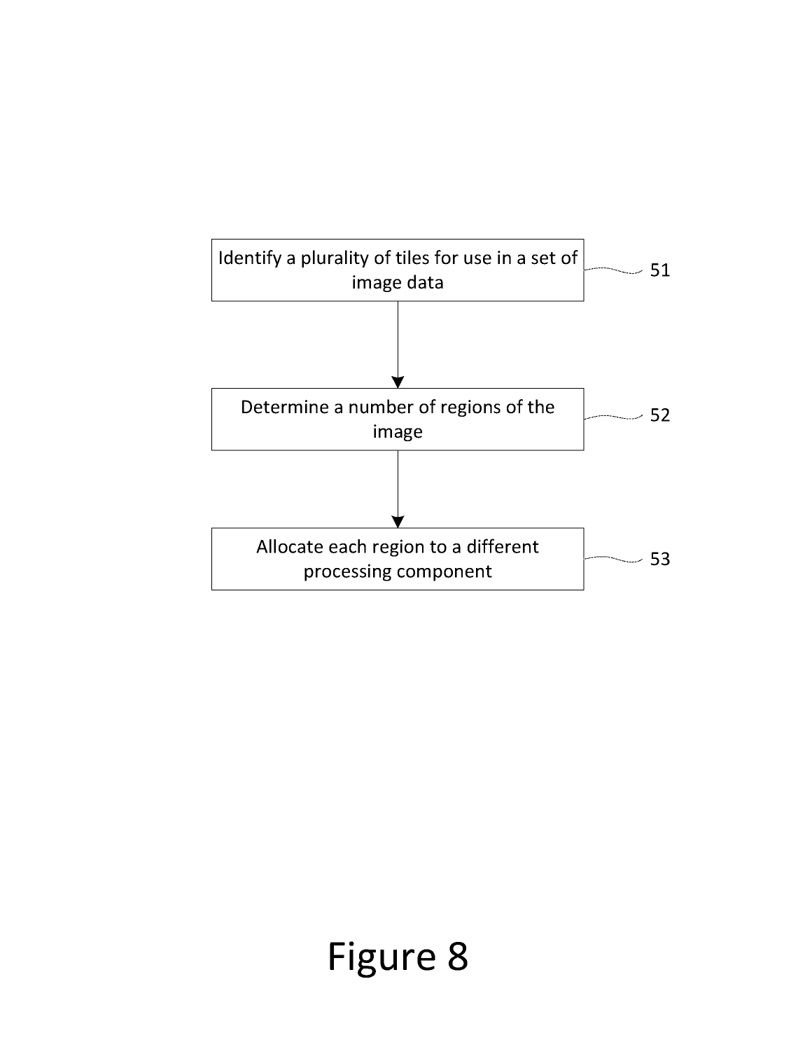

Furthermore, referring to FIG. 8, the present disclosure, and the use of the codec features described herein, provides a parallelisable method of decoding images.

In a first step 51, the computer device identifies a plurality of tiles for use in populating a set of image data S1.

In a second step 52, the computer device identifies a number of regions of the image, where each region is associated with a tile.

In a third step 53, the computer device allocates each region to a different processing component (e.g. a different GPU or a different core of a GPU) for decoding.

With this method, each region of an image, and each tile, can be decoded by a different processing component so as to provide a parallelisable method of generating the set of image data S1.

Furthermore, according to the present disclosure, the computer device (and the different processing components) may compose the set of image data S1 based on tiles of a first quality and/or resolution without generating an image at this level of quality.

Therefore, the set of image data S1 can be formed efficiently without generating and then (e.g. repeatedly) cropping an image as would be required with codecs where different regions of an image cannot be decoded independently.

The method may then comprise generating the set of image data by receiving tiles associated with different regions of a (single) image from different processing components, the tiles being generated simultaneously by these components based on a bitstream that defines the image.

In order to enable the parallel, and independent, decoding of the regions, the codec may be configured to use an upsampler that minimises a dependence on neighbouring pixels. For example, the codec may be configured to use a nearest neighbour upsampler instead of a bicubic upsampler.

The codec may be configured to use an upsampler that minimises an amount of decoding of a base image that is required to generate a higher quality version of a section (or tile) of this base image. The codec may be configured to use an upsampler that enables the independent decoding of sections (or tiles) within an image (or another type of data structure).

For example, a base version of an image at a first level of quality may be divided into 64 different ‘base’ tiles, where each base tile can be combined with respective enhancement data to obtain a version of this tile at a second, higher, level of quality. Similarly, each of these base tiles may be divided into 64 ‘sub’ tiles that can again be combined with respective enhancement data to generate a sub tile at a third, yet higher, level of quality. Therefore, instead of having to decode the whole of an image to obtain a specific sub-tile, the decoder is able to decode only a portion of the image (it will be appreciated that the use of 64 tiles is simply an example, that any number of tiles may be used, and that different tiers of the image may be split in different ways such as into different numbers of component tiles).

In a practical example, to generate a specific sub-tile at a third level of quality, a decoder is able to receive a base tile at a first level of quality and then to upscale this base tile and combine it with first enhancement data to obtain a version of the base tile at a second level of quality. The decoder can then identify a sub-tile of this base tile, upscale this sub-tile, and combine it with second enhancement data to obtain a version of the sub-tile at the third level of quality. Such a codec enables the generation of this sub-tile at the third level of quality without the need to decode any of the other base tiles or any of the other sub-tiles within the decoded base tile (and without the need to receive enhancement data associated with any of these other base tiles or any of these other sub-tiles.

Therefore, the use of the hierarchical codec enables more efficient decoding of a specific region of interest at a high level of quality and thus enables a more efficient method of forming a set of image data comprising this region of interest (where this set of image data can then be provided to an AI model).

Typically, the codec is arranged to enable the grouping of enhancement data (e.g. residual data) into groups associated with tiles of an image. This enables these tiles to be independently decoded. For example, the first and second enhancement data mentioned in the preceding paragraphs may be grouped within a bitstream. In some embodiments, the first enhancement data for a specific base tile of the image may be followed by enhancement data for each of the sub-tiles contained in that base tile so that a decoder can pick out the first enhancement data from the bitstream and then pick out the second enhancement data from a following section.

The codec typically uses a structure (e.g. an s-tree structure) in which an image is divided into a plurality of blocks. In order to decode a region, a computer device needs to decode each block that is covered (at least partially) by the region. Certain methods of upsampling, such as bicubic upsampling, lead to a pixel value being determined based on the values of a plurality of surrounding pixels. This increases the chance of one of the pixels required to decode a block being located in an adjacent block. This can lead to the decoder needing to decode an entire block that is not within a region being decoded simply to determine an upsampled value for a single pixel in this desired region. By using certain (other) upsampling modes, such as the aforementioned nearest neighbour upsampling mode, the likelihood of such inefficient decoding can be reduced.

Typically, the regions are separate regions (so that the tiles in the set of image data each represent a different region of the input image). In some embodiments, the regions may comprise overlapping regions so that certain portions of the input image are present in a plurality of tiles in the set of image data. This may lead to increased accuracy for certain machine learning models.

In some embodiments, different regions of the input image are upsampled to different levels of quality. For example, the edges of the image may be upsampled to a first level of quality with the centre of the image being upsampled to a second level of quality and the set of image data may then be composed of image tiles of a plurality of different qualities (e.g. where the second quality is higher than the first quality).

Typically, each tile in the set of image data is constrained to be the same size so that the ‘quality’ may refer to an enhancement layer associated with the tiles (so that the centre tiles may be taken from a different enhancement layer to the edge tiles). Therefore, the centre tiles each refer to a smaller portion of the base image than the edge tiles (e.g. the centre tiles show a small area of a scene in high detail whereas the edge tiles show a larger area of the scene in a lower amount of detail).

In some embodiments, the computer device is arranged to determine an enhancement layer for determining a tile for a region of the image based on a feature of that region. For example, if a region is determined to contain an object, or a specific type of object, then the computer device may select an enhancement layer with a high level of quality for determining tiles within this region.

The disclosed methods thus provide an efficient method of generating a set of image data (e.g. a set of tiles) that can be provided to a machine learning model, where the tiles within the set of image data are each at an appropriate level of quality. This may comprise providing tiles with different levels of quality (e.g. so that tiles that show specific types of objects have a higher quality than tiles showing a background). In practice, this typically involves providing tiles of a consistent size, where the tiles may represent areas of different size in an input image. For example, a background tile may show 40% of an original image in a first (low) level of quality and an object tile may show 20% of an original image in a second (higher) level of quality.

### End markers

In some embodiments, the codec is arranged to provide end markers that match locations of regions in the image to locations of bits in the bitstream. For example, a header in the bitstream may indicate that a kth bit of the bitstream defines an attribute value for a certain pixel in an image defined in the bitstream.

The computer device may determine a location of a tile based on such an end marker (e.g. based on an end marker defined in a header of the bitstream). In an example, the header may comprise six end markers, which end markers identify first (e.g. top left) pixels of the tiles T1 … T6. Therefore, the computer device is able to readily identify the locations of the tiles so as to efficiently allocate regions of the image to different devices so as to determine the tiles.

The end markers may identify one or more of: the locations of pixels in the base image; and the locations of residuals associated with these pixels (and/or corresponding upsampled pixels) in the bitstream. The end markers may identify the locations of one or more sets of residuals associated with different levels of quality.

More generally, the method may comprise identifying a datastore that indicates locations of bits in the bitstream, where these bits relate to the locations of specific regions in an image and/or the locations of residuals associated with specific regions in the image.

Since the set of image data S1 is typically arranged to comprise tiles of a predetermined (and fixed size), it is possible to identify the locations of the tiles in the image prior to encoding the image. Therefore, the method may comprise identifying the end markers at the time of encoding an image. It will be appreciated that identifying these locations of the tiles prior to encoding the image is not necessary and that many embodiments of the present disclosure do not require any such pre-identification to take place.

As with the other features disclosed herein, the use of the end markers enables efficient generation of a set of image data that can be provided as an input to a ML/AI model. In particular, the use of end markers enables efficient, e.g. parallel, decoding of a plurality of regions of an image so that an image can be readily converted into a plurality of tiles that can be provided to a ML/AI model.

In some embodiments, one or more end markers are used to identify regions that comprise one or more objects of interest. For example, an end marker may be used to identify a bit associated with a top-left pixel of a region that shows an object of interest. The end markers may then be combined with the aforementioned region of interest features, where the end marker may identify a region of interest.

In some embodiments, the computer device may be arranged to identify a data structure that comprises both end markers and quality indicators, where the end markers identify regions of an image and the quality indicators identify a quality with which these regions should be decoded. Therefore, the image may be decoded using a plurality of computer resources (e.g. using different processors in parallel) to provide tiles of a required size, where these tiles may have different levels of quality.

### Encoding

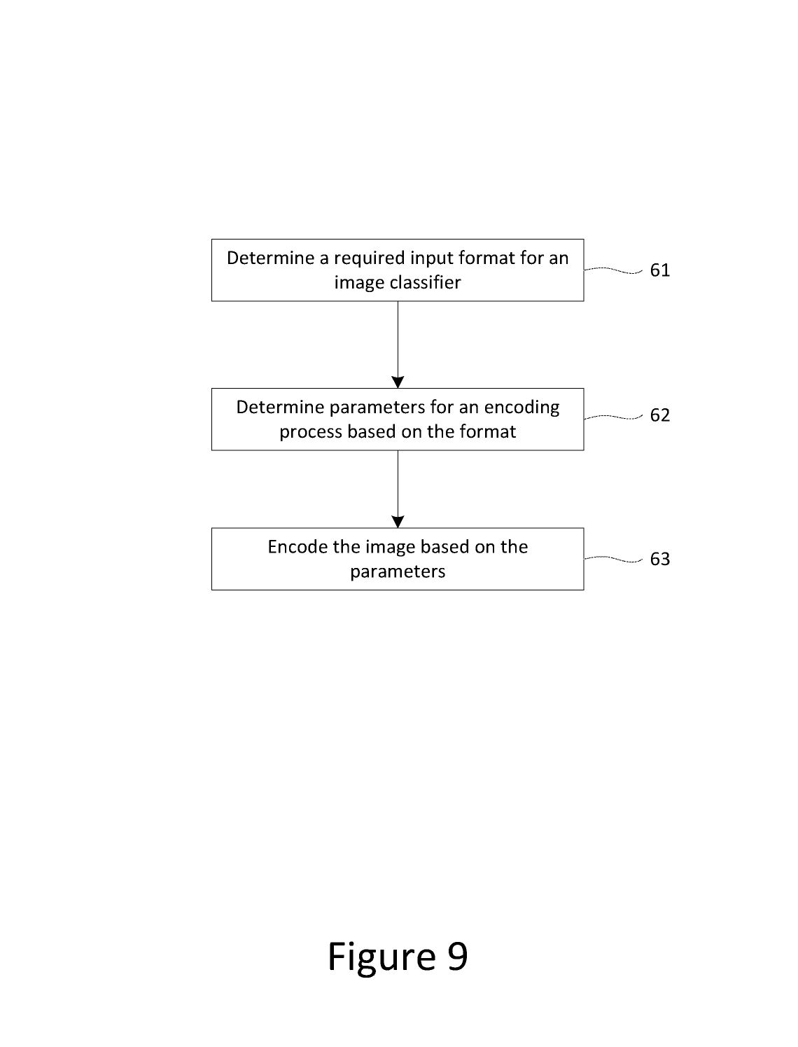

Referring to FIG. 9, there is described a method of encoding an image (and a method of configuring a codec so as to encode an image). This method may be used to encode an image so that it can be readily decoded and then provided as an input to an image classification model (either for training purposes or for classification purposes).

In a first step 61, the computer device determines a required input format for an image classifier. The format may comprise a required size and/or resolution for image data in a set of image data. The format may comprise an arrangement of image tiles in a set of image data.

In a second step 62, the computer device determines a parameter for an encoding process based on the required input format. For example, in dependence on the required input format, the computer device may determine one or more of: a quality (e.g. a resolution) of an enhancement layer; a number of enhancement layers; an upsampling technique used to upsample a first layer to a different layer; a structure for encoding different regions of the image; locations of boundaries between regions in the image; and/or end markers that indicate the location of features in the image.

In a third step 63, the computer device encodes the image based on the determined parameters.

This method enables an image to be efficiently encoded so as to be suitable for later use by a given image classifier.

In some embodiments, the first step 61 comprises determining input formats for a plurality of different image classifiers. The computer device may then determine parameters for the encoding process based on this plurality of image formats. For example, the computer device may determine a plurality of upsampling ratios and/or the computer device may determine qualities for a plurality of enhancement layers so that a bitstream that defines the image can be parsed to efficiently extract sets of image data at a plurality of resolutions, where the different resolutions are suitable for different image classifiers.

The first step 61 of determining the required input format may comprise receiving the input format from a further computer device. In this regard, a set of image or video files may be held on a server and a further computer device may then request (e.g. a subset of) these files in order to train a machine learning model and/or in order to classify these files.

The further computer device may then provide a format so that the server is able to encode image/video files in dependence on this format and to transmit the encoded files to the further computer device. The further computer device can then efficiently decode and process the files.

In this regard, as mentioned above, the required format may indicate one or more of: a required size of input tiles for a set of image data; a required arrangement of input tiles for a set of image data; a required sampling ratio for an enhancement layer; a required number of and/or ratio between enhancement layers.

In some embodiments, the server is arranged to receive an indication of an object of interest. The server (or more generally an encoder) may then encode files based on this indication of an object of interest. For example, the server may crop an image based on the object of interest and/or the server may determine a level of upsampling for an enhancement layer and/or a quality for an enhancement layer based on the object of interest.

The above disclosure has primarily related to methods of using images encoded in a hierarchical data format, such as a VC-6 format, to train machine learning models. In some embodiments, the method includes identifying an image in a non-hierarchical data format, such as a JPEG format, and training the machine learning model based on this image.

In some embodiments, the methods comprise transcoding an image in a non-hierarchical data format to a hierarchical format. For example, a computer device may identify that an image is a JPEG image and transcode (e.g. decode, and then reencode) this image to obtain a version of the image in a VC-6 format. The methods of training a machine learning model may comprise identifying a plurality of images, transcoding any non-hierarchical images in this plurality of images into hierarchical formats, and then training the machine learning model using the hierarchically encoded images. In a first training epoch, the computer device may use images in a plurality of formats, e.g. including non-hierarchically encoded images, while also transcoding any non-hierarchically encoded images into hierarchical formats. Then, in later epochs, the computer device can use solely hierarchically encoded images.

As described above, such hierarchically encoded images may enable the decoding of an image to a required resolution or level of quality as well as the partial decoding of only a portion of the selected image.

As described above, the images may be converted into a shape, size, and/or format required by a machine learning model before being provided to that model. This may comprise padding an image (e.g. using pixels with a value equal to an average pixel value of the image). This may comprise padding the image to obtain square images, e.g. to ensure consistency of image shapes.

In some embodiments, a square expansion process, e.g. a padding process, is applied to an image at full resolution.

The images, e.g. the square-padded images, may then be rescaled, converted to tensors, and/or normalized, before being used to train a machine learning model and/or before being used with a machine learning model for inference.

### Example architecture

Referring to FIG. 10, there is shown a detailed example of an architecture for implementing certain methods disclosed herein. On the left-hand side of the image, a method of data preprocessing is shown. On the right-hand side, an exemplary arrangement of a machine learning model is shown.

Given a high-resolution input image, a computer device encodes this image to form a multi-resolution image (that comprises a base layer and one or more enhancement layers). The example of FIG. 10 considers the use of VC-6 encoding, but it will be appreciated that other codecs may be used instead.

Referring to operation 1-a of FIG. 10, in some embodiments the high-resolution image is downscaled, tiles can be extracted from this downscaled image, and a thumbnail is extracted (e.g. by downsampling the whole of the image). These tiles can then be used to form a set of image data.

Conversely, referring to operation 1-c of FIG. 10, the tiles may be extracted from the multi-resolution image and the thumbnail may further be extracted from this image. For example, the thumbnail may be formed from a base image and the tiles may be formed using one or more enhancement layers that increase a resolution of this base image.

The thumbnail and the tiles can then be combined to form the set of image data and provided to an image encoder. This image encoder provides an input to a machine learning model that may, as shown in FIG. 10, use a multi-layer perceptron to form tokenised image data. This tokenised image data may be used as the input for a large language model (LLM).

This method may be used both during the training of the LLM and the use of the LLM.

As mentioned above, this is merely an exemplary architecture and the disclosures herein may be used to generate input sets of image data for numerous different types of image classifiers.

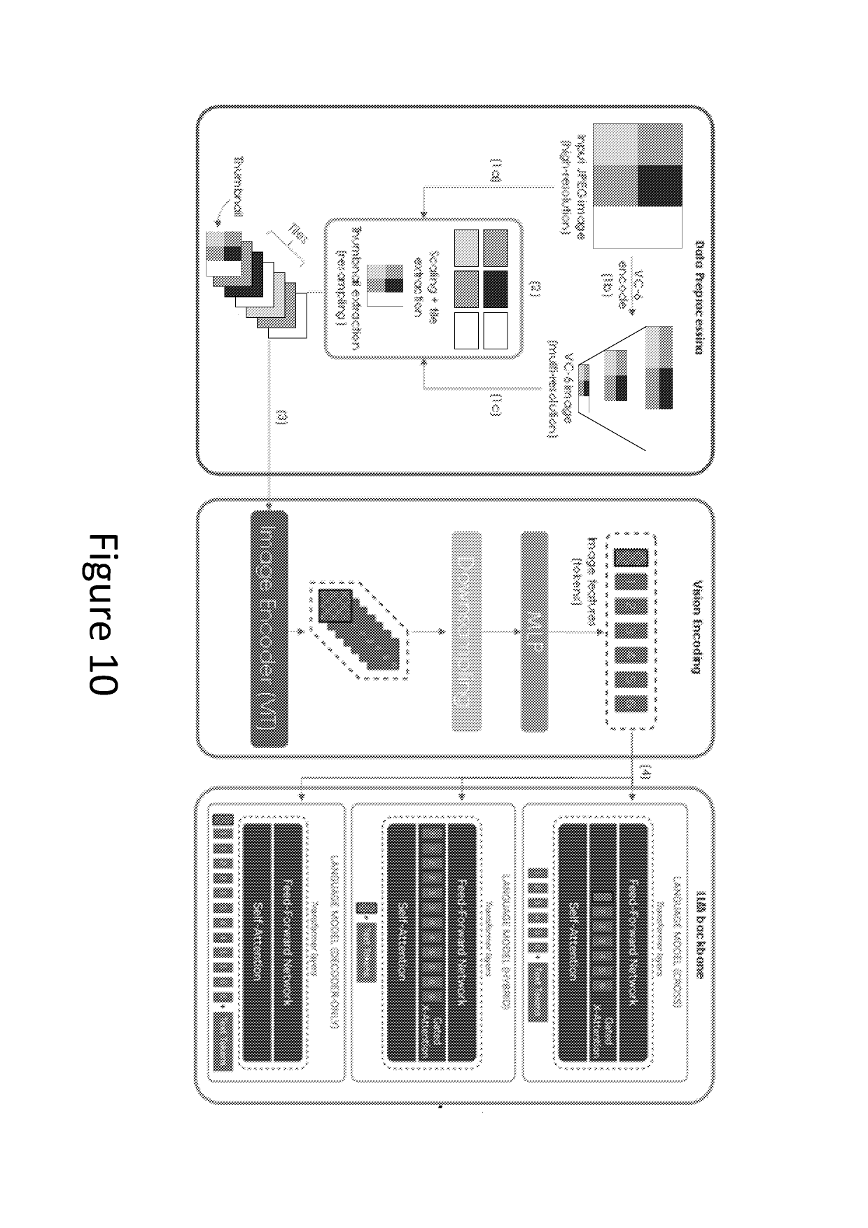

Referring to FIG. 11, there is shown a method of processing data (where this method increases the efficiency of image processing for AI training by leveraging both hierarchical and non-hierarchical image formats). This method may be used for training Large Multimodal Models (LMMs) using different image processing pipelines. The method consists of multiple stages, each designed to optimize data handling efficiency.

Below is a detailed description of each step of the method of FIG. 11 (which is typically carried out by a computer device):

A first, ‘data loading’, step 71 comprises loading images in a hierarchical format so that they may be used for the training of a machine learning model that receives hierarchical images as an input.

If images provided to the pipeline are not pre-encoded in a hierarchical format, such as VC-6, a one-time transcoding process may be used to convert these images in another format to a hierarchical format (e.g. to convert JPEG images to VC-6 images). This encoding enables a lossless format for archival storage and supports efficient downstream processing. More generally, it will be appreciated that VC-6, and other hierarchical formats, can offer either lossless or lossy encoding, and that either type of encoding may be used as part of the arrangements disclosed herein.

Furthermore, the present disclosure envisages an encoder that is arranged to implement an encoding parameter that is a compression ratio and/or an amount of loss (and this parameter may be determined based on a required format of an AI model).

The aforementioned transcoding may comprise JPEG Decoding in which, in workflows utilizing JPEG, images are decoded using for example a GPU-accelerated nvImageCodec, allowing high-speed data extraction. It will be appreciated that JPEG decoding is simply an exemplary embodiment and various image types, e.g. PNG, PDF etc. or more generally file types, e.g. video, audio, etc. may be provided. Furthermore, it will be appreciated that various components may be used to perform the described transcoding and the other operations described herein (e.g. CPUs, GPUs, etc.)

The aforementioned transcoding may comprise VC-6 Encoding, where JPEG (or other) images are (e.g. losslessly) transcoded to VC-6. This process may be used in a first training epoch in order to reduce overhead for subsequent epochs.

In a second, ‘decoding’, step 72, the computer device finds (or determined) an optimal level of quality (LOQ) and performs image decoding based on this LOQ. As has been described above, the optimal Level-of-Quality (LOQ) is determined dynamically, e.g. based on computational constraints and training requirements. For example, a machine learning model may be initially trained on a first set of images at a first, e.g. low, level of quality and then subsequently retrained based on a second set of images at a second, e.g. higher, level of quality.

The decoding typically comprises image decoding of a hierarchical (e.g. VC-6) image format. Instead of decoding a full-resolution image, only the necessary resolution level is extracted from the hierarchical (e.g. VC-6) format reducing computational requirements as compared to implementations where a high resolution level is used unnecessary.

In a third, ‘shaping’, step 73, e.g. a ‘Expand to Square’ step, the computer pads the image to obtain a square aspect ratio, preventing AI training artifacts. More generally, the computer device may pad or crop the image to obtain one or more images of a desired size (e.g. a size of image required by the machine learning model and/or a size that can be cropped to obtain a size of image required by the machine learning model).

The expand-to-square operation may comprise a pixel padding operation that expands a smallest dimension of an image to obtain a square resolution, e.g. to expand a 510x339 image to a 510x510 image. In some embodiments, the pixels in the expanded regions contain the average pixel value of the image. In other embodiments, different values may be used for these pixels (e.g. an average value of k nearest neighbours of the pixel, a user defined value, a default value, a value designated by a training protocol associated with the AI model, etc.

The use of such a padding technique can prevent hallucinations that may otherwise occur during inference.

Where a non-hierarchical format is used, the computer device may also perform a resizing, e.g. ‘Expand to Square’ step. In particular, when using JPEG (or other non-hierarchical formats), the entire image in this format may be expanded. This typically requires higher memory and processing power compared to hierarchical formats. In some embodiments, the computer device is arranged to convert each input image to a hierarchical format before providing these images to the machine learning model to train the machine learning model. In some embodiments, the computer device is arranged to perform the training using images with each of hierarchical and non-hierarchical formats, where this may involve resizing each image in a similar way prior to a fourth, preprocessing, step 74 described below.

In the fourth, ‘preprocessing’, step 74, e.g, a ‘CLIP Processing’ step, the processed images are resized, converted into tensors, and normalized before embedding extraction. More generally, the fourth step comprises generating tensors and/or embeddings of the images that can be fed into a machine learning model.

This fourth step 74 may comprise rescaling an image to a required resolution for image embedding (e.g. a 336x336 resolution). This step may be followed by a conversion to a numerical embedding and then a normalization step.

In a fifth, ‘training’, step 75, e.g. a ‘LMM Training’ step, the final data (e.g. the tensors) is passed to a machine learning model, such as an LMM, for training, re-training, or fine-tuning the LMM (or more generally, for training, re-training, or fine-tuning an AI model or ML model that is being trained).

Advantages of using a hierarchical image format for this training process include:

Hierarchical Multi-Resolution Structure - Supports selective decoding, allowing models to retrieve only the required resolution level, reducing unnecessary computations.

Real-Time Encoding and Decoding - Enables efficient transcoding from JPEG while maintaining (e.g. lossless) compression, ensuring rapid access to high-resolution images. Lossy compression may also be provided

Improved GPU and CPU Workflows - Achieves substantial reductions in preprocessing latency by leveraging GPU-accelerated processing and efficient memory bandwidth management. Similarly, CPU processing methods (or other hardware processing methods) may be used to efficiently make use of available resources.

Reduced Computational Overhead - Enables selective decoding of images at various levels-of-quality (LOQ), reducing the amount of data processed during training.

Preprocessing (e.g. Efficient Square Conversion and Embedding) - Optimizes preprocessing operations such as resizing, square padding, and embedding extraction, significantly improving overall efficiency

The described embodiments are applicable to machine learning/AI model training pipelines where large-scale multimodal datasets should be processed efficiently. They are particularly relevant for applications in machine learning, autonomous systems, and large-scale AI model development where computational efficiency is a critical concern.

It will be appreciated that this method (and the following methods) may be used to process tiles that form only a portion of an image (e.g. in order to train a machine learning model based on these tiles). Equally, these methods may be used to process whole images. Similarly, the methods described above with reference to tiles may equally be used to process whole images (where the methods herein may be used to train a machine learning model using either tiles that form portions of an image or using whole images).

Optimizing LMM training requires a multi-faceted approach that includes hardware accelerations such as GPUs and tensor processing units (TPUs), model optimizations like pruning, quantization, and Mixture-of-Experts (MoE) architectures, as well as preprocessing techniques such as feature distillation and dataset compression.

Data formats play a crucial and complementary role in enhancing efficiency, as they can minimize unnecessary computations and improve data access patterns.

This disclosure explores the use of hierarchical coding formats in optimizing LMM training, using VC-6 as a case study while generalizing its principles to broader AI applications. The disclosure work addresses gaps such as the lack of systematic evaluation of hierarchical coding formats for LMM training and inefficiencies in preprocessing pipelines that lead to unnecessary computational overhead and memory bandwidth bottlenecks.

Key contributions of this disclosure include:

An evaluation framework: we introduce a comprehensive evaluation framework for assessing hierarchical coding formats in LMM training workflows; using the disclosed VC-6 framework can enable an 80% reduction in preprocessing time on GPU and 58% on CPU compared to traditional JPEG pipelines.

Selective Resolution Techniques: we disclose novel techniques for leveraging selective resolution access in training workflows that can achieve a 64% reduction in GPU decoding time while maintaining model training effectiveness.

Hierarchical formats provide many benefits in reducing computational overhead and improving scalability, offering a promising direction for efficient multimodal training as models continue to grow in complexity.

Hierarchical coding formats provide a structured approach, which enables progressive data retrieval and selective access to different levels of detail. These formats facilitate efficient data processing in AI inference, image analysis, and video-based tasks by optimizing memory and computational efficiency. In parallel, Vision Transformers (ViTs) provide a powerful architecture for handling large-scale visual data. Unlike convolutional neural networks (CNNs), which process local receptive fields, ViTs utilize self-attention mechanisms to capture long-range dependencies, making them well-suited for high-resolution image analysis. Techniques such as CLIP (https://openai.com/index/clip/), BLIP (Li et al. “BLIP: Bootstrapping Language-Image Pre-training for Unified Vision-Language Understanding and Generation”), and SigLIP (Zhai et al. ‘Sigmoid Loss for Language Image Pre-Training’) further demonstrate the effectiveness of transformer-based architectures in learning cross-modal representations. These models may be trained and fine-tuned (and/or re-trained) with multiple resolutions, highlighting the need for efficient data representations like hierarchical coding formats to support large-scale training workflows. The present disclosure provides methods and systems for training such networks, e.g. for training networks that can be trained and/or fine-tuned using a plurality of different image resolutions.

In some embodiments, native versions of a hierarchical data format may be used, e.g. a CUDA-native version may be used within an NVIDIA CUDA platform. This could further accelerate pre-processing and image embedding steps.

The methods and systems disclosed herein may be used in various contexts, for example in federated learning or cloud-edge hybrid AI models, where efficient data transmission and reduced preprocessing overhead are critical.

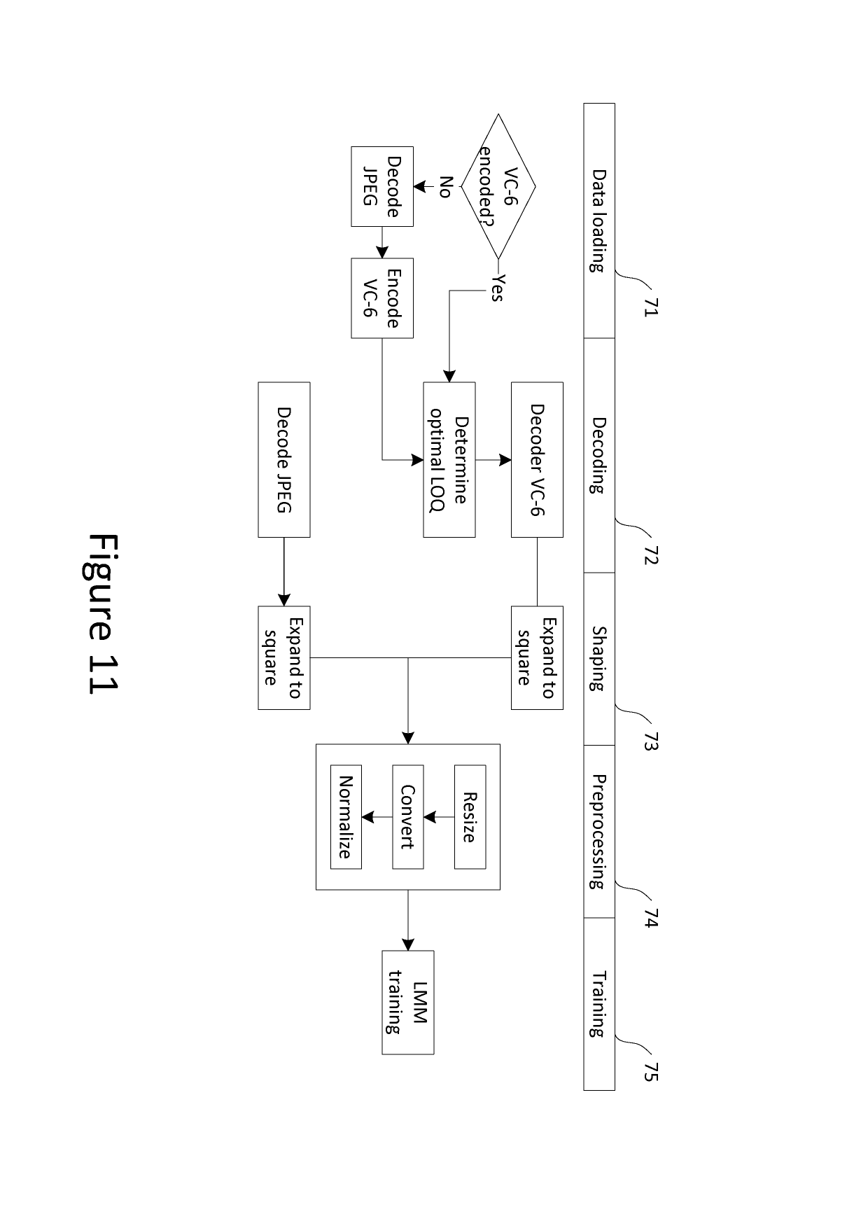

Referring to FIG. 12, there is described a further embodiment of a training pipeline and method for training a machine learning model. This method is typically performed by a computer device and typically uses hierarchically encoded images.

In a first step 81, the computer device receives an encoded image and in a second step 82 the computer device preprocesses the image, e.g. to decode the image, to convert the image to tensors, and to normalise the tensors.

For example, the encoded image may be received in a resolution of 1920x1080, the computer device may then decode this image into an RGB image with a size of (3, 1920, 1080) (e.g. with three layers each of 1920x1080). This RGB image may be converted into tensors of size (3, 256, 256) before normalisation.

Preprocessing the image may comprise converting the image to a required format, such as a square format, where this may involve adding pixels to the top/bottom or sides of the pixel to match the largest of the height or the width of the image.

The conversion of the image into tensors may comprise feeding the image into a transformer such as a vision image transformer (ViT). In some embodiments, this comprises using a convoluted visual transformer (e.g. a CLIP transformer). The image conversion of the image to the required shape and/or size may comprise converting the image to a shape and/or size required by the transformer.

In a third step 83, the computer device extracts one or more patches, e.g. the computer device may comprise n patches to obtain a tensor of size (n, 3, 16, 16) and in a fourth step 84 the computer device flattens the patch into one-dimensional arrays (e.g. n arrays of size 768).

In a fifth step 85, the computer device tokenises the arrays, in a sixth step 86 the computer device positionally encodes the tokenised arrays (e.g. using positional information such as sine and cosine functions) and in a seventh step 87 the computer device feeds the positionally encoded tokenised arrays into a machine learning model such as a vision encoder. Finally, in a ninth step 89, the computer device outputs a feature representation determined using the machine learning model. For example, the computer device may output an encoded feature map of a size (n, D), where D is a feature size.

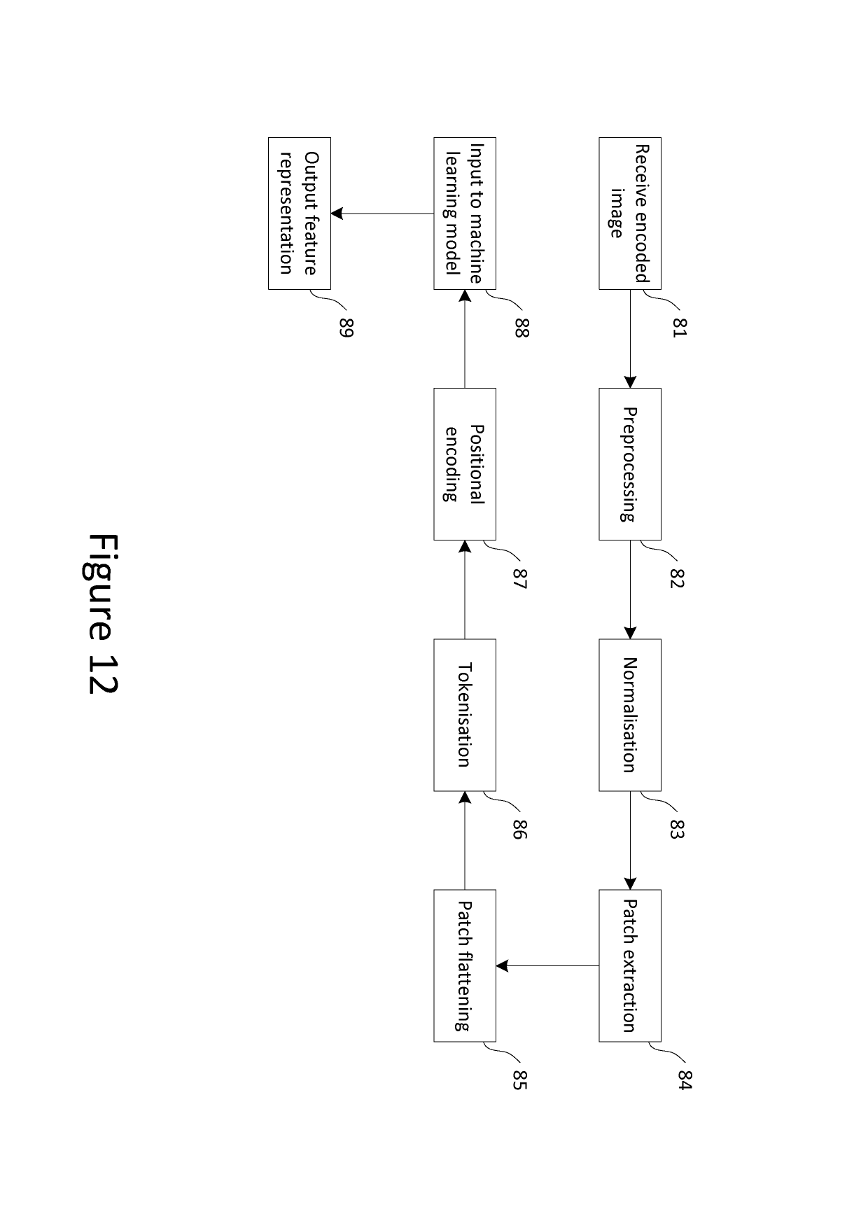

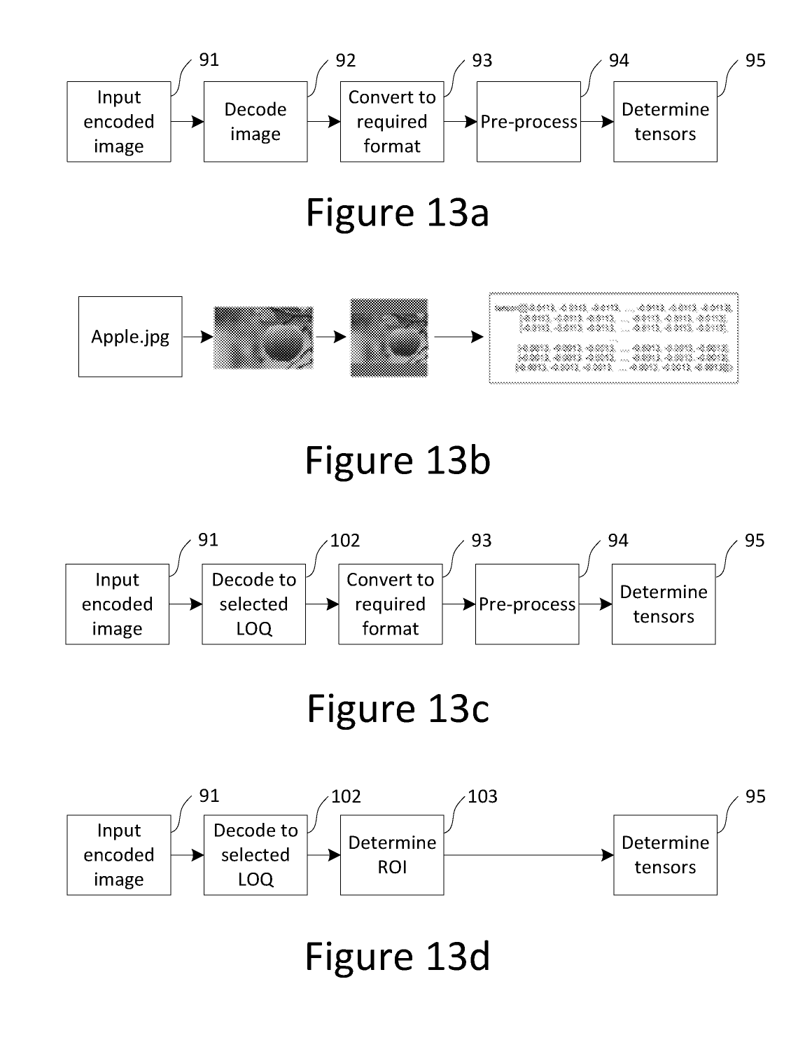

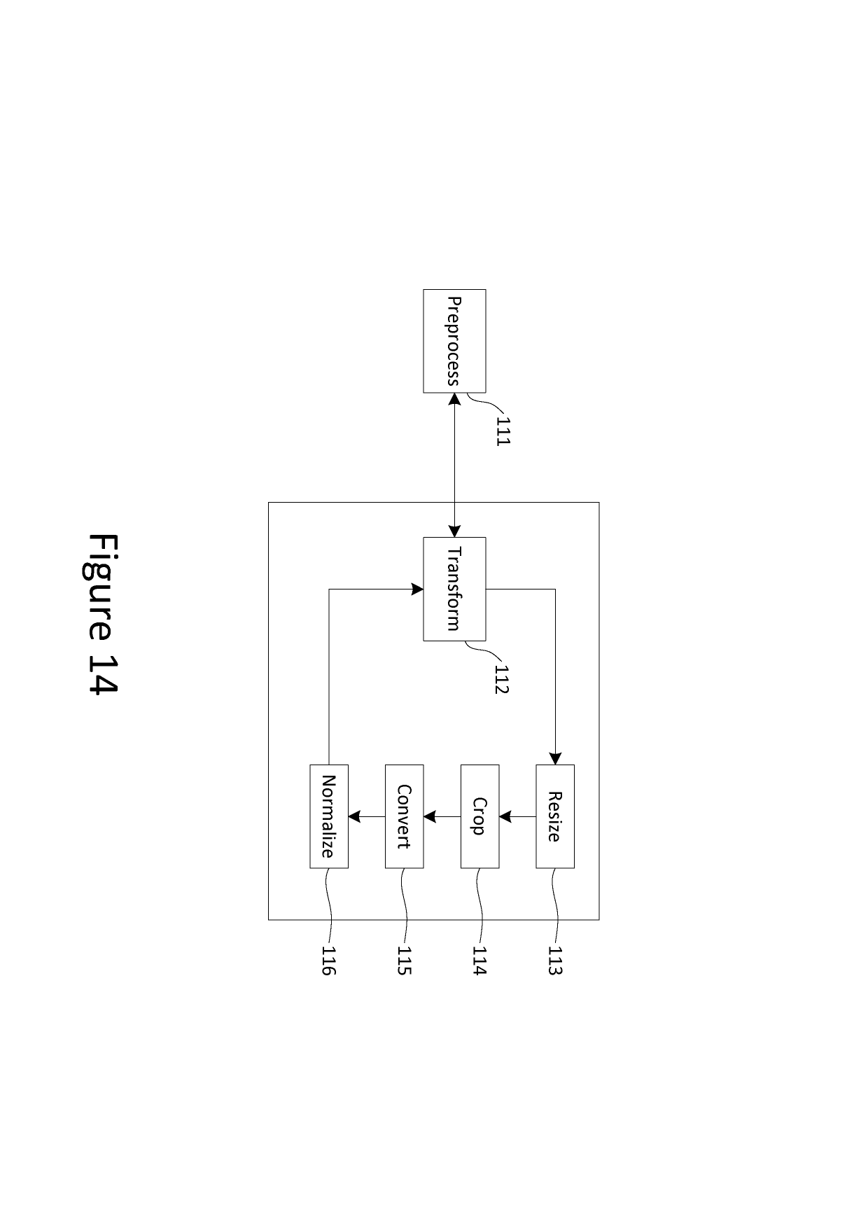

Referring to FIGS. 13a - 13d, there are described various embodiments for obtaining tensors that may be used within the training of a machine learning model.

Referring to FIG. 13a, the method may involve: in a first step 91, obtaining an encoded image; in a second step 92, decoding the image; in a third step 93, converting the decoded image to a required format (e.g. a required shape or size); in a fourth step 94, preprocessing the converted image (e.g. as described above); and in a fifth step 95 determining tensors from the pre-processed image, e.g. as has been described above.

The required format may, for example, be a square format and the method may comprise padding the decoded image in order to obtain the square format.

An example of the implementation of this process is shown in FIG. 13b, which shows a method in which tensors are determined based on an image of an apple.

Referring to FIG. 13c, the decoding of the image may comprise a second step 102 of decoding the image to a selected level of quality and/or a minimum level of quality that exceeds a threshold level of quality and/or resolution, as has been described above. In particular, the method may comprise determining the selected level of quality for the decoding process based on one or more of: available (e.g. hardware) resources, a required input of the machine learning model, and a user input, and then decoding the image to this level of quality.

By decoding the image to this selected level of quality (instead of always decoding an image to a maximum level of quality) a quicker, more efficient, and less data intensive method of training can be provided.

In some embodiments, the selected level of quality is determined to be the level of quality that provides a resolution that is closest to an expected model pixel value. For example, the selected level of quality may be determined to be the level of quality that provides an image with a resolution that is closest to a resolution required by the machine learning model and/or the vision transformer. As described above, this may comprise determining the selected level of quality to be the lowest level of quality that provides a resolution that is higher than a resolution required by the machine learning model and/or the vision transformer (so that the image can then be downscaled to meet this required resolution).

Referring to FIG. 13d, the converting of the image to the required format may comprise a third step 103 of determining a region of interest (ROI) within the image and converting (or decoding) the image based on this region of interest. For example, as has been described above, the method may comprise decoding the image so as to only decode a part of the image that contains this region of interest. The method may comprise decoding a part of the image and then either padding or cropping this part of the image to obtain an image of the required format. The determination of the selected LOQ may be dependent on this region of interest (so that the second step 102 and the third step 103) may be performed in any order, where the LOQ may be selected so as to enable the selection of an ROI at an appropriate resolution.

As is also shown in FIG. 13d, the fourth step 94 of pre-processing the image may be optional, where the computer device may be arranged to obtain tensors without pre-processing (e.g. scaling and normalizing) the image. Such a method is particularly, but not exclusively, applicable to situations that involve the determination of an ROI since in these situations the ROI can be selected to be a suitable size for providing to a machine learning model so that any scaling of the ROI is unnecessary.

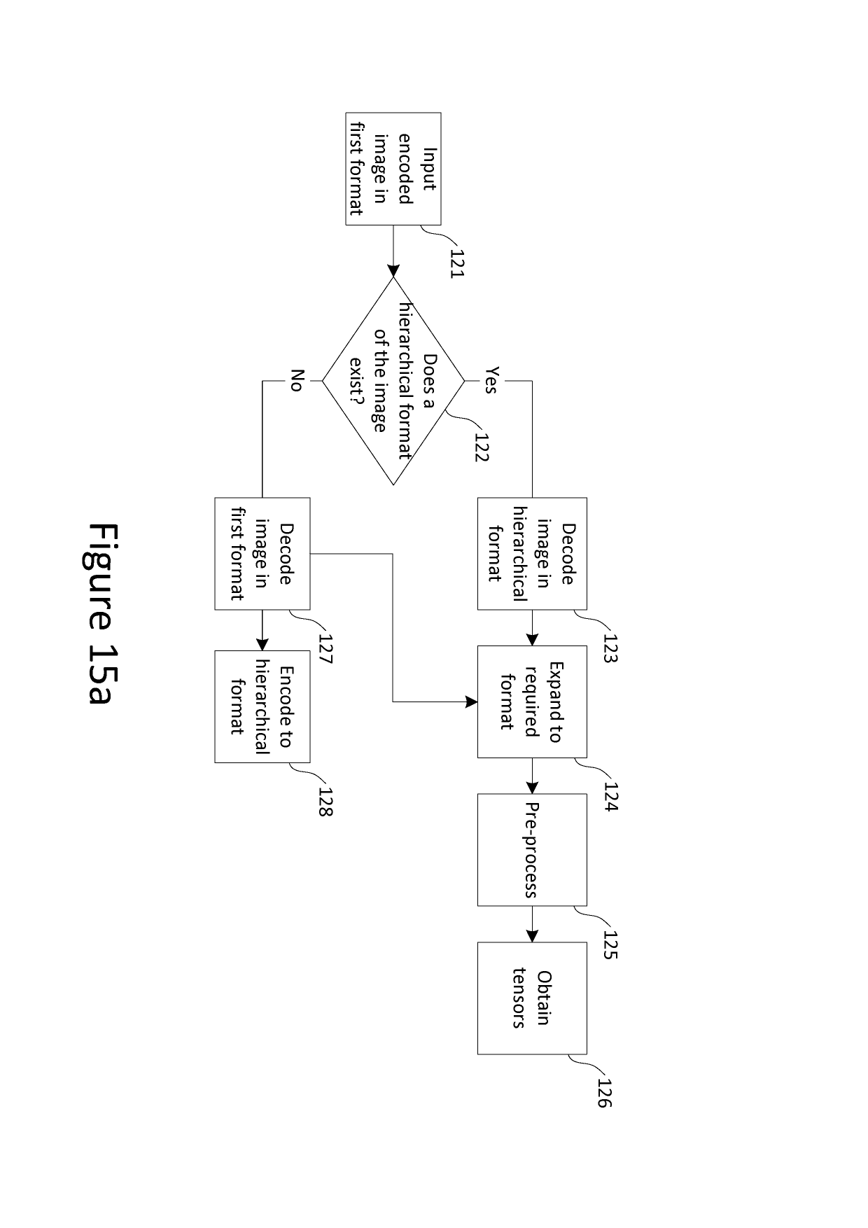

Referring to FIG. 14, there is shown an exemplary process for preprocessing an image, as has been described above. This process may, for example, be carried out by a CLIP transformer.

In a first step 111, the image is transformed. In a second step 112, the transformed image is resized to a pixel size of a model, e.g. using bicubic interpolation. In a third step 113, a central portion of the image is cropped; for example, the portion may be cropped based on a required size of an output and an aspect ration of the input image. In a fourth step 114, the image is converted to a tensor representation (e.g. a PIL image may be converted to PyTorch tensors). In a fifth step 115, the tensors are normalized, e.g. to have a mean of 0 and a standard deviation of 1. This normalization can improve training performance by reducing a range of pixel values provided to a machine learning model during training. The second to fifth steps may then be repeated.

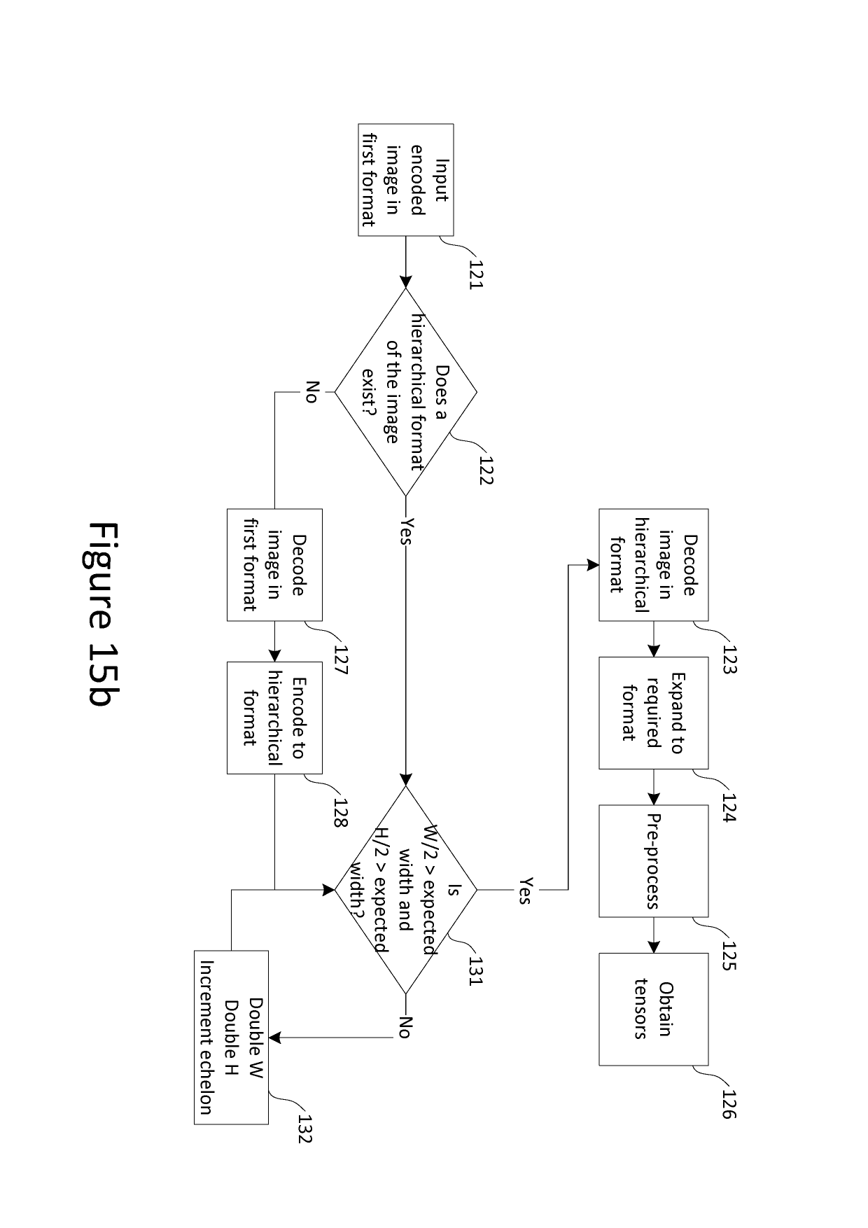

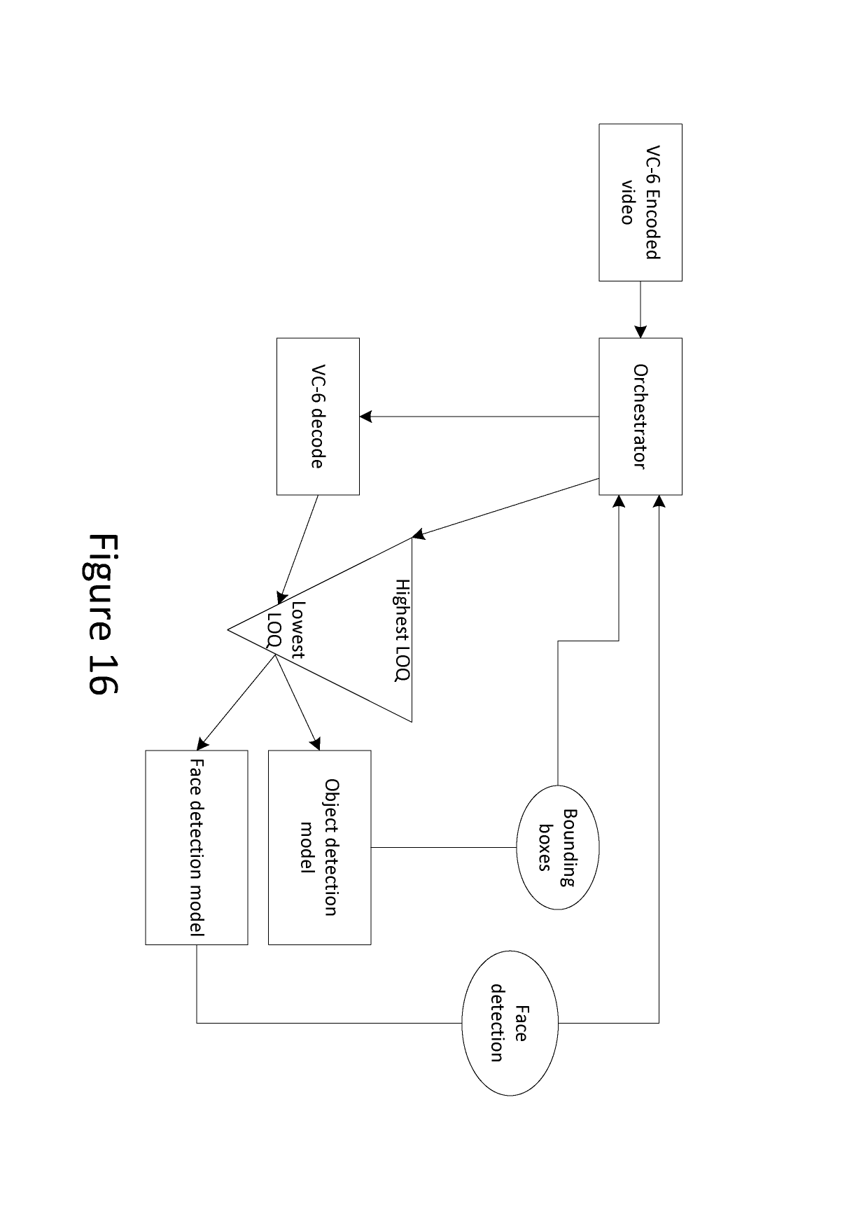

Referring to FIG. 15a, there is shown a further method of generating tensors (e.g. as described in the methods above). This method is typically performed by a computer device.

In a first step 121, the computer device receives an encoded image in a non-hierarchical format, e.g. in a JPEG format.

In a second step 122, the computer device determines whether a hierarchical format of this image already exists, e.g. whether a VC-6 format of the image exists.

In a third step 123, if the hierarchical format exists, then the computer device decodes the hierarchical format, e.g. to determine component RGB images.

The method then proceeds in a fourth 124, fifth 125, and sixth 126 step that involve converting the image to a required format, preprocessing the image, and converting the image to a tensor representation (as described above).

If, following the second step 122, the computer device determines that a hierarchical version of the image does not exist, in a seventh step 127, the computer device decodes the non-hierarchical version of the image, e.g. to component RGB images.

The computer device may then perform the fourth 124, fifth 125, and sixth steps 126 using the decoded image.

Furthermore, in an eighth step 128 that follows the seventh step 127, the computer device encodes the image in the hierarchical format, e.g. VC-6. This hierarchical version of the image may then be stored in a storage of the computer (or transmitted to a further storage device). Thereafter, if the image is required again, the computer device can use this hierarchical format of the image.

Such a method is particularly useful where the training occurs over a plurality of epochs (e.g. that use different resolutions of images or that use different regions of interest within one or more images). In these cases, the first epoch can be performed using (decoded versions of) the non-hierarchical versions of images, with following epochs using (decoded versions of) the hierarchical versions of the same images.

Referring to FIG. 15b, there is shown a further method of generating tensors (e.g. as described in the methods above). This method is typically performed by a computer device.

This method of FIG. 15b is similar to that of FIG. 15a with the difference that prior to the third step 123 of the method, in an intermediate step 131 the computer device checks whether a width of the image and a height of the image are greater than an expected width and an expected height (e.g. whether W/2 > Expected width and H/2 > Expected height). If these values are not greater than the expected values, then in a further intermediate step 132 the image width and height are doubled (e.g. by decoding an image in a higher-level of quality with a higher resolution) and an ‘echelon’ value is incremented. The expected width and the expected height may be based on the requirements of the machine learning model being trained and/or based on the requirements of the transformer being used to determine the tensor values (e.g. the width and height may be determined based on the desired size of tensors).

Where a hierarchical version of the image is not available, then in the seventh step 127 the computer device decodes the non-hierarchical format of the image, in the eight step 128 the computer device encodes the file in the hierarchical format, and then the computer device proceeds to the intermediate step 131 (and then to the third 123, fourth 124, fifth 125, and sixth 126 steps).

The method may comprise storing images for a plurality of echelons (e.g. with different heights and widths). Typically, decoding the method comprises decoding the method using the highest available echelon. Decoding the image may equally comprise decoding the lowest echelon available that meets the height and width requirements.

With the above-described methods, the first training epoch typically takes a significant period of time (since it requires the decoding of non-hierarchical image formats) with future training epochs being much quicker since they can use hierarchical image formats only.

While the present disclosure has primarily provided examples in which a VC-6 format is used to provide images to a machine learning module, it will be appreciated that other formats can be used and also that the machine learning machine may be arranged to perform inference on video and/or to be trained using video. For example, the input to the machine learning model may be one or more frames of a video.

In some embodiments, the hierarchical format comprises an LCEVC format, where obtaining an image may comprise obtaining a frame of a video encoded using the LCEVC codec and/or wherein obtaining an image may comprise obtaining a plurality of images and/or frames encoded using the LCEVC codec.

The LCEVC codec provides a bitstream that provides a base layer with a base quality or resolution and one or more enhancement layers that can be combined with the base layer to provide video (e.g. frames of a video) with an increased quality or resolution. Therefore, as described herein, the LCEVC codec (or, more generally, a codec that provides one or more enhancement layers) may be used to provide frames with a required LOQ, where in this context determining a required LOQ may comprise determining a required enhancement layer. This may involve determining a minimum enhancement layer needed to provide video at a required resolution or quality for the machine learning model.

This disclosure has generally described methods of determining an LOQ (e.g. necessary to obtain images in a required resolution). It will be appreciated that this includes methods of determining an enhancement layer (e.g. necessary to obtain video or video frames in a required resolution), where using a certain enhancement layer to provide a video/image provides a video/image at a certain level of quality.

Furthermore, where the disclosure has described methods of using different LOQs of a hierarchically encoded image to train and then re-train a machine learning model, this teaching includes the use of different numbers of enhancement layers (e.g. 0, 1, and 2) to obtain an image and/or video that can be used to train and then re-train a machine learning model.

This application of video codecs to the disclosures herein provides an ability to optimize AI inference preprocessing by enabling parallel decoding workflows, improving throughput, and reducing latency in media analytics and video search pipelines in particular.

In a practical example that considers a 1080p video, a vision encoder requiring 336×336 input might scale a 1920×1080 video or video frame to a size of 336×336. With LCEVC, the 1080p video may be provided using a base layer at 960×540 and a plurality of enhancement layers. With LCEVC, to provide a 336x336 input, a computer device is able to decode only the base layer and then scale this base layer down to 336×336, significantly reducing decoding time and computational cost.

The number of enhancement layers used may be dynamically determined based on this required input size (so that where a vision encoder is used that requires a larger image, the computer device may combine the base layer with one or more enhancement layers to obtain a higher resolution image before providing this image to the vision encoder).

Similarly, as has been described above, a video encoded using an LCEVC codec may be decoded so as to decode only a limited region of interest in the video, e.g. in order to decode only content within a bounding box that may be identified during a detection phase.

Where a limited region of interest is considered, the computer device may upscale only a portion of a video by combining a base layer with one or more enhancement layers only for this limited region of interest.

In a practical example, where a 240×240 bounding box is detected in a 1920×1080 video, the computer device may decode the full base layer (960×540), but only upscale the 120×120 region corresponding to the region of interest to full HD resolution (by combining a portion of the base layer with one or more enhancement layers). Specifically the enhancement layers may be decoded exclusively for the 240×240 area and combined with the upscaled base subset.

As described above, the base layer and the enhancement layers may be decoded simultaneously using parallel processors in order to more efficiently and rapidly perform the decoding.

This enables independent or partial enhancement layer decoding to serve different AI inference tasks without requiring full-frame processing. The processing may employ scheduling or orchestration logic to prioritize the decoding of certain layers based on task requirements and available computational resources.

The computer device may reuse a previously decoded base layer to accelerate a full-resolution decode for a separate task in order to avoiding redundant base decoding and improving overall pipeline efficiency. For example, where the machine learning model is initially trained on lower quality video (e.g. using no enhancement layers or only one enhancement layer) and is then re-trained on higher quality video (e.g. using more enhancement layers), the computer device may reuse the decoded base layer for each step of training. Similarly, the lower quality video may be used for an initial object detection step (e.g. to identify that there is a significant probability of the object being present in a video) with the higher quality video being used to confirm this detection (e.g. to identify that there is a very high probability of the object being present). The same decoded base layer may be used for each step, with the confirmation step also using one or more enhancement layers (that may be decoded in parallel with the base layer).

In a practical example, a base layer at 960×540 may be decoded for an initial detection task. For a subsequent recognition task, the previously decoded base may be reused (e.g. in combination with an enhancement layer) without requiring a full re-decode of the base layer. An enhancement layer may be decoded in parallel with the initial base layer decode ensuring that both base and enhancement layers are ready immediately for the next inference step.

These methods provide a number of benefits. For example, they:

Reduce computational overhead and latency in video preprocessing by leveraging layered structure and parallel decoding.

Manage multiple video renditions from layered bitstreams efficiently without costly full-frame decoding.

Enable scalable AI workflows where different inference models or pipeline stages concurrently or sequentially access different layers or resolutions with minimal overhead.

Improve GPU/CPU utilization by offloading selective decoding and preprocessing to lower-cost hardware or parallel pipelines.

Reduce memory bandwidth and data transfer by exploiting selective decoding and partial layer usage.

Are compatible with existing AI frameworks and video processing toolchains.

Maintain backward compatibility with legacy codecs while facilitating efficient multi-layer parallel decoding.

Seamlessly integrate into current media analytics and video search pipelines without requiring disruptive infrastructure changes.

The methods and systems disclosed herein may be used for various image and video processing techniques. For example, the machine learning model may be trained for, and used for, media analytics and/or image or video classification and/or image or video search and summarisation.

In various embodiments, the machine learning model may be used for one or more of:

Automated extraction, analysis, and interpretation of audio-visual data from video streams to enable insights, indexing, and decision-making across various applications.

Media Analytics (e.g. real-time and/or post-event analysis). This may involve one or more of:

Detection, classification, and tracking of objects, people, events, and behaviors in video and audio streams.

Counting and measuring entities and occurrences for operational and security monitoring.

Anomaly detection and pattern recognition for safety, compliance, and process optimization.

Event correlation and behavioral analysis for situational awareness and automated response.

Common domains: retail, industrial inspection, security surveillance, transportation, public safety, and smart facilities management.

Video Search & Summarisation (Content Understanding & Retrieval). This may involve one or more of:

Generating textual summaries, captions, or descriptions to facilitate quick understanding of video content.

Natural language question answering to retrieve precise information from videos.

Semantic or keyword-based retrieval of relevant videos or segments for content discovery, recommendation, or legal/compliance review.

Recognition and classification of human or object actions to enable tagging, highlight extraction, or behavioral indexing.

Typical use cases: media libraries, streaming platforms, sports analytics, compliance monitoring, and customer engagement.

It will be appreciated that these are exemplary uses of a machine learning model and that the disclosures herein may be used to train and/or use a machine learning model for other functions.

### Adaptive tokenisation

As has been described above, the present disclosure considers a method of performing a plurality of steps with an artificial intelligence model (e.g. a plurality of training steps and/or inference steps) by: generating a first set of images; providing the first set of images to the machine learning model; receiving an output from the machine learning model; and generating a second set of images in dependence on this output.

In particular, a level of quality of the second set of images and/or a region of interest depicted in the second set of images may be determined based on the output of the machine learning model. This provides an adaptive method of using or training an artificial intelligence model in which a second step can be performed based on a first step. This is of particular use where the images are associated with a hierarchical representation so that the first set of images and the second set of images are different versions of the same hierarchically-encoded images (e.g. with different levels of quality and/or showing different regions of interest). For example, the different levels of quality may relate to different colour planes or ranges. In some embodiments, a first level of quality comprises an alpha or monochrome level of quality and a second level of quality comprises a colour level of quality.

In various embodiments, the second set of images may be determined to provide:

A certain level of quality based on the output of the machine learning model. In particular, the output of the machine learning model may indicate a required level of quality of the second set of images and a computer device may then obtain enhancement data that can be used to provide this required level of quality.

A certain resolution (and/or a plurality of resolutions) of images based on the output of the machine learning model. In particular, the output of the machine learning model may indicate a required resolution (e.g. to provide further training) and then the second set of images may provide this resolution.

One or more regions of interest. For example, the output may identify the regions of interest based on the first set of images so that a second set of images can be generated based on these regions of interest (e.g. by upsampling only a portion of the first set of images so that the second set of images only show these regions). This avoids the unnecessary upsampling of regions that do not contain relevant content.

A subset of the first set of images (e.g. at a different level of quality). For example, the output may identify images that cannot be confidently classified at the first level of quality and may request that these images are provided at a second level of quality

Typically, a computer device that is generating the second set of images is arranged to request enhancement data (e.g. comprising enhancement layers) from a further computer device in order to generate this second set of images. In this regard, the computer device may obtain the first set of images, obtain the output, and then determine enhancement data (e.g. enhancement layers) that is required to generate the second set of images. The computer device may then request this enhancement data from the further computer device. In this way, the computer device is able to request only necessary enhancement data so as to prevent the unnecessary transfer of information (as would occur, e.g. if the computer device requested highest level of quality, e.g. original, images prior to the first training step). On this topic, it would be possible to generate the first and second set of images by downsampling a highest quality original image to different degrees. However, this requires access to the highest quality image and also requires redundant processing. By using hierarchically encoded images and then requesting second enhancement data as described above, the unnecessary transfer and storage of data can be avoided.

In various embodiments, the output is associated with a level of confidence and/or a level of convergence. In particular, the output may indicate a level of confidence with which the machine learning model has been able to classify the input images and/or may indicate a level of convergence associated with the images.

Where the output is associated with a level of confidence, the computer device may provide a level of confidence for the classification of one or more of (or each of) the images in the first set of images. Generating the second set of images may then comprise generating a second set of images that includes images associated with a level of confidence below a threshold level of confidence. Therefore, the method may involve providing images at a low level of quality, determining whether the machine learning model can successfully classify each these images, and then for any images that have not been successfully classified, providing higher quality version of these images.

Where the output is associated with a rate of convergence (and/or a weight or relevance of an image for a training purpose), the computer device may identify one or more images or types of images that have been particularly useful for updating a model and may provide higher quality versions of these images. For example, images that have been wrongly classified may be provided in a higher quality. This ‘rate of convergence’ based on an image may be separate to a training parameter that controls the convergence of the model and may indicate an amount of a weightings change that is attributable to the images.

In this regard, training the models may involve updating one or more weights or parameters of the models based on the input images (and, e.g. a human or automated indication of whether the machine learning model has correctly classified these input images). A computer device may be able to identify images that have led to significant changes in the weights/parameters (e.g. due to an indication that these images were not correctly classified) and may generate the second set of images based on these images.

Typically, the method comprises identifying any images in the first set of images and transcoding these images into a hierarchical format (if they are not already in a hierarchical format) either before the first training step or during the first training set. The generation of the images in the second set of images (and in some embodiments the first set of images) can then be based on these images in a hierarchical format.

In particular, the generation of the second set of images can be by combining of (e.g. upsampled versions of) the first set of images with enhancement data determined during the transcoding process.

Therefore, in order to provide a sequence of inputs to the machine learning model, a computer device is able to use these images in a hierarchical format. In particular, a first input may be based on a first set of images at a first (e.g. low) quality and a second input may be based on a second set of images at a second (e.g. higher) quality, where the second set of images may be formed by upsampling the first set of images and then combining the upsampled images with enhancement data (e.g. residual data). This process may continue so that a third set of images is formed by upsampling and adjusting the second set of images, etc.

With the system of the present disclosure, the computer device is able to efficiently generate each set of images (e.g. without duplication of work). Furthermore, the computer device is able to request/use enhancement data only where necessary.

In particular, the computer device may request/receive the images of first quality at a first time, use these images to generate the first set of images, and then determine whether to request enhancement data associated with the second level of quality at a second time. Therefore, the computer device only requests enhancement data where necessary and is able to only request second level enhancement data for a subset of the images in the first set of images. Similarly, the computer device may generate (e.g. by a transcoding process) hierarchical versions of images during (or before) a first training step so that these hierarchical images can be used efficiently for a plurality of further training steps or processes. For example, these transcoded images can be used to decode different regions of interest at different times in order to use these different regions in different training steps.

In this regard, the training process may continue so that the computer device requests third level enhancement data for only a subset of the images in the second set of images, and so on. The third level enhancement data may be associated with images in the first level of images (e.g. where the second and third sets of images are associated with different regions of interest in the first set of images). Equally, the third level enhancement data may be associated with images in the second level of images (e.g. where the third level enhancement data can be combined with these images to generate images at a third level of quality).

This provides improvements in efficiency as compared to systems that use non-hierarchically encoded images (e.g. JPGs). In this regard, conventional systems may need to separately request images of different quality in order to generate different sets of images. For example, in order to generate the second set of images, a conventional system might request entire, standalone, images at the second level of quality (leading to the re-transmission of any data that is already present in the first set of images). In contrast, with the system of the present disclosure, a computer device is able to generate the second set of images by requesting second level enhancement data only (and then combining this enhancement data with the first set of images).

In some embodiments, the formation of the second set of images image is dependent on a output rate or threshold associated with a first input of an artificial intelligence model (e.g. that is being trained). For example, a convergence or a success of the model over a plurality of training epochs may be determined and the machine learning model may determine the second set of training data based on this convergence (e.g. to generate the second set of training data when the model reaches a first level of success for classifying images in the first set of training data and/or when the degree of convergence indicates the model is no longer improving due to training on the first set of training data).

In some embodiments, the computer device is arranged extract (from a set of frames or images) a first subset of frames at a first time and then a second subset of frames at a second time, where the extraction of the second subset of frames is dependent on an output associated with the first subset of frames. For example, the model may take the first subset of frames as an input and then provide an output that has an output confidence level. If this confidence level is below a threshold level, then the computer device can request the second subset of frames (to provide the machine learning model with more information). Conversely, if the output confidence level is above the threshold, then the computer device is able to choose not to request the second subset (to avoid providing excess information that is not needed by the model). This may be particularly useful where the images are frames of a video. The computer device can then determine a sampling rate based on the output (so that, e.g. if the output of a first step provides a high level of confidence, a second set of images is provided that includes every 10th frame of the video, whereas if the output of a first step provides a low level of confidence, a second set of images is provided that includes every 2nd frame of the video).

As described above, the computer device may continue to generate and provide sets of images until a set of images is provided that has a sufficient level of quality (e.g. that contains high enough quality to successfully perform a training process). The sufficient level of quality may be associated with a threshold level of confidence, where the model may request images of increasing quality until the model is able to provide an output with a level of confidence that exceeds this threshold level of confidence.

The sufficient level of quality may be associated with a threshold level of convergence. In particular, where the images are being used to train the model, the model may request images of increasing quality until a convergence of the model passes a threshold (e.g. a change in parameter values over a plurality of training epochs falls beneath a threshold amount). This point may be deemed to indicate that images of further quality are no longer providing a training benefit.

In this regard, the model may struggle to successfully classify low quality images, but may be more successful at classifying higher quality images. Therefore, providing a first set of images at a lowest quality in a first step and a second set of (e.g. the same) images at a slightly higher quality in a second step may be used to significantly update the model (e.g. based on images that are classified differently during the first and second steps). However, at some point the model may be able to successfully classify most or all of the images so that further increases in quality do not provide any substantial benefit. The present disclosure considers a method of determining this point of diminishing benefit and then determining not to generate higher quality images.

### Adaptive down qualification

An aspect of the present disclosure considers a method that comprises identifying one or more obscurable regions in a first set of images at a first level of quality (e.g. at a high resolution). These obscurable regions may comprise secure data, for example personally identifiable information (PII) such as faces of users or vehicle license plates. It may be desired to obscure these regions and/or to ignore these regions when analysing the images.

In various embodiments, the obscurable regions comprise one or more of: faces of individuals, vehicle licence plates, body silhouettes, tattoos, or other features that could enable personal identification. These obscurable regions can then be obscured without (undesirably) reducing the ability of image recognition/classification models to analyse an image.

The method involves generating a second set of images in which the obscurable regions of interest have a second, e.g. lower, level of quality (e.g. where the second images are at a lower resolution).

Therefore, as has been described above, a method according to the present disclosure may involve identifying regions of interest in a set of images at a low level of quality and generating higher quality versions of these regions of interest. Similarly, a method may involve identifying obscurable regions in a set of images at a high level of quality and generating lower quality versions of these obscurable regions. This can be used, for example, to improve the efficiency of image detection or classification algorithms by ensuring these algorithms focus on only relevant regions of the images.

The method may leverage hierarchical codecs (e.g. VC-6 and LCEVC) to downsample or downscale only selected obscurable regions in order to discard or omit higher-detail enhancement layers for these obscurable regions, while leaving other regions of interest (e.g. vehicles, traffic signs, road markings) at higher quality so that they can be analysed.

In some embodiments, the downsampling or downscaling occurs on-device, where this may be performed by, e.g., a surveillance camera or an edge box before this device transmits the images to a further server for analysis. This can ensure that sensitive data never leaves the edge device (or only leaves the edge device in a quality that is low enough to avoid any data security concerns).

In some embodiments, the downsampling or downscaling occurs on a centralised server or archive. For example, the downsampling or downscaling may be performed on images received at a server in an initial pre-processing step that is performed prior to analysis being performed on these images.

Typically, the processing (e.g. downsampling/downscaling) of the images is adaptive. For example, a suppression strength (e.g. a level of quality of the processed images, an amount of downsampling or downscaling, a pixelation of the processed image, or an amount of residuals that are discarded) may be altered so as to ensure that the obscurable regions do not reveal sensitive information. For example, a level of processing may be performed until a recognition level for an object the obscurable region falls below a threshold level.

The recognition level may be associated with a level of confidence of an image recognition model, where the images may be processed until a level of certainty associated with the image recognition model classifying an object in the obscurable regions falls beneath a threshold level. For example, the images may be processed until the model is no longer able to identify a person depicted in the obscurable region.

The recognition level may be selected so that the obscurable regions are processed to avoid recognition while the other regions are preserved in sufficient quality to enable target image recognition tasks to be performed.

This ensures training and inference on image or video datasets can proceed using real-world footage without breaching data security requirements or privacy regulations, and without the need to generate new security-compliant datasets manually.

In some embodiments, the processing comprises applying an artificial intelligence algorithm, such as an object or face detection algorithm, to an image or a set of images in order to identify one or more obscurable regions in the image(s). This may comprise identifying PII (or another type of content) in the images and determining the obscurable regions as those regions containing this content.

In some embodiments, the method involves determining an obscurable region in a plurality of images, where this may involve tracking the movement of an obscurable image through a set of images (e.g. through a series of video frames).

In some embodiments, the method involves processing (e.g. downsampling or downscaling) the obscurable regions in order to reduce a level of quality of these regions. By using the hierarchical formats described herein, it is possible to perform this processing without affecting the quality of the remainder of the images so as to provide an image with different regions of different qualities.

The method may similarly comprising identifying one or more obscurable regions in an image and processing the other regions of this image in order to increase a level of quality of the other images (while note increasing the quality of the obscurable images)

In some embodiments, processing the image(s) further comprises applying an irreversible transform to the obscurable region(s). For example, the method may comprise adding strong pixelation or a Gaussian blur to the obscurable regions.

Typically the method comprises processing (e.g. downscaling) the obscurable regions until a level of confidence of image recognition for these regions falls below a threshold.

In some embodiments, processing the obscurable regions comprises modifying a header of the image(s) in order to identify the obscurable regions. Modifying the header may comprise adding a flag to the header to identify an obscurable region. This flag may indicate that higher levels of quality cannot be obtained for the obscurable region. The flag may be associated with a permissions level.

Therefore, a first set of devices with a first level of permissions may be unable to increase a level of quality of the obscurable region(s) while a second set of devices with a second level of permissions may be able to increase this level of quality of the obscurable region(s). The permissions level may identify permissions for a plurality of levels of quality, so that different permission levels provide access to different levels of quality.

Providing access to the levels of quality may involve enabling a computer device to obtain reconstruction data and/or residual data associated with a higher level of quality of the obscurable region(s).

For example, a highest level of quality of an image may be stored on a server, with the reconstruction data required to obtain this highest level of quality (from a lower level of quality) also being stored on the server. The server may then transmit a base image at a lowest level of quality to a further computer device. This further computer device may be able to request residual data in order to generate a version of the base image at a higher level of quality. The server may be arranged to receive such a request; determine one or more flags associated with the request, where the flags indicate that the request relates to an obscurable region; and provide the residual data based on a permission of the further computer device (so that the further computer device is only able to obtain residual data for obscurable regions if it has sufficient permission). A first further computer device may have permissions that enable access to residual data for a first level of quality; a second further computer device may have permissions that enable access to residual data for a second level of quality, etc.

Where the images are initially in a non-hierarchical format, processing the images may comprise transcoding the images to a hierarchical format and then processing the hierarchical format to obtain images that present the obscurable regions in the images with a first, relatively low, level of quality and that present other regions in the image with a second, relatively high, level of quality.

This method of processing images to identify and process obscurable regions may be performed as part of the generation of a training set for an artificial intelligence or machine learning model where this can be used to train an AI/ML model to perform image recognition or classification tasks on images that contain obscurable regions at low levels of quality.

### Motion-adaptive processing

An aspect of the present disclosure relates to a method of motion-adaptive processing. In particular, the computer device may be arranged to determine motion in one or more of a first set of images (at a first level of quality) and to generate a second set of images (at a second level of quality that may be a higher level of quality or a lower level of quality) based on this motion.

For example, motion may be detected in the first set of frame at a first, low, quality and then a second set of frames may be generated at a second, higher, level of quality to generate an input for an AI model (e.g. so that the AI model can analyse or classify the motion). Generating the second set of frames may depend on a region in which the motion is detected. In this regard, the computer device may identify (e.g. using a first AI model) one or more regions of interest in the first set of frames, the one or more regions of interest being associated with objects in motion. The second set of images may then comprise representations of these regions of interest. Other regions in the image may be ignored and/or generated at a lower level of quality than the regions of interest.

Therefore, the second set of images may comprise a combination of the regions of interest at the second level of quality and the other regions at the first level of quality.

In some embodiments, hierarchical formats of the first set of images are considered only for the regions of images so that an input set of images in a non-hierarchical format is analysed for motion and then hierarchical versions of images are retrieved only if motion is detected in these input images (this enables the computer device to extract the regions of interest from the hierarchical versions of the images).

In some embodiments, the computer device is arranged to determine the second level of quality based on (e.g. a feature of) the motion. For example, images with a lot of motion may be upscaled to a primary level of quality and images with relatively low motion may be upscaled to a secondary level of quality (e.g. where the primary level of quality is higher than the secondary level of quality). Each of the primary and the secondary levels of quality may be different to, e.g. higher than, an initial level of quality of the first set of images.

As described above, the second set of images may be provided as an input to an ML/AI model (e.g. for inference purposes or for training purposes).

In some embodiments, the motion is detected based on differences between images in the set of images. For example, where the set of images comprise frames of a video, motion may be detected based on differences between subsequent frames of the video.

In some embodiments, generating the second set of images based on the motion comprises analysing a feature of the motion. For example, the computer device may analyse a magnitude of the motion or may analyse a variance of the motion. The computer device may generate images/regions with a higher levels of quality based on a feature of the motion (e.g. based on a magnitude of the motion exceeding a threshold magnitude, a duration of the motion exceeding a threshold duration, and/or a direction of the motion being consistent). This enables the computer device to distinguish between meaningful motion (e.g. a movement of an object across a scene) and noise (e.g. noise motion caused due to camera shake).

Where the second set of images is provided as an input to an AI/ML model, this may comprise providing the first set of images to an AI/ML model at a first time and then providing the second set of images to a (e.g. the same) AI/ML model at a second time. Such a method can be used to train different aspects of an AI/ML model so that a first aspect is able to detect motion and a second aspect is able to classify this motion. In some embodiments, detecting the motion comprises detecting the motion based on an output from the AI/ML model (following the first step).

### Eagle-Eye Vision Console

The present disclosure considers a console and a real-time demonstration platform that integrates codecs, such as a SMPTE VC-6 codec into AI-driven visual analytics workflows.

In particular, the present disclosure considers a console that integrates a VC-6 codec into workflows. Unlike traditional formats that require full-frame decoding, VC-6 supports multi-resolution decoding through Levels of Quality (LOQ). Each LOQ corresponds to a progressively refined representation of the same image, allowing the system to decode frames at various granularities depending on context.

This layered design enables:

Progressive rendering — decode and display low-LOQ data first for instant feedback while higher LOQs are fetched as needed.

Selective ROI decoding — target specific areas for high-resolution analysis without processing the entire frame across any of the available LOQs.

Partial bitstream access — fetch only the necessary sections of the compressed bit-stream, minimizing I/O and compute overhead, optimizing network load and memory bandwidth requirement

These capabilities directly translate into lower latency and reduced bandwidth usage when paired with AI models, especially in real-time or resource-constrained environments such as embedded vision systems, edge devices, and live monitoring platforms.

As shown in FIG. 18, the present disclosure considers an orchestrated multi-inference pipeline, managed by a central Orchestrator component. The workflow operates as follows:

1. Input: A VC-6 encoded video stream is provided to the Orchestrator.

2. Decoding: Frames are decoded at a chosen LOQ within a single decoder state, ensuring consistency across all downstream operations.

3. Inference: Decoded frames are passed in parallel to multiple AI models.

4. Feedback Loop: The output of each model (e.g., bounding boxes, meshes) informs the decoding process for ROIs at higher LOQs.

For example, the pipeline may use one or more of:

A YOLOv5 AI model for object detection — fast, scalable, and well-suited for identifying multiple classes in real time.

A Google MediaPipe FaceMesh for dense facial landmark mapping — enabling ROI-based mesh extraction for facial features such as eyes, nose, and lips.

Since all inferences share a common decoder state, the pipeline achieves zero redundant decoding and maintains synchronization across model outputs.

### Efficient Region and LOQ Management

Each detected object or face mesh may trigger the console’s region of interest decoding mechanism, allowing regions to be decoded at higher LOQs continuing from its previous state. For example, as has been described above, the pipeline may decode an entire frame at LOQ -5 (a lowest resolution) for fast object detection, and then selectively re-decode detected bounding boxes at LOQ 0 (full resolution) for detailed inspection.

This dynamic decoding strategy ensures:

Optimal GPU and CPU utilization

Reduced memory footprint

Scalable inference throughput even under variable frame-rate conditions

### UI Controls and Developer Configurability and Stats

The present disclosure further considers an interactive control interface that serves as a live tuning tool for inference pipelines enabling developers to adjust:

LOQ decoding levels to balance performance vs. quality.

Confidence thresholds for detection models.

ROI LOQ settings to experiment with different decoding hierarchies in real time for selected ROIs.

The immediate visual feedback accelerates iterative testing and makes it easy to evaluate the codec’s behavior under varying inference loads.

The interface may comprise a real time stats panel that shows the performance of the decode and the inference in the current workflow for the current selected LOQ-ROI configuration.

### End-to-End Integration and Encoding Tools

The pipeline may include an encoding utility that converts standard video inputs into VC-6 format, ensuring end-to-end compatibility. This allows engineers to benchmark and experiment with different encoding profiles and analyze their impact on inference performance, latency, and visual fidelity.

The present disclosure considers single-state decoding as the foundation for efficient multi-model inference — a concept that can be extended to distributed AI pipelines and hybrid edge-cloud architectures.

### Alternatives and modifications

It will be understood that the present invention has been described above purely by way of example, and modifications of detail can be made within the scope of the invention.

For example, while the methods disclosed herein have primarily been described with reference to large language models (LLMs) and large multimodal models (LMMs), it will be appreciated that these methods are applicable to a wide variety of machine learning models, a wide variety of artificial intelligence models, and, more generally, to a large variety of classification models.

In some embodiments, the methods disclosed herein are arranged to provide an input (e.g. a set of image data) to a vision transformer (ViT) that can be used to decompose an input image into a series of tiles and then to map these tiles into a smaller dimension. The disclosures herein may be used to provide the decomposition of an image into tiles and so the systems herein may form a part of a vision transformer.

While the detailed disclosure has primarily considered the use of, and training of, machine learning models, it will be appreciated that the disclosure extends to the use of, and training of, artificial intelligence (AI) models.

Furthermore, while the described methods have primarily been described with reference to image classification models, it will be appreciated that the methods disclosed herein are applicable to a broader range of contexts.

While the description above has considered methods of determining regions of interest in an image, it will be appreciated that these regions may be regions that do contain relevant content and equally may be regions that do not contain relevant content. For example, the image classifier may comprise, or may use, an adversarial network, such as a generative adversarial network (GAN). The use of an adversarial network may comprise identifying objects that are not an object being classified by the image classifier. For example, where the image classifier is being trained to detect cats in an image, an adversarial network may be used to train this classifier on images that do not contain cats (but do contain objects that look similar to cats). The detection of a region of interest may comprise detection of such objects/images/regions of images.

It will be appreciated that the methods disclosed herein may be used with various machine learning techniques. For example, the method may be used with supervised or unsupervised training techniques. The methods may be used with various types of machine learning models. The methods may be used with, e.g. convolutional neural networks (CNNs), deep neural networks, long short term models (LSTMs), etc..

In some embodiments, the computer device may be arranged to decode an image and/or video based on a use of the decoded image of video (e.g. for inference or for training). For example, the computer device may be arranged to use a first level of quality, e.g. a low-resolution level of quality, for tasks like object detection and tracking, while using a second level of quality, e.g. a high-resolution level of quality, for tasks such as recognition, classification and segmentation.

As described herein, the hierarchical formats (e.g. of images or videos) typically comprise a base representation and one or more enhancement levels. Selecting the level of quality (LOQ) may then involve selecting one or more (or none) of these enhancement layers and combining these layers with the base layer in order to obtain an image or video at a desired resolution. It will be appreciated that this level of quality may relate to an image (e.g. a VC6 image) or a video (e.g. a LCEVC video).

The hierarchical format may be associated with another, e.g. non-hierarchical format. For example, an LCEVC codec may be integrated with a versatile video coding (VVC) codec (or an MPEG, AV1, VP9, HEVC, etc. codec), where the VVC codec may be used to provide the base layer. It will be appreciated that such a combination of codecs, e.g. where a non-hierarchical codec provides a base representation and then a further codec provides one or more enhancement layers, leads to a hierarchically encoded format.

In some embodiments, the base representation is provided using a VVenC encoder.

Reference numerals appearing in the claims are by way of illustration only and shall have no limiting effect on the scope of the claims.

1. An artificial intelligence, AI, model comprising an image classifier, wherein the AI model is arranged to receive a set of image data formed using a method that comprises:
determining a required format of image tiles for the AI model based on the image classifier;
determining a level of quality capable of providing the required format of image tiles; and
decoding an encoded image so as to generate the one or more image tiles at the determined level of quality; wherein the encoded image has been encoded using a codec that provides a base image and one or more enhancement layers so as to enable the generation of a plurality of versions of the image, with each version of the image having a different level of quality.

2. The AI model of claim 1, wherein determining a required format of an image comprises identifying a required size and/or resolution of an image.

3. The AI model of claim 1, wherein determining a required format of an image comprises identifying a required size and/or arrangement of tiles for inputting into the image classifier.

4. The AI model of claim 1, wherein determining the level of quality comprises identifying an enhancement layer capable of providing the identified format of image.

5. The AI model of claim 1, wherein determining the level of quality comprises identifying a minimum level of quality capable of providing the required format of image.

6. The AI model of claim 1, wherein generating an image with a specific level of quality comprises combining the base layer with one or more enhancement layers associated with said specific level of quality.

7. The AI model of claim 1, being arranged to receive a set of image data formed using a method that involves encoding the image prior to the decoding of the image, the method comprising:
identifying the image classifier;
identifying a required format of an image based on the identified image classifier;
determining an encoding parameter based on an input format associated with the image classifier; and
encoding the image based on the encoding parameter.

8. The AI model of claim 1, being arranged to receive a set of image data formed using a method that comprises:
identifying a plurality of image classifiers with different required formats; and
for each of the image classifiers:
identifying a level of quality capable of providing the required format of image; and
generating, from the encoded image, a version of the image using the identified level of quality.

9. The AI model of claim 1, being arranged to receive a set of image data formed using a method that comprises:
determining a thumbnail tile using a version of the image with a first level of quality; determining one or more image tiles using a version of the image with a second level of quality that is the identified level of quality; and
combining the thumbnail tile and the image tiles to form the set of image data.

10. The AI model of claim 7, being arranged to receive a set of image data formed using a method that comprises:
determining a region of interest in the image; and extracting the region of interest in a third level of quality.

11. The AI model of claim 10, being arranged to receive a set of image data formed using a method that comprises performing an inference process based on the region of interest.

12. The AI model of claim 1, being arranged to receive a set of image data formed using a method that comprises:
identifying a first region of the image and a second region of the image; and
generating a first tile based on the first region and generating a second tile based on the second region.

13. The AI model of claim 11, being arranged to receive a set of image data formed using a method that comprises generating the first tile with a first level of quality and generating the second tile with a second level of quality.

14. The AI model of claim 11, being arranged to receive a set of image data formed using a method that comprises identifying the first region based on a feature of the first region.

15. The AI model of claim 13, being arranged to receive a set of image data formed using a method that comprises comprising receiving an object of interest from a second device and identifying the first region based on the object of interest.

16. The AI model of claim 1, being arranged to receive a set of image data formed using a method that comprises determining one or more tiles from the image based on one or more regions of interest in the image, wherein determining the one or more tiles comprises generating a first set of tiles with a first level of quality, the first set of tiles relating to regions of interest and generating a second set of tiles with a second level of quality, the second set of tiles relating to regions other than the regions of interest.

17. The AI model of claim 1, being arranged to receive a set of image data formed using a method that comprises determining one or more regions of interest based on a first version of the image prior to determining a second, higher level of quality, version of a portion of the image including the regions of interest.

18. The AI model of claim 1, being arranged to receive a set of image data formed using a method that comprises resizing the decoded image based on the required format.

19. An encoder for encoding an image for use with an artificial intelligence, AI, model, the encoder comprising a processor for:
identifying an artificial intelligence, AI, model; identifying a required format of an image based on the identified AI model;
determining an encoding parameter based on the required format; and encoding the image based on the encoding parameter, the image being encoded using a codec that provides a base image and one or more enhancement layers so as to enable the generation of a plurality of versions of the image, wherein each version of the image has a different level of quality.

20. A system comprising:
an encoder for encoding an image, the encoder comprising a processor for:
identifying an artificial intelligence, AI, model;
identifying a required format of an image based on the identified AI model;
determining an encoding parameter based on the required format; and
encoding the image based on the encoding parameter, the image being encoded using a codec that provides a base image and one or more enhancement layers so as to enable the generation of a plurality of versions of the image, wherein each version of the image has a different level of quality; and
a decoder for decoding the encoded image, the decoder comprising a processor for:
identifying the AI model;
determining the required format of the image based on the identified AI model;
determining a level of quality capable of providing the required format of image; and
decoding the image so as to generate a version of the image using the identified level of quality.
